(19) United States
(12) Patent Application Publication
(10) Pub. No.: US 2024/0338857 A1
(43) Pub. Date: Oct. 10, 2024

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG Electronics Inc., Seoul (KR)

(72) Inventors: Hanje PARK, Seoul (KR); Joohyung BYEON, Seoul (KR); Donggyu SIM, Seoul (KR)

(21) Appl. No.: 18/294,861

(22) PCT Filed: Aug. 2, 2022
(86) PCT No.: PCT/KR2022/011373

§ 371 Date: Feb. 2, 2024

(30) Foreign Application Priority Data
Aug. 3, 2021 (KR) 10-2021-0102060
Sep. 28, 2021 (KR) 10-2021-0128139

(51) Int. Cl. G06T 9/00; G06T 15/04

(52) U.S. Cl. CPC G06T 9/001; G06T 15/04; G06T 2210/12

(57) ABSTRACT

A point cloud data transmission method according to embodiments may comprise the steps of: encoding point cloud data; and transmitting the point cloud data. A point cloud data reception method according to embodiments may comprise the steps of: receiving point cloud data; decoding the point cloud data; and rendering the point cloud data.

### TECHNICAL FIELD

Embodiments provide a method for providing point cloud content to provide a user with various services such as virtual reality (VR), augmented reality (AR), mixed reality (MR), and self-driving services.

### BACKGROUND ART

A point cloud is a set of points in a three-dimensional (3D) space. It is difficult to generate point cloud data because the number of points in the 3D space is large. A large throughput is required to transmit and receive data of a point cloud.

### DISCLOSURE

### Technical Problem

An object of the present disclosure is to provide a point cloud data transmission device, a point cloud data transmission method, a point cloud data reception device, and a point cloud data reception method for efficiently transmitting and receiving a point cloud.

Another object of the present disclosure is to provide a point cloud data transmission device, a point cloud data transmission method, a point cloud data reception device, and a point cloud data reception method for addressing latency and encoding/decoding complexity.

Embodiments are not limited to the above-described objects, and the scope of the embodiments may be extended to other objects that can be inferred by those skilled in the art based on the entire contents of the present disclosure.

### Technical Solution

The object of the present disclosure can be achieved by providing a method of transmitting point cloud data. The method may include encoding point cloud data, and transmitting the point cloud data.

In another aspect of the present disclosure, provided herein is a method of receiving point cloud data. The method may include receiving point cloud data, decoding the point cloud data, and rendering the point cloud data.

### ADVANTAGEOUS EFFECTS

The point cloud data transmission method, the point cloud data transmission apparatus, the point cloud data reception method, and the point cloud data reception apparatus according to the embodiments may provide a good-quality point cloud service.

The point cloud data transmission method, the point cloud data transmission apparatus, the point cloud data reception method, and the point cloud data reception apparatus according to the embodiments may achieve various video codec methods.

The point cloud data transmission method, the point cloud data transmission apparatus, the point cloud data reception method, and the point cloud data reception apparatus according to the embodiments may provide universal point cloud content such as a self-driving service.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates an exemplary structure of a transmission/reception system for providing point cloud content according to embodiments;

FIG. 2 illustrates capture of point cloud data according to embodiments;

FIG. 3 illustrates an exemplary point cloud, geometry, and texture image according to embodiments;

FIG. 4 illustrates an exemplary V-PCC encoding process according to embodiments;

FIG. 5 illustrates an example of a tangent plane and a normal vector of a surface according to embodiments;

FIG. 6 illustrates an exemplary bounding box of a point cloud according to embodiments;

FIG. 7 illustrates an example of determination of individual patch positions on an occupancy map according to embodiments;

FIG. 8 shows an exemplary relationship among normal, tangent, and bitangent axes according to embodiments;

FIG. 9 shows an exemplary configuration of the minimum mode and maximum mode of a projection mode according to embodiments;

FIG. 10 illustrates an exemplary EDD code according to embodiments;

FIG. 11 illustrates an example of recoloring based on color values of neighboring points according to embodiments;

FIG. 12 illustrates an example of push-pull background filling according to embodiments;

FIG. 13 shows an exemplary possible traversal order for a 4*4 block according to embodiments;

FIG. 14 illustrates an exemplary best traversal order according to embodiments;

FIG. 15 illustrates an exemplary 2D video/image encoder according to embodiments;

FIG. 16 illustrates an exemplary V-PCC decoding process according to embodiments;

FIG. 17 shows an exemplary 2D video/image decoder according to embodiments;

FIG. 18 is a flowchart illustrating operation of a transmission device according to embodiments of the present disclosure;

FIG. 19 is a flowchart illustrating operation of a reception device according to

embodiments;

FIG. 20 illustrates an exemplary structure operable in connection with point cloud data transmission/reception methods/devices according to embodiments;

FIG. 21 illustrates a VPCC encoder according to embodiments;

FIG. 22 illustrates 3D patch generation according to embodiments;

FIG. 23 illustrates additional projection planes for improving visual quality according to embodiments;

FIG. 24 illustrates an example of a difference in occupancy map based on the size of an occupancy packing block according to embodiments;

FIG. 25 illustrates the boundaries of a patch of smoothing point cloud data and a trilinear filter according to embodiments;

FIG. 26 illustrates attribute interleaving according to embodiments;

FIG. 27 illustrates a VPCC decoder according to embodiments;

FIG. 28 illustrates a 3D mesh data encoder according to embodiments;

FIG. 29 illustrates a 3D mesh data encoder according to embodiments;

FIG. 30 illustrates a connectivity encoder according to embodiments;

FIG. 31 illustrates a normal encoder according to embodiments;

FIG. 32 illustrates a 3D mesh data decoder according to embodiments;

FIG. 33 illustrates a vertex geometry/vertex color decoder according to embodiments;

FIG. 34 illustrates a vertex order mapper according to embodiments;

FIG. 35 illustrates a connectivity decoder according to embodiments;

FIG. 36 illustrates a normal decoder according to embodiments;

FIG. 37 illustrates a face color decoder according to embodiments;

FIG. 38 illustrates an example of a face color display according to embodiments;

FIG. 39 illustrates a patch boundary representation color decoder according to embodiments;

FIG. 40 illustrates a V3C bitstream structure according to embodiments;

FIG. 41 illustrates a V3C parameter set according to embodiments;

FIG. 42 illustrates category 1 mesh data according to embodiments;

FIG. 43 illustrates a texture map for each of consecutive frames according to embodiments;

FIG. 44 illustrates a reconstruction of texture maps of consecutive frames according to embodiments;

FIG. 45 illustrates a texture map rearranger according to embodiments;

FIGS. 46 and 47 illustrate texture reconstruction according to embodiments;

FIG. 48 illustrates texture reconstruction using object-based matching according to embodiments;

FIG. 49 illustrates texture reconstruction according to embodiments;

FIG. 50 illustrates a point cloud data transmission device (encoder) according to embodiments;

FIG. 51 illustrates coordinate correction according to embodiments;

FIG. 52 illustrates a texture map rearrangement method according to embodiments;

FIG. 53 illustrates a point cloud data reception device according to embodiments;

FIG. 54 illustrates texture coordinates according to embodiments;

FIG. 55 illustrates a texture map restoration method for a decoder according to embodiments;

FIG. 56 illustrates a V3C unit header according to embodiments;

FIG. 57 illustrates a V3C parameter set according to embodiments;

FIG. 58 illustrates texture map information according to embodiments;

FIG. 59 illustrates a method of transmitting point cloud data according to embodiments; and

FIG. 60 illustrates a method of receiving point cloud data according to embodiments.

### BEST MODE

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

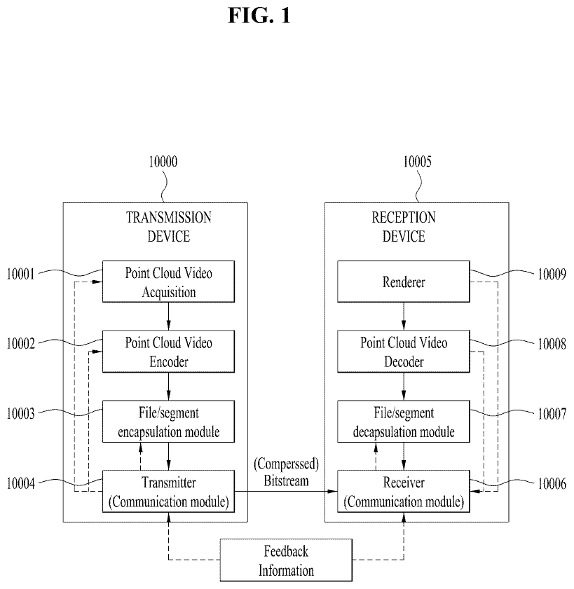

FIG. 1 illustrates an exemplary structure of a transmission/reception system for providing point cloud content according to embodiments.

The present disclosure provides a method of providing point cloud content to provide a user with various services such as virtual reality (VR), augmented reality (AR), mixed reality (MR), and self-driving. The point cloud content according to the embodiments represent data representing objects as points, and may be referred to as a point cloud, point cloud data, point cloud video data, point cloud image data, or the like.

A point cloud data transmission device 10000 according to embodiment may include a point cloud video acquirer 10001, a point cloud video encoder 10002, a file/segment encapsulation module 10003, and/or a transmitter (or communication module) 10004. The transmission device according to the embodiments may secure and process point cloud video (or point cloud content) and transmit the same. According to embodiments, the transmission device may include a fixed station, a base transceiver system (BTS), a network, an artificial intelligence (AI) device and/or system, a robot, and an AR/VR/XR device and/or a server. According to embodiments, the transmission device 10000 may include a device robot, a vehicle, AR/VR/XR devices, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The point cloud video acquirer 10001 according to the embodiments acquires a point cloud video through a process of capturing, synthesizing, or generating a point cloud video.

The point cloud video encoder 10002 according to the embodiments encodes the point cloud video data. According to embodiments, the point cloud video encoder 10002 may be referred to as a point cloud encoder, a point cloud data encoder, an encoder, or the like. The point cloud compression coding (encoding) according to the embodiments is not limited to the above-described embodiment. The point cloud video encoder may output a bitstream containing the encoded point cloud video data. The bitstream may not only include encoded point cloud video data, but also include signaling information related to encoding of the point cloud video data.

The encoder according to the embodiments may support both the geometry-based point cloud compression (G-PCC) encoding scheme and/or the video-based point cloud compression (V-PCC) encoding scheme. In addition, the encoder may encode a point cloud (referring to either point cloud data or points) and/or signaling data related to the point cloud. The specific operation of encoding according to embodiments will be described below.

As used herein, the term V-PCC may stand for Video-based Point Cloud Compression (V-PCC). The term V-PCC may be the same as Visual Volumetric Video-based Coding (V3C). These terms may be complementarily used.

The file/segment encapsulation module 10003 according to the embodiments encapsulates the point cloud data in the form of a file and/or segment form. The point cloud data transmission method/device according to the embodiments may transmit the point cloud data in a file and/or segment form.

The transmitter (or communication module) 10004 according to the embodiments transmits the encoded point cloud video data in the form of a bitstream. According to embodiments, the file or segment may be transmitted to a reception device over a network, or stored in a digital storage medium (e.g., USB, SD, CD, DVD, Blu-ray, HDD, SSD, etc.). The transmitter according to the embodiments is capable of wired/wireless communication with the reception device (or the receiver) over a network of 4G, 5G, 6G, etc. In addition, the transmitter may perform necessary data processing operation according to the network system (e.g., a 4G, 5G or 6G communication network system). The transmission device may transmit the encapsulated data in an on-demand manner.

A point cloud data reception device 10005 according to the embodiments may include a receiver 10006, a file/segment decapsulation module 10007, a point cloud video decoder 10008, and/or a renderer 10009. According to embodiments, the reception device may include a device robot, a vehicle, AR/VR/XR devices, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The receiver 10006 according to the embodiments receives a bitstream containing point cloud video data. According to embodiments, the receiver 10006 may transmit feedback information to the point cloud data transmission device 10000.

The file/segment decapsulation module 10007 decapsulates a file and/or a segment containing point cloud data. The decapsulation module according to the embodiments may perform a reverse process of the encapsulation process according to the embodiments.

The point cloud video decoder 10007 decodes the received point cloud video data. The decoder according to the embodiments may perform a reverse process of encoding according to the embodiments.

The renderer 10009 renders the decoded point cloud video data. According to embodiments, the renderer 10009 may transmit the feedback information obtained at the reception side to the point cloud video decoder 10008. The point cloud video data according to the embodiments may carry feedback information to the receiver. According to embodiments, the feedback information received by the point cloud transmission device may be provided to the point cloud video encoder.

The arrows indicated by dotted lines in the drawing represent a transmission path of feedback information acquired by the reception device 10005. The feedback information is information for reflecting interactivity with a user who consumes point cloud content, and includes user information (e.g., head orientation information), viewport information, and the like). In particular, when the point cloud content is content for a service (e.g., self-driving service, etc.) that requires interaction with a user, the feedback information may be provided to the content transmitting side (e.g., the transmission device 10000) and/or the service provider. According to embodiments, the feedback information may be used in the reception device 10005 as well as the transmission device 10000, and may not be provided.

The head orientation information according to embodiments is information about a user's head position, orientation, angle, motion, and the like. The reception device 10005 according to the embodiments may calculate viewport information based on the head orientation information. The viewport information may be information about a region of the point cloud video that the user is viewing. A viewpoint is a point where a user is viewing a point cloud video, and may refer to a center point of the viewport region. That is, the viewport is a region centered on the viewpoint, and the size and shape of the region may be determined by a field of view (FOV). Accordingly, the reception device 10005 may extract the viewport information based on a vertical or horizontal FOV supported by the device in addition to the head orientation information. In addition, the reception device 10005 performs gaze analysis to check how the user consumes a point cloud, a region that the user gazes at in the point cloud video, a gaze time, and the like. According to embodiments, the reception device 10005 may transmit feedback information including the result of the gaze analysis to the transmission device 10000. The feedback information according to the embodiments may be acquired in the rendering and/or display process. The feedback information according to the embodiments may be secured by one or more sensors included in the reception device 10005. In addition, according to embodiments, the feedback information may be secured by the renderer 10009 or a separate external element (or device, component, etc.). The dotted lines in FIG. 1 represent a process of transmitting the feedback information secured by the renderer 10009. The point cloud content providing system may process (encode/decode) point cloud data based on the feedback information. Accordingly, the point cloud video data decoder 10008 may perform a decoding operation based on the feedback information. The reception device 10005 may transmit the feedback information to the transmission device. The transmission device (or the point cloud video data encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) all point cloud data, and provide point cloud content to the user.

According to embodiments, the transmission device 10000 may be called an encoder, a transmission device, a transmitter, or the like, and the reception device 10004 may be called a decoder, a reception device, a receiver, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to point cloud data.

The elements of the point cloud content providing system illustrated in FIG. 1 may be implemented by hardware, software, a processor, and/or combinations thereof.

Embodiments may provide a method of providing point cloud content to provide a user with various services such as virtual reality (VR), augmented reality (AR), mixed reality (MR), and self-driving.

In order to provide a point cloud content service, a point cloud video may be acquired first. The acquired point cloud video may be transmitted through a series of processes, and the reception side may process the received data back into the original point cloud video and render the processed point cloud video. Thereby, the point cloud video may be provided to the user. Embodiments provide a method of effectively performing this series of processes.

The entire processes for providing a point cloud content service (the point cloud data transmission method and/or point cloud data reception method) may include an acquisition process, an encoding process, a transmission process, a decoding process, a rendering process, and/or a feedback process.

According to embodiments, the process of providing point cloud content (or point cloud data) may be referred to as a point cloud compression process. According to embodiments, the point cloud compression process may represent a geometry-based point cloud compression process.

Each element of the point cloud data transmission device and the point cloud data reception device according to the embodiments may be hardware, software, a processor, and/or a combination thereof.

In order to provide a point cloud content service, a point cloud video may be acquired. The acquired point cloud video is transmitted through a series of processes, and the reception side may process the received data back into the original point cloud video and render the processed point cloud video. Thereby, the point cloud video may be provided to the user. Embodiments provide a method of effectively performing this series of processes.

The entire processes for providing a point cloud content service may include an acquisition process, an encoding process, a transmission process, a decoding process, a rendering process, and/or a feedback process.

The point cloud compression system may include a transmission device and a reception device. The transmission device may output a bitstream by encoding a point cloud video, and deliver the same to the reception device through a digital storage medium or a network in the form of a file or a stream (streaming segment). The digital storage medium may include various storage media such as a USB, SD, CD, DVD, Blu-ray, HDD, and SSD.

The transmission device may include a point cloud video acquirer, a point cloud video encoder, a file/segment encapsulator, and a transmitter. The reception device may include a receiver, a file/segment decapsulator, a point cloud video decoder, and a renderer. The encoder may be referred to as a point cloud video/picture/picture/frame encoder, and the decoder may be referred to as a point cloud video/picture/picture/frame decoding device. The transmitter may be included in the point cloud video encoder. The receiver may be included in the point cloud video decoder. The renderer may include a display. The renderer and/or the display may be configured as separate devices or external components. The transmission device and the reception device may further include a separate internal or external module/unit/component for the feedback process.

According to embodiments, the operation of the reception device may be the reverse process of the operation of the transmission device.

The point cloud video acquirer may perform the process of acquiring point cloud video through a process of capturing, composing, or generating point cloud video. In the acquisition process, data of 3D positions (x, y, z)/attributes (color, reflectance, transparency, etc.) of multiple points, for example, a polygon file format (PLY) (or the Stanford Triangle format) file may be generated. For a video having multiple frames, one or more files may be acquired. During the capture process, point cloud related metadata (e.g., capture related metadata) may be generated.

A point cloud data transmission device according to embodiments may include an encoder configured to encode point cloud data, and a transmitter configured to transmit the point cloud data. The data may be transmitted in the form of a bitstream containing a point cloud.

A point cloud data reception device according to embodiments may include a receiver configured to receive point cloud data, a decoder configured to decode the point cloud data, and a renderer configured to render the point cloud data.

The method/device according to the embodiments represents the point cloud data transmission device and/or the point cloud data reception device.

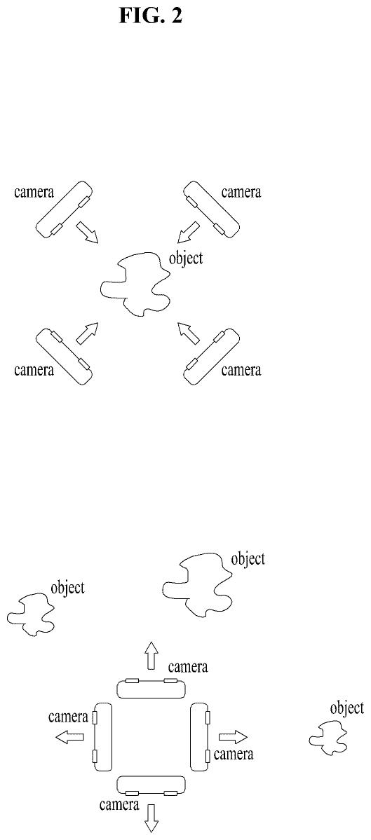

FIG. 2 illustrates capture of point cloud data according to embodiments.

Point cloud data according to embodiments may be acquired by a camera or the like. A capturing technique according to embodiments may include, for example, inward-facing and/or outward-facing.

In the inward-facing according to the embodiments, one or more cameras inwardly facing an object of point cloud data may photograph the object from the outside of the object.

In the outward-facing according to the embodiments, one or more cameras outwardly facing an object of point cloud data may photograph the object. For example, according to embodiments, there may be four cameras.

The point cloud data or the point cloud content according to the embodiments may be a video or a still image of an object/environment represented in various types of 3D spaces. According to embodiments, the point cloud content may include video/audio/an image of an object.

For capture of point cloud content, a combination of camera equipment (a combination of an infrared pattern projector and an infrared camera) capable of acquiring depth and RGB cameras capable of extracting color information corresponding to the depth information may be configured. Alternatively, the depth information may be extracted through LiDAR, which uses a radar system that measures the location coordinates of a reflector by emitting a laser pulse and measuring the return time. A shape of the geometry consisting of points in a 3D space may be extracted from the depth information, and an attribute representing the color/reflectance of each point may be extracted from the RGB information. The point cloud content may include information about the positions (x, y, z) and color (YCbCr or RGB) or reflectance (r) of the points. For the point cloud content, the outward-facing technique of capturing an external environment and the inward-facing technique of capturing a central object may be used. In the VR/AR environment, when an object (e.g., a core object such as a character, a player, a thing, or an actor) is configured into point cloud content that may be viewed by the user in any direction (360 degrees), the configuration of the capture camera may be based on the inward-facing technique. When the current surrounding environment is configured into point cloud content in a mode of a vehicle, such as self-driving, the configuration of the capture camera may be based on the outward-facing technique. Because the point cloud content may be captured by multiple cameras, a camera calibration process may need to be performed before the content is captured to configure a global coordinate system for the cameras.

The point cloud content may be a video or still image of an object/environment presented in various types of 3D spaces.

Additionally, in the point cloud content acquisition method, any point cloud video may be composed based on the captured point cloud video. Alternatively, when a point cloud video for a computer-generated virtual space is to be provided, capturing with an actual camera may not be performed. In this case, the capture process may be replaced simply by a process of generating related data.

Post-processing may be needed for the captured point cloud video to improve the quality of the content. In the video capture process, the maximum/minimum depth may be adjusted within a range provided by the camera equipment. Even after the adjustment, point data of an unwanted area may still be present. Accordingly, post-processing of removing the unwanted area (e.g., the background) or recognizing a connected space and filling the spatial holes may be performed. In addition, point clouds extracted from the cameras sharing a spatial coordinate system may be integrated into one piece of content through the process of transforming each point into a global coordinate system based on the coordinates of the location of each camera acquired through a calibration process. Thereby, one piece of point cloud content having a wide range may be generated, or point cloud content with a high density of points may be acquired.

The point cloud video encoder may encode the input point cloud video into one or more video streams. One video may include a plurality of frames, each of which may correspond to a still image/picture. In this specification, a point cloud video may include a point cloud image/frame/picture/video/audio. In addition, the term “point cloud video” may be used interchangeably with a point cloud image/frame/picture. The point cloud video encoder may perform a video-based point cloud compression (V-PCC) procedure. The point cloud video encoder may perform a series of procedures such as prediction, transformation, quantization, and entropy coding for compression and encoding efficiency. The encoded data (encoded video/image information) may be output in the form of a bitstream. Based on the V-PCC procedure, the point cloud video encoder may encode point cloud video by dividing the same into a geometry video, an attribute video, an occupancy map video, and auxiliary information, which will be described later. The geometry video may include a geometry image, the attribute video may include an attribute image, and the occupancy map video may include an occupancy map image. The auxiliary information may include auxiliary patch information. The attribute video/image may include a texture video/image.

The encapsulation processor (file/segment encapsulation module) 1003 may encapsulate the encoded point cloud video data and/or metadata related to the point cloud video in the form of, for example, a file. Here, the metadata related to the point cloud video may be received from the metadata processor. The metadata processor may be included in the point cloud video encoder or may be configured as a separate component/module. The encapsulation processor may encapsulate the data in a file format such as ISOBMFF or process the same in the form of a DASH segment or the like. According to an embodiment, the encapsulation processor may include the point cloud video-related metadata in the file format. The point cloud video metadata may be included, for example, in boxes at various levels on the ISOBMFF file format or as data in a separate track within the file. According to an embodiment, the encapsulation processor may encapsulate the point cloud video-related metadata into a file. The transmission processor may perform processing for transmission on the point cloud video data encapsulated according to the file format. The transmission processor may be included in the transmitter or may be configured as a separate component/module. The transmission processor may process the point cloud video data according to a transmission protocol. The processing for transmission may include processing for delivery over a broadcast network and processing for delivery through a broadband. According to an embodiment, the transmission processor may receive point cloud video-related metadata from the metadata processor along with the point cloud video data, and perform processing of the point cloud video data for transmission.

The transmitter 1004 may transmit the encoded video/image information or data that is output in the form of a bitstream to the receiver of the reception device through a digital storage medium or a network in the form of a file or streaming. The digital storage medium may include various storage media such as USB, SD, CD, DVD, Blu-ray, HDD, and SSD. The transmitter may include an element for generating a media file in a predetermined file format, and may include an element for transmission over a broadcast/communication network. The receiver may extract the bitstream and transmit the extracted bitstream to the decoding device.

The receiver 1003 may receive point cloud video data transmitted by the point cloud video transmission device according to the present disclosure. Depending on the transmission channel, the receiver may receive the point cloud video data over a broadcast network or through a broadband. Alternatively, the point cloud video data may be received through a digital storage medium.

The reception processor may process the received point cloud video data according to the transmission protocol. The reception processor may be included in the receiver or may be configured as a separate component/module. The reception processor may reversely perform the above-described process of the transmission processor such that the processing corresponds to the processing for transmission performed at the transmission side. The reception processor may deliver the acquired point cloud video data to the decapsulation processor, and the acquired point cloud video-related metadata to the metadata parser. The point cloud video-related metadata acquired by the reception processor may take the form of a signaling table.

The decapsulation processor (file/segment decapsulation module) 10007 may decapsulate the point cloud video data received in the form of a file from the reception processor. The decapsulation processor may decapsulate the files according to ISOBMFF or the like, and may acquire a point cloud video bitstream or point cloud video-related metadata (a metadata bitstream). The acquired point cloud video bitstream may be delivered to the point cloud video decoder, and the acquired point cloud video-related metadata (metadata bitstream) may be delivered to the metadata processor. The point cloud video bitstream may include the metadata (metadata bitstream). The metadata processor may be included in the point cloud video decoder or may be configured as a separate component/module. The point cloud video-related metadata acquired by the decapsulation processor may take the form of a box or a track in the file format. The decapsulation processor may receive metadata necessary for decapsulation from the metadata processor, when necessary. The point cloud video-related metadata may be delivered to the point cloud video decoder and used in a point cloud video decoding procedure, or may be transferred to the renderer and used in a point cloud video rendering procedure.

The point cloud video decoder may receive the bitstream and decode the video/image by performing an operation corresponding to the operation of the point cloud video encoder. In this case, the point cloud video decoder may decode the point cloud video by dividing the same into a geometry video, an attribute video, an occupancy map video, and auxiliary information as described below. The geometry video may include a geometry image, and the attribute video may include an attribute image. The occupancy map video may include an occupancy map image. The auxiliary information may include auxiliary patch information. The attribute video/image may include a texture video/image.

The 3D geometry may be reconstructed based on the decoded geometry image, the occupancy map, and auxiliary patch information, and then may be subjected to a smoothing process. A color point cloud image/picture may be reconstructed by assigning color values to the smoothed 3D geometry based on the texture image. The renderer may render the reconstructed geometry and the color point cloud image/picture. The rendered video/image may be displayed through the display. The user may view all or part of the rendered result through a VR/AR display or a typical display.

The feedback process may include transferring various kinds of feedback information that may be acquired in the rendering/displaying process to the transmission side or to the decoder of the reception side. Interactivity may be provided through the feedback process in consuming point cloud video. According to an embodiment, head orientation information, viewport information indicating a region currently viewed by a user, and the like may be delivered to the transmission side in the feedback process. According to an embodiment, the user may interact with things implemented in the VR/AR/MR/self-driving environment. In this case, information related to the interaction may be delivered to the transmission side or a service provider during the feedback process. According to an embodiment, the feedback process may be skipped.

The head orientation information may represent information about the location, angle and motion of a user's head. On the basis of this information, information about a region of the point cloud video currently viewed by the user, that is, viewport information may be calculated.

The viewport information may be information about a region of the point cloud video currently viewed by the user. Gaze analysis may be performed using the viewport information to check the way the user consumes the point cloud video, a region of the point cloud video at which the user gazes, and how long the user gazes at the region. The gaze analysis may be performed at the reception side and the result of the analysis may be delivered to the transmission side on a feedback channel. A device such as a VR/AR/MR display may extract a viewport region based on the location/direction of the user's head, vertical or horizontal FOV supported by the device, and the like.

According to an embodiment, the aforementioned feedback information may not only be delivered to the transmission side, but also be consumed at the reception side. That is, decoding and rendering processes at the reception side may be performed based on the aforementioned feedback information. For example, only the point cloud video for the region currently viewed by the user may be preferentially decoded and rendered based on the head orientation information and/or the viewport information.

Here, the viewport or viewport region may represent a region of the point cloud video currently viewed by the user. A viewpoint is a point which is viewed by the user in the point cloud video and may represent a center point of the viewport region. That is, a viewport is a region around a viewpoint, and the size and form of the region may be determined by the field of view (FOV).

The present disclosure relates to point cloud video compression as described above. For example, the methods/embodiments disclosed in the present disclosure may be applied to the point cloud compression or point cloud coding (PCC) standard of the moving picture experts group (MPEG) or the next generation video/image coding standard.

As used herein, a picture/frame may generally represent a unit representing one image in a specific time interval.

A pixel or a pel may be the smallest unit constituting one picture (or image). Also, “sample” may be used as a term corresponding to a pixel. A sample may generally represent a pixel or a pixel value. It may represent only a pixel/pixel value of a luma component, only a pixel/pixel value of a chroma component, or only a pixel/pixel value of a depth component.

A unit may represent a basic unit of image processing. The unit may include at least one of a specific region of the picture and information related to the region. The unit may be used interchangeably with term such as block or area in some cases. In a general case, an M×N block may include samples (or a sample array) or a set (or array) of transform coefficients configured in M columns and N rows.

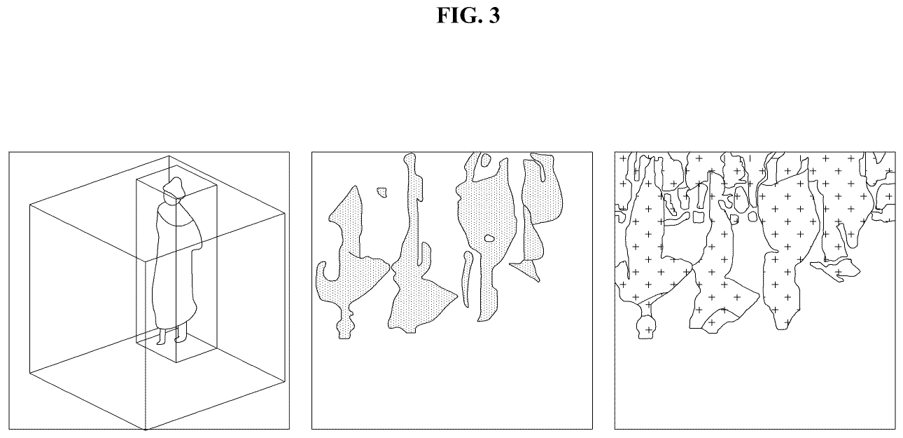

FIG. 3 illustrates an example of a point cloud, a geometry image, and a texture image according to embodiments.

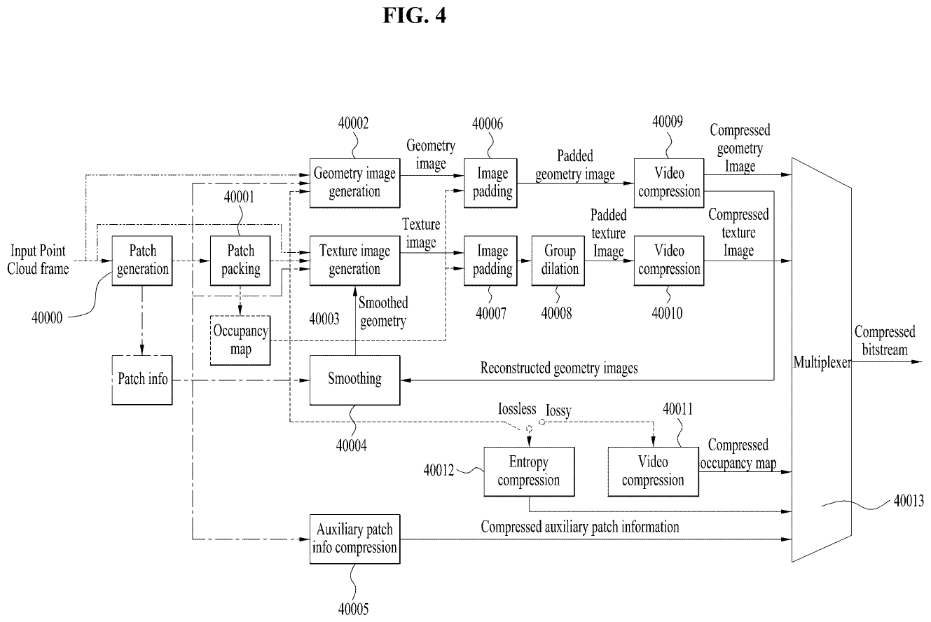

A point cloud according to the embodiments may be input to the V-PCC encoding process of FIG. 4, which will be described later, to generate a geometric image and a texture image. According to embodiments, a point cloud may have the same meaning as point cloud data.

As shown in the figure, the left part shows a point cloud, in which an object is positioned in a 3D space and may be represented by a bounding box or the like. The middle part shows the geometry, and the right part shows a texture image (non-padded image).

Video-based point cloud compression (V-PCC) according to embodiments may provide a method of compressing 3D point cloud data based on a 2D video codec such as HEVC or VVC. Data and information that may be generated in the V-PCC compression process are as follows:

Occupancy map: this is a binary map indicating whether there is data at a corresponding position in a 2D plane, using a value of 0 or 1 in dividing the points constituting a point cloud into patches and mapping the same to the 2D plane. The occupancy map may represent a 2D array corresponding to ATLAS, and the values of the occupancy map may indicate whether each sample position in the atlas corresponds to a 3D point.

An atlas is a collection of 2D bounding boxes positioned in a rectangular frame that correspond to a 3D bounding box in a 3D space in which volumetric data is rendered and information related thereto.

The atlas bitstream is a bitstream for one or more atlas frames constituting an atlas and related data.

The atlas frame is a 2D rectangular array of atlas samples onto which patches are projected.

An atlas sample is a position of a rectangular frame onto which patches associated with the atlas are projected.

An atlas frame may be partitioned into tiles. A tile is a unit in which a 2D frame is partitioned. That is, a tile is a unit for partitioning signaling information of point cloud data called an atlas.

Patch: A set of points constituting a point cloud, which indicates that points belonging to the same patch are adjacent to each other in 3D space and are mapped in the same direction among 6-face bounding box planes in the process of mapping to a 2D image.

Geometry image: this is an image in the form of a depth map that presents position information (geometry) about each point constituting a point cloud on a patch-by-patch basis. The geometry image may be composed of pixel values of one channel. Geometry represents a set of coordinates associated with a point cloud frame.

Texture image: this is an image representing the color information about each point constituting a point cloud on a patch-by-patch basis. A texture image may be composed of pixel values of a plurality of channels (e.g., three channels of R, G, and B). The texture is included in an attribute. According to embodiments, a texture and/or attribute may be interpreted as the same object and/or having an inclusive relationship.

Auxiliary patch info: this indicates metadata needed to reconstruct a point cloud with individual patches. Auxiliary patch info may include information about the position, size, and the like of a patch in a 2D/3D space.

Point cloud data according to the embodiments, for example, V-PCC components may include an atlas, an occupancy map, geometry, and attributes.

Atlas represents a set of 2D bounding boxes. It may be patches, for example, patches projected onto a rectangular frame. Atlas may correspond to a 3D bounding box in a 3D space, and may represent a subset of a point cloud.

An attribute may represent a scalar or vector associated with each point in the point cloud. For example, the attributes may include color, reflectance, surface normal, time stamps, material ID.

The point cloud data according to the embodiments represents PCC data according to video-based point cloud compression (V-PCC) scheme. The point cloud data may include a plurality of components. For example, it may include an occupancy map, a patch, geometry and/or texture.

FIG. 4 illustrates a V-PCC encoding process according to embodiments.

The figure illustrates a V-PCC encoding process for generating and compressing an occupancy map, a geometry image, a texture image, and auxiliary patch information. The V-PCC encoding process of FIG. 4 may be processed by the point cloud video encoder 10002 of FIG. 1. Each element of FIG. 4 may be performed by software, hardware, processor and/or a combination thereof.

The patch generation or patch generator 40000 receives a point cloud frame (which may be in the form of a bitstream containing point cloud data). The patch generator 40000 generates a patch from the point cloud data. In addition, patch information including information about patch generation is generated.

The patch packing or patch packer 40001 packs patches for point cloud data. For example, one or more patches may be packed. In addition, the patch packer generates an occupancy map containing information about patch packing.

The geometry image generation or geometry image generator 40002 generates a geometry image based on the point cloud data, patches, and/or packed patches. The geometry image refers to data containing geometry related to the point cloud data.

The texture image generation or texture image generator 40003 generates a texture image based on the point cloud data, patches, and/or packed patches. In addition, the texture image may be generated further based on smoothed geometry generated by smoothing processing of smoothing based on the patch information.

The smoothing or smoother 40004 may mitigate or eliminate errors contained in the image data. For example, based on the patched reconstructed geometry image, portions that may cause errors between data may be smoothly filtered out to generate smoothed geometry.

The auxiliary patch info compression or auxiliary patch info compressor 40005, auxiliary patch information related to the patch information generated in the patch generation is compressed. In addition, the compressed auxiliary patch information may be transmitted to the multiplexer. The auxiliary patch information may be used in the geometry image generation 40002.

The image padding or image padder 40006, 40007 may pad the geometry image and the texture image, respectively. The padding data may be padded to the geometry image and the texture image.

The group dilation or group dilator 40008 may add data to the texture image in a similar manner to image padding. The added data may be inserted into the texture image.

The video compression or video compressor 40009, 40010, 40011 may compress the padded geometry image, the padded texture image, and/or the occupancy map, respectively. The compression may encode geometry information, texture information, occupancy information, and the like.

The entropy compression or entropy compressor 40012 may compress (e.g., encode) the occupancy map based on an entropy scheme.

According to embodiments, the entropy compression and/or video compression may be performed, respectively depending on whether the point cloud data is lossless and/or lossy.

The multiplexer 40013 multiplexes the compressed geometry image, the compressed texture image, and the compressed occupancy map into a bitstream.

The specific operations in the respective processes of FIG. 4 are described below. Patch generation 40000

The patch generation process refers to a process of dividing a point cloud into patches, which are mapping units, in order to map the point cloud to the 2D image. The patch generation process may be divided into three steps: normal value calculation, segmentation, and patch segmentation.

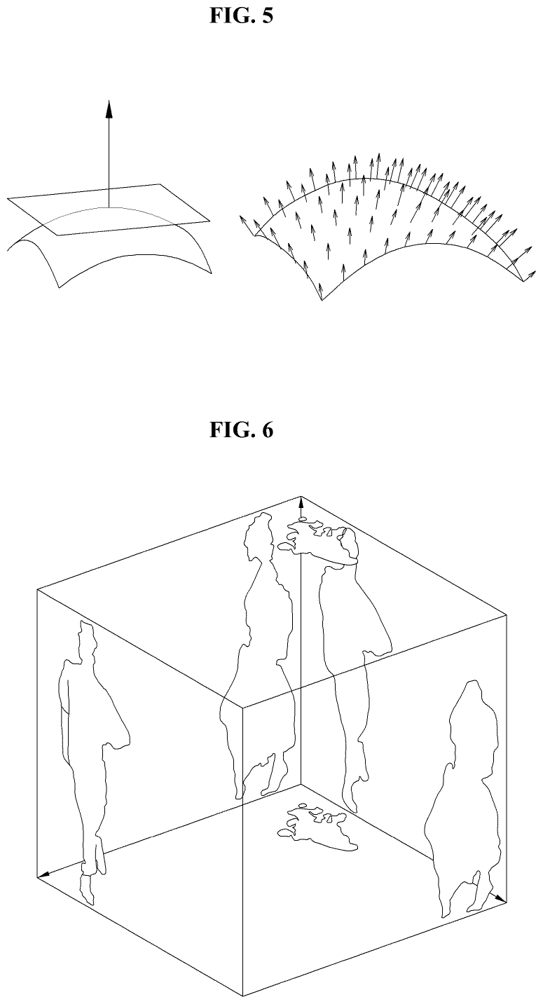

The normal value calculation process will be described in detail with reference to FIG. 5.

FIG. 5 illustrates an example of a tangent plane and a normal vector of a surface according to embodiments.

The surface of FIG. 5 is used in the patch generation process 40000 of the V-PCC encoding process of FIG. 4 as follows.

Normal calculation related to patch generation:

Each point of a point cloud has its own direction, which is represented by a 3D vector called a normal vector. Using the neighbors of each point obtained using a K-D tree or the like, a tangent plane and a normal vector of each point constituting the surface of the point cloud as shown in the figure may be obtained. The search range applied to the process of searching for neighbors may be defined by the user.

The tangent plane refers to a plane that passes through a point on the surface and completely includes a tangent line to the curve on the surface.

FIG. 6 illustrates an exemplary bounding box of a point cloud according to embodiments.

A method/device according to embodiments, for example, patch generation, may employ a bounding box in generating a patch from point cloud data.

The bounding box according to the embodiments refers to a box of a unit for dividing point cloud data based on a hexahedron in a 3D space.

The bounding box may be used in the process of projecting a target object of the point cloud data onto a plane of each planar face of a hexahedron in a 3D space. The bounding box may be generated and processed by the point cloud video acquirer 10000 and the point cloud video encoder 10002 of FIG. 1. Further, based on the bounding box, the patch generation 40000, patch packing 40001, geometry image generation 40002, and texture image generation 40003 of the V-PCC encoding process of FIG. 2 may be performed.

Segmentation related to patch generation

Segmentation is divided into two processes: initial segmentation and refine segmentation.

The point cloud encoder 10002 according to the embodiments projects a point onto one face of a bounding box. Specifically, each point constituting a point cloud is projected onto one of the six faces of a bounding box surrounding the point cloud as shown in the figure. Initial segmentation is a process of determining one of the planar faces of the bounding box onto which each point is to be projected.

\vec{n}ₚ_{ᵢ}, which is a normal value corresponding to each of the six planar faces, is defined as follows:

(1.0, 0.0, 0.0), (0.0, 1.0, 0.0), (0.0, 0.0, 1.0), (−1.0, 0.0, 0.0), (0.0,-1.0, 0.0), (0.0, 0.0,-1.0).

As shown in the equation below, a face that yields the maximum value of dot product of the normal vector \vec{n}nₚ_{ᵢ} of each point, which is obtained in the normal value calculation process, and \vec{n}nₚ_{_{idx}} is determined as a projection plane of the corresponding point. That is, a plane whose normal vector is most similar to the direction of the normal vector of a point is determined as the projection plane of the point.

$${max}_{{p}_{idx}} \{ {\vec{n}}_{{p}_{i}} \cdot {\vec{n}}_{{p}_{idx}} \}$$

The determined plane may be identified by one cluster index, which is one of 0 to 5.

Refine segmentation is a process of enhancing the projection plane of each point constituting the point cloud determined in the initial segmentation process in consideration of the projection planes of neighboring points. In this process, a score normal, which represents the degree of similarity between the normal vector of each point and the normal of each planar face of the bounding box which are considered in determining the projection plane in the initial segmentation process, and score smooth, which indicates the degree of similarity between the projection plane of the current point and the projection planes of neighboring points, may be considered together.

Score smooth may be considered by assigning a weight to the score normal. In this case, the weight value may be defined by the user. The refine segmentation may be performed repeatedly, and the number of repetitions may also be defined by the user.

Patch segmentation related to patch generation

Patch segmentation is a process of dividing the entire point cloud into patches, which are sets of neighboring points, based on the projection plane information about each point constituting the point cloud obtained in the initial/refine segmentation process. The patch segmentation may include the following steps:

1) Calculate neighboring points of each point constituting the point cloud, using the K-D tree or the like. The maximum number of neighbors may be defined by the user;

2) When the neighboring points are projected onto the same plane as the current point (when they have the same cluster index), extract the current point and the neighboring points as one patch;

3) Calculate geometry values of the extracted patch. The details are described below; and

4) Repeat operations 2) to 4) until there is no unextracted point.

The occupancy map, geometry image and texture image for each patch as well as the size of each patch are determined through the patch segmentation process.

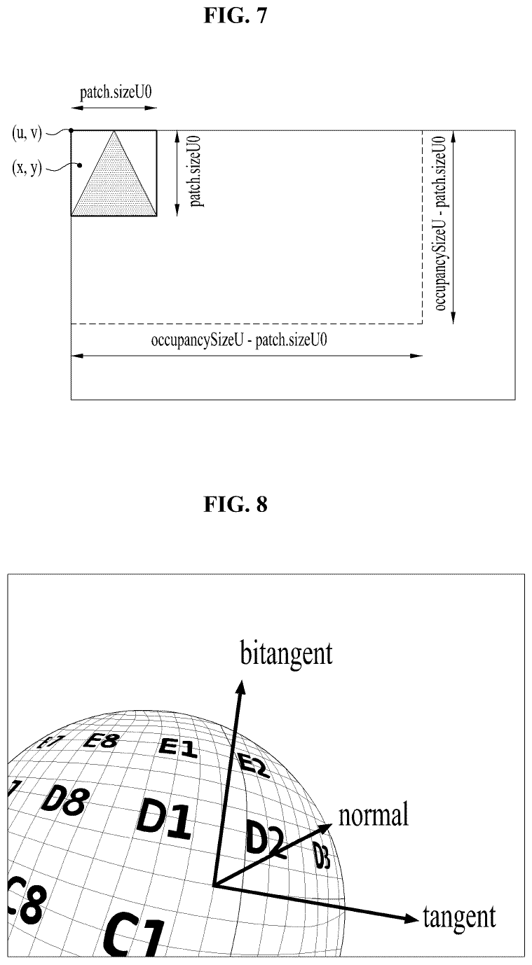

FIG. 7 illustrates an example of determination of individual patch positions on an occupancy map according to embodiments.

The point cloud encoder 10002 according to the embodiments may perform patch packing and generate an occupancy map.

Patch packing & occupancy map generation (40001)

This is a process of determining the positions of individual patches in a 2D image to map the segmented patches to the 2D image. The occupancy map, which is a kind of 2D image, is a binary map that indicates whether there is data at a corresponding position, using a value of 0 or 1. The occupancy map is composed of blocks and the resolution thereof may be determined by the size of the block. For example, when the block is 1*1 block, a pixel-level resolution is obtained. The occupancy packing block size may be determined by the user.

The process of determining the positions of individual patches on the occupancy map may be configured as follows:

1) Set all positions on the occupancy map to 0;

2) Place a patch at a point (u, v) having a horizontal coordinate within the range of (0, occupancySizeU-patch.sizeU0) and a vertical coordinate within the range of (0, occupancySizeV-patch.sizeV0) in the occupancy map plane;

3) Set a point (x, y) having a horizontal coordinate within the range of (0, patch.sizeU0) and a vertical coordinate within the range of (0, patch.sizeV0) in the patch plane as a current point;

4) Change the position of point (x, y) in raster order and repeat operations 3) and 4) if the value of coordinate (x, y) on the patch occupancy map is 1 (there is data at the point in the patch) and the value of coordinate (u+x, v+y) on the global occupancy map is 1 (the occupancy map is filled with the previous patch). Otherwise, proceed to operation 6);

5) Change the position of (u, v) in raster order and repeat operations 3) to 5);

6) Determine (u, v) as the position of the patch and copy the occupancy map data about the patch onto the corresponding portion on the global occupancy map; and

7) Repeat operations 2) to 7) for the next patch.

occupancySizeU: indicates the width of the occupancy map. The unit thereof is occupancy packing block size.

occupancy SizeV: indicates the height of the occupancy map. The unit thereof is occupancy packing block size.

patch.sizeU0: indicates the width of the occupancy map. The unit thereof is occupancy packing block size.

patch.sizeV0: indicates the height of the occupancy map. The unit thereof is occupancy packing block size.

For example, as shown in FIG. 7, there is a box corresponding to a patch having a patch size in a box corresponding to an occupancy packing size block, and a point (x, y) may be located in the box.

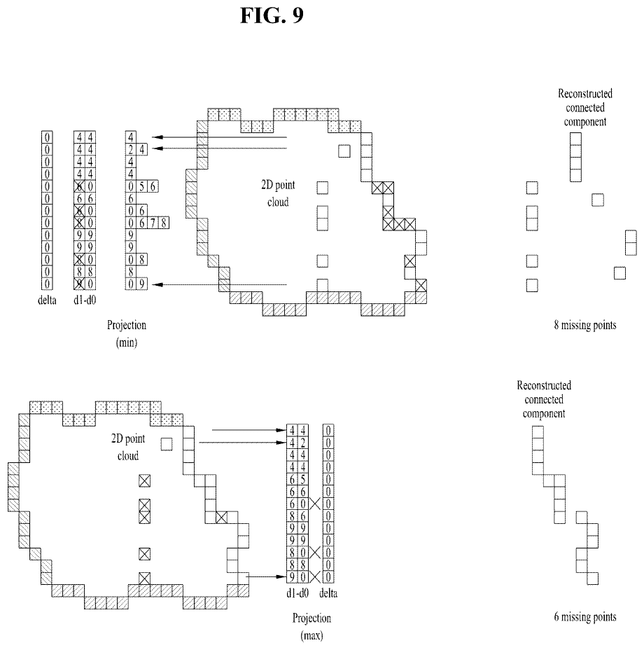

FIG. 8 shows an exemplary relationship among normal, tangent, and bitangent axes according to embodiments.

The point cloud encoder 10002 according to embodiments may generate a geometry image. The geometry image refers to image data including geometry information about a point cloud. The geometry image generation process may employ three axes (normal, tangent, and bitangent) of a patch in FIG. 8.

Geometry image generation (40002)

In this process, the depth values constituting the geometry images of individual patches are determined, and the entire geometry image is generated based on the positions of the patches determined in the patch packing process described above. The process of determining the depth values constituting the geometry images of individual patches may be configured as follows.

1) Calculate parameters related to the position and size of an individual patch. The parameters may include the following information.

A normal index indicating the normal axis is obtained in the previous patch generation process. The tangent axis is an axis coincident with the horizontal axis u of the patch image among the axes perpendicular to the normal axis, and the bitangent axis is an axis coincident with the vertical axis v of the patch image among the axes perpendicular to the normal axis. The three axes may be expressed as shown in the figure.

FIG. 9 shows an exemplary configuration of the minimum mode and maximum mode of a projection mode according to embodiments.

The point cloud encoder 10002 according to embodiments may perform patch-based projection to generate a geometry image, and the projection mode according to the embodiments includes a minimum mode and a maximum mode.

3D spatial coordinates of a patch may be calculated based on the bounding box of the minimum size surrounding the patch. For example, the 3D spatial coordinates may include the minimum tangent value of the patch (on the patch 3d shift tangent axis) of the patch, the minimum bitangent value of the patch (on the patch 3d shift bitangent axis), and the minimum normal value of the patch (on the patch 3d shift normal axis).

2D size of a patch indicates the horizontal and vertical sizes of the patch when the patch is packed into a 2D image. The horizontal size (patch 2d size u) may be obtained as a difference between the maximum and minimum tangent values of the bounding box, and the vertical size (patch 2d size v) may be obtained as a difference between the maximum and minimum bitangent values of the bounding box.

2) Determine a projection mode of the patch. The projection mode may be either the min mode or the max mode. The geometry information about the patch is expressed with a depth value. When each point constituting the patch is projected in the normal direction of the patch, two layers of images, an image constructed with the maximum depth value and an image constructed with the minimum depth value, may be generated.

In the min mode, in generating the two layers of images d0 and d1, the minimum depth may be configured for d0, and the maximum depth within the surface thickness from the minimum depth may be configured for d1, as shown in the figure.

For example, when a point cloud is located in 2D as illustrated in the figure, there may be a plurality of patches including a plurality of points. As shown in the figure, it is indicated that points marked with the same style of shadow may belong to the same patch. The figure illustrates the process of projecting a patch of points marked with blanks.

When projecting points marked with blanks to the left/right, the depth may be incremented by 1 as 0, 1, 2, . . . , 6, 7, 8, 9 with respect to the left side, and the number for calculating the depths of the points may be marked on the right side.

The same projection mode may be applied to all point clouds or different projection modes may be applied to respective frames or patches according to user definition. When different projection modes are applied to the respective frames or patches, a projection mode that may enhance compression efficiency or minimize missed points may be adaptively selected.

3) Calculate the depth values of the individual points.

In the min mode, image d0 is constructed with depth0, which is a value obtained by subtracting the minimum normal value of the patch (on the patch 3d shift normal axis) calculated in operation 1) from the minimum normal value of the patch (on the patch 3d shift normal axis) for the minimum normal value of each point. If there is another depth value within the range between depth0 and the surface thickness at the same position, this value is set to depth1. Otherwise, the value of depth0 is assigned to depth1. Image d1 is constructed with the value of depth 1.

For example, a minimum value may be calculated in determining the depth of points of image d0 (4 2 4 4 0 6 0 0 9 9 0 8 0). In determining the depth of points of image d1, a greater value among two or more points may be calculated. When only one point is present, the value thereof may be calculated (4 4 4 4 6 6 6 8 9 9 8 8 9). In the process of encoding and reconstructing the points of the patch, some points may be lost (For example, in the figure, eight points are lost).

In the max mode, image do is constructed with depth0, which is a value obtained by subtracting the minimum normal value of the patch (on the patch 3d shift normal axis) calculated in operation 1) from the minimum normal value of the patch (on the patch 3d shift normal axis) for the maximum normal value of each point. If there is another depth value within the range between depth0 and the surface thickness at the same position, this value is set to depth1. Otherwise, the value of depth0 is assigned to depth1. Image dl is constructed with the value of depth 1.

For example, a maximum value may be calculated in determining the depth of points of do (4 4 4 4 6 6 6 8 9 9 8 8 9). In addition, in determining the depth of points of d1, a lower value among two or more points may be calculated. When only one point is present, the value thereof may be calculated (4 2 4 4 5 6 0 6 9 9 0 8 0). In the process of encoding and reconstructing the points of the patch, some points may be lost (For example, in the figure, six points are lost).

The entire geometry image may be generated by placing the geometry images of the individual patches generated through the above-described processes onto the entire geometry image based on the patch position information determined in the patch packing process.

Layer d1 of the generated entire geometry image may be encoded using various methods. A first method (absolute d1 method) is to encode the depth values of the previously generated image d1. A second method (differential method) is to encode a difference between the depth values of previously generated image d1 and the depth values of image d0.

In the encoding method using the depth values of the two layers, d0 and d1 as described above, if there is another point between the two depths, the geometry information about the point is lost in the encoding process, and therefore an enhanced-delta-depth (EDD) code may be used for lossless coding.

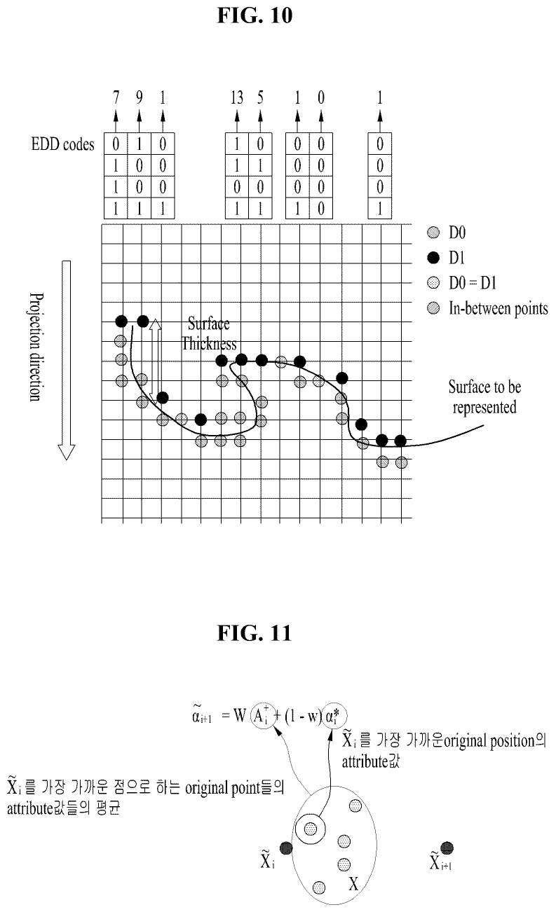

Hereinafter, the EDD code will be described in detail with reference to FIG. 10.

FIG. 10 illustrates an exemplary EDD code according to embodiments.

In some/all processes of the point cloud encoder 10002 and/or V-PCC encoding (e.g., video compression 40009), the geometry information about points may be encoded based on the EOD code.

As shown in the figure, the EDD code is used for binary encoding of the positions of all points within the range of surface thickness including d1. For example, in the figure, the points included in the second left column may be represented by an EDD code of 0b1001 (=9) because the points are present at the first and fourth positions over DO and the second and third positions are empty. When the EDD code is encoded together with DO and transmitted, a reception terminal may restore the geometry information about all points without loss.

For example, when there is a point present above a reference point, the value is 1. When there is no point, the value is 0. Thus, the code may be expressed based on 4 bits. Smoothing (40004)

Smoothing is an operation for eliminating discontinuity that may occur on the patch boundary due to deterioration of the image quality occurring during the compression process. Smoothing may be performed by the point cloud encoder or smoother:

1) Reconstruct the point cloud from the geometry image. This operation may be the reverse of the geometry image generation described above. For example, the reverse process of encoding may be reconstructed;

2) Calculate neighboring points of each point constituting the reconstructed point cloud using the K-D tree or the like;

3) Determine whether each of the points is positioned on the patch boundary. For example, when there is a neighboring point having a different projection plane (cluster index) from the current point, it may be determined that the point is positioned on the patch boundary;

4) If there is a point present on the patch boundary, move the point to the center of mass of the neighboring points (positioned at the average x, y, z coordinates of the neighboring points). That is, change the geometry value. Otherwise, maintain the previous geometry value.

FIG. 11 illustrates an example of recoloring based on color values of neighboring points according to embodiments.

The point cloud encoder or the texture image generator 40003 according to the embodiments may generate a texture image based on recoloring.

Texture image generation (40003)

The texture image generation process, which is similar to the geometry image generation process described above, includes generating texture images of individual patches and generating an entire texture image by arranging the texture images at determined positions. However, in the operation of generating texture images of individual patches, an image with color values (e.g., R, G, and B values) of the points constituting a point cloud corresponding to a position is generated in place of the depth values for geometry generation.

In estimating a color value of each point constituting the point cloud, the geometry previously obtained through the smoothing process may be used. In the smoothed point cloud, the positions of some points may have been shifted from the original point cloud, and accordingly a recoloring process of finding colors suitable for the changed positions may be required. Recoloring may be performed using the color values of neighboring points. For example, as shown in the figure, a new color value may be calculated in consideration of the color value of the nearest neighboring point and the color values of the neighboring points.

For example, referring to the figure, in the recoloring, a suitable color value for a changed position may be calculated based on the average of the attribute information about the closest original points to a point and/or the average of the attribute information about the closest original positions to the point.

Texture images may also be generated in two layers of t0 and t1, like the geometry

images, which are generated in two layers of d0 and d1.

Auxiliary patch info compression (40005)

The point cloud encoder or the auxiliary patch info compressor according to the embodiments may compress the auxiliary patch information (auxiliary information about the point cloud).

The auxiliary patch info compressor compresses the auxiliary patch information generated in the patch generation, patch packing, and geometry generation processes described above. The auxiliary patch information may include the following parameters:

Index (cluster index) for identifying the projection plane (normal plane);

3D spatial position of a patch, i.e., the minimum tangent value of the patch (on the patch 3d shift tangent axis), the minimum bitangent value of the patch (on the patch 3d shift bitangent axis), and the minimum normal value of the patch (on the patch 3d shift normal axis);

2D spatial position and size of the patch, i.e., the horizontal size (patch 2d size u), the vertical size (patch 2d size v), the minimum horizontal value (patch 2d shift u), and the minimum vertical value (patch 2d shift u); and

Mapping information about each block and patch, i.e., a candidate index (when patches are disposed in order based on the 2D spatial position and size information about the patches, multiple patches may be mapped to one block in an overlapping manner. In this case, the mapped patches constitute a candidate list, and the candidate index indicates the position in sequential order of a patch whose data is present in the block), and a local patch index (which is an index indicating one of the patches present in the frame). Table X shows a pseudo code representing the process of matching between blocks and patches based on the candidate list and the local patch indexes.

The maximum number of candidate lists may be defined by a user.

for(i=0; i<BlockCount; i++) {
if(candidatePatches[i].size( ) == 1) {
blockToPatch[i] = candidatePatches[i][0] } else {
candidate_index
if(candidate_index == max_candidate_count){
blockToPatch[i] = local_patch_index } else {
blockToPatch[i] = candidatePatches[i][candidate_index }
}

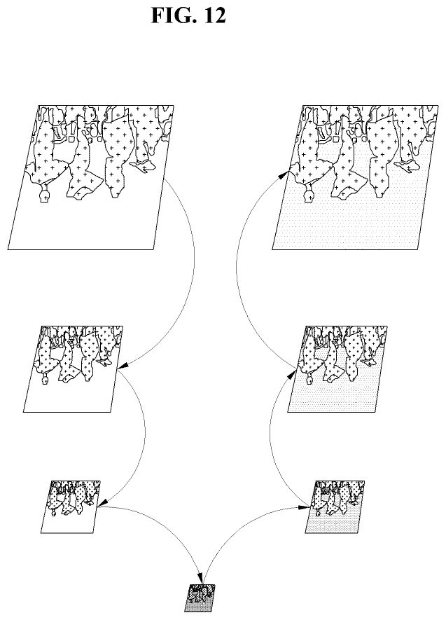

FIG. 12 illustrates push-pull background filling according to embodiments. Image padding and group dilation (40006, 40007, 40008)

The image padder according to the embodiments may fill the space except the patch area with meaningless supplemental data based on the push-pull background filling technique.

Image padding is a process of filling the space other than the patch region with meaningless data to improve compression efficiency. For image padding, pixel values in columns or rows close to a boundary in the patch may be copied to fill the empty space. Alternatively, as shown in the figure, a push-pull background filling method may be used. According to this method, the empty space is filled with pixel values from a low resolution image in the process of gradually reducing the resolution of a non-padded image and increasing the resolution again.

Group dilation is a process of filling the empty spaces of a geometry image and a texture image configured in two layers, d0/d1 and t0/t1, respectively. In this process, the empty spaces of the two layers calculated through image padding are filled with the average of the values for the same position.

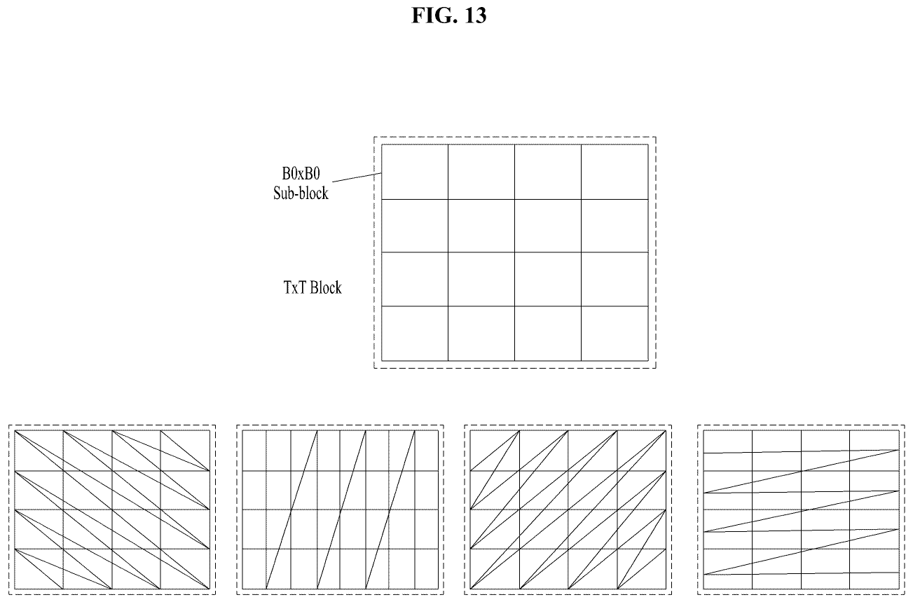

FIG. 13 shows an exemplary possible traversal order for a 4*4 block according to embodiments.

Occupancy map compression (40012, 40011)

The occupancy map compressor according to the embodiments may compress the previously generated occupancy map. Specifically, two methods, namely video compression for lossy compression and entropy compression for lossless compression, may be used. Video compression is described below.

The entropy compression may be performed through the following operations.

1) If a block constituting an occupancy map is fully occupied, encode 1 and repeat the same operation for the next block of the occupancy map. Otherwise, encode 0 and perform operations 2) to 5).

2) Determine the best traversal order to perform run-length coding on the occupied pixels of the block. The figure shows four possible traversal orders for a 4*4 block.

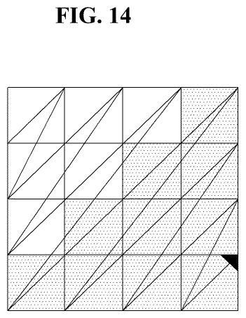

FIG. 14 illustrates an exemplary best traversal order according to embodiments.

As described above, the entropy compressor according to the embodiments may code (encode) a block based on the traversal order scheme as described above.

For example, the best traversal order with the minimum number of runs is selected from among the possible traversal orders and the index thereof is encoded. The figure illustrates a case where the third traversal order in FIG. 13 is selected. In the illustrated case, the number of runs may be minimized to 2, and therefore the third traversal order may be selected as the best traversal order.

3) Encode the number of runs. In the example of FIG. 14, there are two runs, and therefore 2 is encoded.

4) Encode the occupancy of the first run. In the example of FIG. 14, 0 is encoded because the first run corresponds to unoccupied pixels.

5) Encode lengths of the individual runs (as many as the number of runs). In the example of FIG. 14, the lengths of the first run and the second run, 6 and 10, are sequentially encoded. Video compression (40009, 40010, 40011)

The video compressor according to the embodiments encodes a sequence of a geometry image, a texture image, an occupancy map image, and the like generated in the above-described operations, using a 2D video codec such as HEVC or VVC.

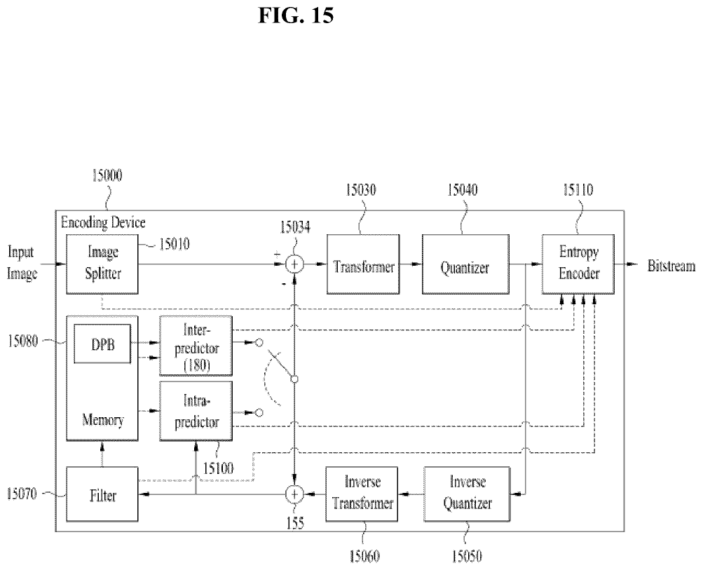

FIG. 15 illustrates an exemplary 2D video/image encoder according to embodiments.

The figure, which represents an embodiment to which the video compression or video compressor 40009, 40010, and 40011 described above is applied, is a schematic block diagram of a 2D video/image encoder 15000 configured to encode a video/image signal. The 2D video/image encoder 15000 may be included in the point cloud video encoder described above or may be configured as an internal/external component. Each component of FIG. 15 may correspond to software, hardware, processor and/or a combination thereof.

Here, the input image may include the geometry image, the texture image (attribute(s) image), and the occupancy map image described above. The output bitstream (i.e., the point cloud video/image bitstream) of the point cloud video encoder may include output bitstreams for the respective input images (i.e., the geometry image, the texture image (attribute(s) image), the occupancy map image, etc.).

An inter-predictor 15090 and an intra-predictor 15100 may be collectively called a predictor. That is, the predictor may include the inter-predictor 15090 and the intra-predictor 15100. A transformer 15030, a quantizer 15040, an inverse quantizer 15050, and an inverse transformer 15060 may be included in the residual processor. The residual processor may further include a subtractor 15020. According to an embodiment, the image splitter 15010, the subtractor 15020, the transformer 15030, the quantizer 15040, the inverse quantizer 15050, the inverse transformer 15060, the adder 155, the filter 15070, the inter-predictor 15090, the intra-predictor 15100, and the entropy encoder 15110 described above may be configured by one hardware component (e.g., an encoder or a processor). In addition, the memory 15080 may include a decoded picture buffer (DPB) and may be configured by a digital storage medium.

The image splitter 15010 may spit an image (or a picture or a frame) input to the encoder 15000 into one or more processing units. For example, the processing unit may be called a coding unit (CU). In this case, the CU may be recursively split from a coding tree unit (CTU) or a largest coding unit (LCU) according to a quad-tree binary-tree (QTBT) structure. For example, one CU may be split into a plurality of CUs of a lower depth based on a quad-tree structure and/or a binary-tree structure. In this case, for example, the quad-tree structure may be applied first and the binary-tree structure may be applied later. Alternatively, the binary-tree structure may be applied first. The coding procedure according to the present disclosure may be performed based on a final CU that is not split anymore. In this case, the LCU may be used as the final CU based on coding efficiency according to characteristics of the image. When necessary, a CU may be recursively split into CUs of a lower depth, and a CU of the optimum size may be used as the final CU. Here, the coding procedure may include prediction, transformation, and reconstruction, which will be described later. As another example, the processing unit may further include a prediction unit (PU) or a transform unit (TU). In this case, the PU and the TU may be split or partitioned from the aforementioned final CU. The PU may be a unit of sample prediction, and the TU may be a unit for deriving a transform coefficient and/or a unit for deriving a residual signal from the transform coefficient.

The term “unit” may be used interchangeably with terms such as block or area. In a general case, an M×N block may represent a set of samples or transform coefficients configured in M columns and N rows. A sample may generally represent a pixel or a value of a pixel, and may indicate only a pixel/pixel value of a luma component, or only a pixel/pixel value of a chroma component. “Sample” may be used as a term corresponding to a pixel or a pel in one picture (or image).

The encoder 15000 may generate a residual signal (residual block or residual sample array) by subtracting a prediction signal (predicted block or predicted sample array) output from the inter-predictor 15090 or the intra-predictor 15100 from an input image signal (original block or original sample array), and the generated residual signal is transmitted to the transformer 15030. In this case, as shown in the figure, the unit that subtracts the prediction signal (predicted block or predicted sample array) from the input image signal (original block or original sample array) in the encoder 15000 may be called a subtractor 15020. The predictor may perform prediction for a processing target block (hereinafter referred to as a current block) and generate a predicted block including prediction samples for the current block. The predictor may determine whether intra-prediction or inter-prediction is applied on a current block or CU basis. As will be described later in the description of each prediction mode, the predictor may generate various kinds of information about prediction, such as prediction mode information, and deliver the generated information to the entropy encoder 15110. The information about the prediction may be encoded and output in the form of a bitstream by the entropy encoder 15110.

The intra-predictor 15100 may predict the current block with reference to the samples in the current picture. The samples may be positioned in the neighbor of or away from the current block depending on the prediction mode. In intra-prediction, the prediction modes may include a plurality of non-directional modes and a plurality of directional modes. The non-directional modes may include, for example, a DC mode and a planar mode. The directional modes may include, for example, 33 directional prediction modes or 65 directional prediction modes according to fineness of the prediction directions. However, this is merely an example, and more or fewer directional prediction modes may be used depending on the setting. The intra-predictor 15100 may determine a prediction mode to be applied to the current block, based on the prediction mode applied to the neighboring block.

The inter-predictor 15090 may derive a predicted block for the current block based on a reference block (reference sample array) specified by a motion vector on the reference picture. In this case, in order to reduce the amount of motion information transmitted in the inter-prediction mode, the motion information may be predicted on a per block, subblock, or sample basis based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. The reference picture including the reference block may be the same as or different from the reference picture including the temporal neighboring block. The temporal neighboring block may be referred to as a collocated reference block or a collocated CU (colCU), and the reference picture including the temporal neighboring block may be referred to as a collocated picture (colPic). For example, the inter-predictor 15090 may configure a motion information candidate list based on the neighboring blocks and generate information indicating a candidate to be used to derive a motion vector and/or a reference picture index of the current block. Inter-prediction may be performed based on various prediction modes. For example, in a skip mode and a merge mode, the inter-predictor 15090 may use motion information about a neighboring block as motion information about the current block. In the skip mode, unlike the merge mode, the residual signal may not be transmitted. In a motion vector prediction (MVP) mode, the motion vector of a neighboring block may be used as a motion vector predictor and the motion vector difference may be signaled to indicate the motion vector of the current block.

The prediction signal generated by the inter-predictor 15090 or the intra-predictor 15100 may be used to generate a reconstruction signal or to generate a residual signal.

The transformer 15030 may generate transform coefficients by applying a transformation technique to the residual signal. For example, the transformation technique may include at least one of discrete cosine transform (DCT), discrete sine transform (DST), Karhunen-Loève transform (KLT), graph-based transform (GBT), or conditionally non-linear transform (CNT). Here, the GBT refers to transformation obtained from a graph depicting the relationship between pixels. The CNT refers to transformation obtained based on a prediction signal generated based on all previously reconstructed pixels. In addition, the transformation operation may be applied to pixel blocks having the same size of a square, or may be applied to blocks of a variable size other than the square.

The quantizer 15040 may quantize the transform coefficients and transmit the same to the entropy encoder 15110. The entropy encoder 15110 may encode the quantized signal (information about the quantized transform coefficients) and output a bitstream of the encoded signal. The information about the quantized transform coefficients may be referred to as residual information. The quantizer 15040 may rearrange the quantized transform coefficients, which are in a block form, in the form of a one-dimensional vector based on a coefficient scan order, and generate information about the quantized transform coefficients based on the quantized transform coefficients in the form of the one-dimensional vector. The entropy encoder 15110 may employ various encoding techniques such as, for example, exponential Golomb, context-adaptive variable length coding (CAVLC), and context-adaptive binary arithmetic coding (CABAC). The entropy encoder 15110 may encode information necessary for video/image reconstruction (e.g., values of syntax elements) together with or separately from the quantized transform coefficients. The encoded information (e.g., encoded video/image information) may be transmitted or stored in the form of a bitstream on a network abstraction layer (NAL) unit basis. The bitstream may be transmitted over a network or may be stored in a digital storage medium. Here, the network may include a broadcast network and/or a communication network, and the digital storage medium may include various storage media such as USB, SD, CD, DVD, Blu-ray, HDD, and SSD. A transmitter (not shown) to transmit the signal output from the entropy encoder 15110 and/or a storage (not shown) to store the signal may be configured as internal/external elements of the encoder 15000. Alternatively, the transmitter may be included in the entropy encoder 15110.

The quantized transform coefficients output from the quantizer 15040 may be used to generate a prediction signal. For example, inverse quantization and inverse transform may be applied to the quantized transform coefficients through the inverse quantizer 15050 and the inverse transformer 15060 to reconstruct the residual signal (residual block or residual samples). The adder 155 may add the reconstructed residual signal to the prediction signal output from the inter-predictor 15090 or the intra-predictor 15100. Thereby, a reconstructed signal (reconstructed picture, reconstructed block, reconstructed sample array) may be generated. When there is no residual signal for a processing target block as in the case where the skip mode is applied, the predicted block may be used as the reconstructed block. The adder 155 may be called a reconstructor or a reconstructed block generator. The generated reconstructed signal may be used for intra-prediction of the next processing target block in the current picture, or may be used for inter-prediction of the next picture through filtering as described below.

The filter 15070 may improve subjective/objective image quality by applying filtering to the reconstructed signal. For example, the filter 15070 may generate a modified reconstructed picture by applying various filtering techniques to the reconstructed picture, and the modified reconstructed picture may be stored in the memory 15080, specifically, the DPB of the memory 15080. The various filtering techniques may include, for example, deblocking filtering, sample adaptive offset, adaptive loop filtering, and bilateral filtering. As described below in the description of the filtering techniques, the filter 15070 may generate various kinds of information about filtering and deliver the generated information to the entropy encoder 15110. The information about filtering may be encoded and output in the form of a bitstream by the entropy encoder 15110.

The modified reconstructed picture transmitted to the memory 15080 may be used as a reference picture by the inter-predictor 15090. Thus, when inter-prediction is applied, the encoder may avoid prediction mismatch between the encoder 15000 and the decoder and improve encoding efficiency.

The DPB of the memory 15080 may store the modified reconstructed picture so as to be used as a reference picture by the inter-predictor 15090. The memory 15080 may store the motion information about a block from which the motion information in the current picture is derived (or encoded) and/or the motion information about the blocks in a picture that has already been reconstructed. The stored motion information may be delivered to the inter-predictor 15090 so as to be used as motion information about a spatial neighboring block or motion information about a temporal neighboring block. The memory 15080 may store the reconstructed samples of the reconstructed blocks in the current picture and deliver the reconstructed samples to the intra-predictor 15100.

At least one of the prediction, transform, and quantization procedures described above may be skipped. For example, for a block to which the pulse coding mode (PCM) is applied, the prediction, transform, and quantization procedures may be skipped, and the value of the original sample may be encoded and output in the form of a bitstream.

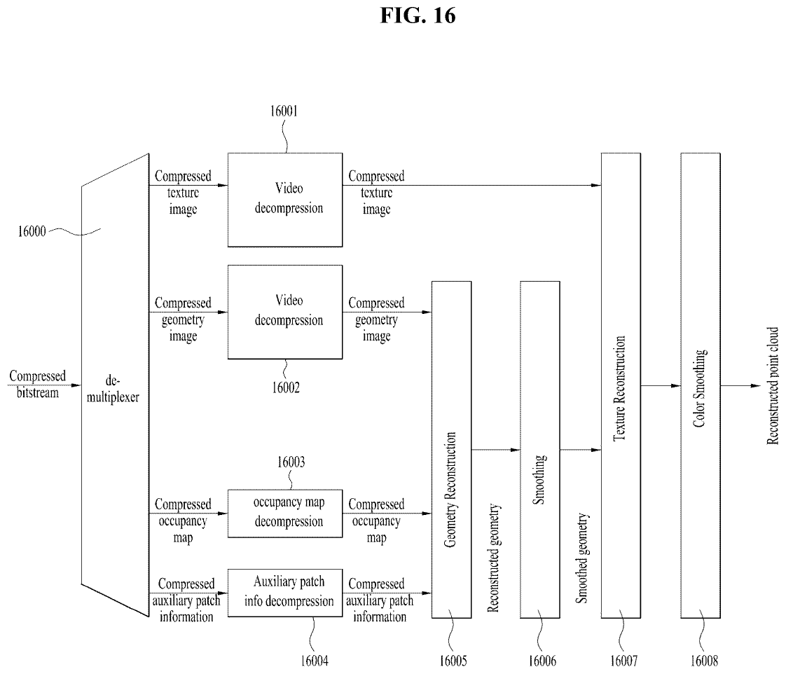

FIG. 16 illustrates an exemplary V-PCC decoding process according to embodiments.

The V-PCC decoding process or V-PCC decoder may follow the reverse process of the V-PCC encoding process (or encoder) of FIG. 4. Each component in FIG. 16 may correspond to software, hardware, a processor, and/or a combination thereof.

The demultiplexer 16000 demultiplexes the compressed bitstream to output a compressed texture image, a compressed geometry image, a compressed occupancy map, and compressed auxiliary patch information.

The video decompression or video decompressor 16001, 16002 decompresses (or decodes) each of the compressed texture image and the compressed geometry image.

The occupancy map decompression or occupancy map decompressor 16003 decompresses the compressed occupancy map.

The auxiliary patch info decompression or auxiliary patch info decompressor 16004 decompresses auxiliary patch information.

The geometry reconstruction or geometry reconstructor 16005 restores (reconstructs) the geometry information based on the decompressed geometry image, the decompressed occupancy map, and/or the decompressed auxiliary patch information. For example, the geometry changed in the encoding process may be reconstructed.

The smoothing or smoother 16006 may apply smoothing to the reconstructed geometry. For example, smoothing filtering may be applied.

The texture reconstruction or texture reconstructor 16007 reconstructs the texture from the decompressed texture image and/or the smoothed geometry.

The color smoothing or color smoother 16008 smoothes color values from the reconstructed texture. For example, smoothing filtering may be applied.

As a result, reconstructed point cloud data may be generated.

The figure illustrates a decoding process of the V-PCC for reconstructing a point cloud by decoding the compressed occupancy map, geometry image, texture image, and auxiliary path information. Each process according to the embodiments is operated as follows.

Video decompression (1600, 16002)

Video decompression is a reverse process of the video compression described above. In video decompression, a 2D video codec such as HEVC or VVC is used to decode a compressed bitstream containing the geometry image, texture image, and occupancy map image generated in the above-described process.

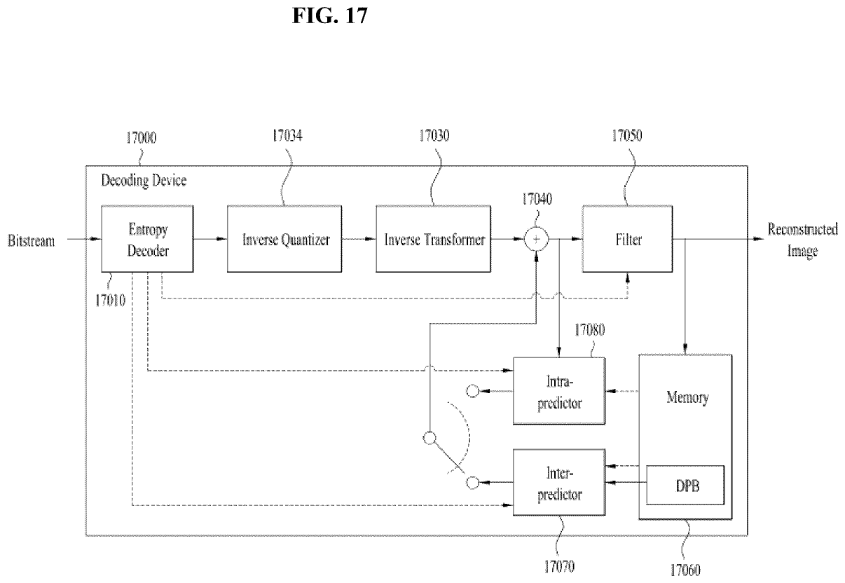

FIG. 17 illustrates an exemplary 2D video/image decoder according to embodiments.

The 2D video/image decoder may follow the reverse process of the 2D video/image encoder of FIG. 15.

The 2D video/image decoder of FIG. 17 is an embodiment of the video decompression or video decompressor of FIG. 16. FIG. 17 is a schematic block diagram of a 2D video/image decoder 17000 by which decoding of a video/image signal is performed. The 2D video/image decoder 17000 may be included in the point cloud video decoder of FIG. 1, or may be configured as an internal/external component. Each component in FIG. 17 may correspond to software, hardware, a processor, and/or a combination thereof.

Here, the input bitstream may include bitstreams for the geometry image, texture image (attribute(s) image), and occupancy map image described above. The reconstructed image (or the output image or the decoded image) may represent a reconstructed image for the geometry image, texture image (attribute(s) image), and occupancy map image described above.

Referring to the figure, an inter-predictor 17070 and an intra-predictor 17080 may be collectively referred to as a predictor. That is, the predictor may include the inter-predictor 17070 and the intra-predictor 17080. An inverse quantizer 17020 and an inverse transformer 17030 may be collectively referred to as a residual processor. That is, the residual processor may include the inverse quantizer 17020 and the inverse transformer 17030. The entropy decoder 17010, the inverse quantizer 17020, the inverse transformer 17030, the adder 17040, the filter 17050, the inter-predictor 17070, and the intra-predictor 17080 described above may be configured by one hardware component (e.g., a decoder or a processor) according to an embodiment. In addition, the memory 170 may include a decoded picture buffer (DPB) or may be configured by a digital storage medium.

When a bitstream containing video/image information is input, the decoder 17000 may reconstruct an image in a process corresponding to the process in which the video/image information is processed by the encoder of FIG. 1. For example, the decoder 17000 may perform decoding using a processing unit applied in the encoder. Thus, the processing unit of decoding may be, for example, a CU. The CU may be split from a CTU or an LCU along a quad-tree structure and/or a binary-tree structure. Then, the reconstructed video signal decoded and output through the decoder 17000 may be played through a player.

The decoder 17000 may receive a signal output from the encoder in the form of a bitstream, and the received signal may be decoded through the entropy decoder 17010. For example, the entropy decoder 17010 may parse the bitstream to derive information (e.g., video/image information) necessary for image reconstruction (or picture reconstruction). For example, the entropy decoder 17010 may decode the information in the bitstream based on a coding technique such as exponential Golomb coding, CAVLC, or CABAC, output values of syntax elements required for image reconstruction, and quantized values of transform coefficients for the residual. More specifically, in the CABAC entropy decoding, a bin corresponding to each syntax element in the bitstream may be received, and a context model may be determined based on decoding target syntax element information and decoding information about neighboring and decoding target blocks or information about a symbol/bin decoded in a previous step. Then, the probability of occurrence of a bin may be predicted according to the determined context model, and arithmetic decoding of the bin may be performed to generate a symbol corresponding to the value of each syntax element. According to the CABAC entropy decoding, after a context model is determined, the context model may be updated based on the information about the symbol/bin decoded for the context model of the next symbol/bin. Information about the prediction in the information decoded by the entropy decoder 17010 may be provided to the predictors (the inter-predictor 17070 and the intra-predictor 17080), and the residual values on which entropy decoding has been performed by the entropy decoder 17010, that is, the quantized transform coefficients and related parameter information, may be input to the inverse quantizer 17020. In addition, information about filtering of the information decoded by the entropy decoder 17010 may be provided to the filter 17050. A receiver (not shown) configured to receive a signal output from the encoder may be further configured as an internal/external element of the decoder 17000. Alternatively, the receiver may be a component of the entropy decoder 17010.

The inverse quantizer 17020 may output transform coefficients by inversely quantizing the quantized transform coefficients. The inverse quantizer 17020 may rearrange the quantized transform coefficients in the form of a two-dimensional block. In this case, the rearrangement may be performed based on the coefficient scan order implemented by the encoder. The inverse quantizer 17020 may perform inverse quantization on the quantized transform coefficients using a quantization parameter (e.g., quantization step size information), and acquire transform coefficients.

The inverse transformer 17030 acquires a residual signal (residual block and residual sample array) by inversely transforming the transform coefficients.

The predictor may perform prediction on the current block and generate a predicted block including prediction samples for the current block. The predictor may determine whether intra-prediction or inter-prediction is to be applied to the current block based on the information about the prediction output from the entropy decoder 17010, and may determine a specific intra-/inter-prediction mode.

The intra-predictor 265 may predict the current block with reference to the samples in the current picture. The samples may be positioned in the neighbor of or away from the current block depending on the prediction mode. In intra-prediction, the prediction modes may include a plurality of non-directional modes and a plurality of directional modes. The intra-predictor 17080 may determine a prediction mode to be applied to the current block, using the prediction mode applied to the neighboring block.

The inter-predictor 17070 may derive a predicted block for the current block based on a reference block (reference sample array) specified by a motion vector on the reference picture. In this case, in order to reduce the amount of motion information transmitted in the inter-prediction mode, the motion information may be predicted on a per block, subblock, or sample basis based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. For example, the inter-predictor 17070 may configure a motion information candidate list based on neighboring blocks and derive a motion vector of the current block and/or a reference picture index based on the received candidate selection information. Inter-prediction may be performed based on various prediction modes. The information about the prediction may include information indicating an inter-prediction mode for the current block.

The adder 17040 may add the acquired residual signal to the prediction signal (predicted block or prediction sample array) output from the inter-predictor 17070 or the intra-predictor 17080, thereby generating a reconstructed signal (a reconstructed picture, a reconstructed block, or a reconstructed sample array). When there is no residual signal for a processing target block as in the case where the skip mode is applied, the predicted block may be used as the reconstructed block.

The adder 17040 may be called a reconstructor or a reconstructed block generator. The generated reconstructed signal may be used for intra-prediction of the next processing target block in the current picture, or may be used for inter-prediction of the next picture through filtering as described below.

The filter 17050 may improve subjective/objective image quality by applying filtering to the reconstructed signal. For example, the filter 17050 may generate a modified reconstructed picture by applying various filtering techniques to the reconstructed picture, and may transmit the modified reconstructed picture to the memory 250, specifically, the DPB of the memory 17060. The various filtering techniques may include, for example, deblocking filtering, sample adaptive offset, adaptive loop filtering, and bilateral filtering.

The reconstructed picture stored in the DPB of the memory 17060 may be used as a reference picture in the inter-predictor 17070. The memory 17060 may store the motion information about a block from which the motion information is derived (or decoded) in the current picture and/or the motion information about the blocks in a picture that has already been reconstructed. The stored motion information may be delivered to the inter-predictor 17070 so as to be used as the motion information about a spatial neighboring block or the motion information about a temporal neighboring block. The memory 17060 may store the reconstructed samples of the reconstructed blocks in the current picture, and deliver the reconstructed samples to the intra-predictor 17080.

In the present disclosure, the embodiments described regarding the filter 160, the inter-predictor 180, and the intra-predictor 185 of the encoding device 100 may be applied to the filter 17050, the inter-predictor 17070 and the intra-predictor 17080 of the decoder 17000, respectively, in the same or corresponding manner.

At least one of the prediction, transform, and quantization procedures described above may be skipped. For example, for a block to which the pulse coding mode (PCM) is applied, the prediction, transform, and quantization procedures may be skipped, and the value of a decoded sample may be used as a sample of the reconstructed image.

Occupancy map decompression (16003)

This is a reverse process of the occupancy map compression described above. Occupancy map decompression is a process for reconstructing the occupancy map by decompressing the occupancy map bitstream.

Auxiliary patch info decompression (16004)

The auxiliary patch information may be reconstructed by performing the reverse process of the aforementioned auxiliary patch info compression and decoding the compressed auxiliary patch info bitstream.

Geometry reconstruction (16005)

This is a reverse process of the geometry image generation described above. Initially, a patch is extracted from the geometry image using the reconstructed occupancy map, the 2D position/size information about the patch included in the auxiliary patch info, and the information about mapping between a block and the patch. Then, a point cloud is reconstructed in a 3D space based on the geometry image of the extracted patch and the 3D position information about the patch included in the auxiliary patch info. When the geometry value corresponding to a point (u, v) within the patch is g (u, v), and the coordinates of the position of the patch on the normal, tangent and bitangent axes of the 3D space are (80, s0, r0), 8 (u, v), s (u, v), and r (u, v), which are the normal, tangent, and bitangent coordinates in the 3D space of a position mapped to point (u, v) may be expressed as follows:

$$δ ( u , v ) = δ0 + g ( u , v ) ;$$

$$s ( u , v ) = s 0 + u ;$$

$$r ( u , v ) = r 0 + v .$$

Smoothing (16006)

Smoothing, which is the same as the smoothing in the encoding process described above, is a process for eliminating discontinuity that may occur on the patch boundary due to deterioration of the image quality occurring during the compression process.

Texture reconstruction (16007)

Texture reconstruction is a process of reconstructing a color point cloud by assigning color values to each point constituting a smoothed point cloud. It may be performed by assigning color values corresponding to a texture image pixel at the same position as in the geometry image in the 2D space to points of a point of a point cloud corresponding to the same position in the 3D space, based on the mapping information about the geometry image and the point cloud in the geometry reconstruction process described above.

Color smoothing (16008)

Color smoothing is similar to the process of geometry smoothing described above. Color smoothing is a process for eliminating discontinuity that may occur on the patch boundary due to deterioration of the image quality occurring during the compression process. Color smoothing may be performed through the following operations:

1) Calculate neighboring points of each point constituting the reconstructed point cloud using the K-D tree or the like. The neighboring point information calculated in the geometry smoothing process described in section 2.5 may be used.

2) Determine whether each of the points is positioned on the patch boundary. These operations may be performed based on the boundary information calculated in the geometry smoothing process described above.

3) Check the distribution of color values for the neighboring points of the points present on the boundary and determine whether smoothing is to be performed. For example, when the entropy of luminance values is less than or equal to a threshold local entry (there are many similar luminance values), it may be determined that the corresponding portion is not an edge portion, and smoothing may be performed. As a method of smoothing, the color value of the point may be replaced with the average of the color values of the neighboring points.

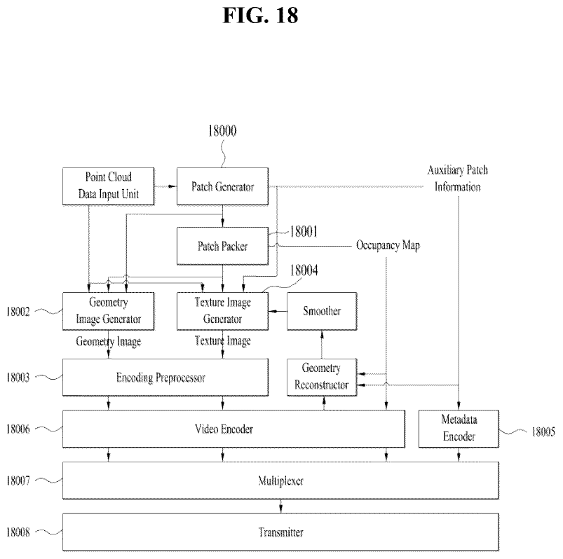

FIG. 18 is a flowchart illustrating operation of a transmission device according to embodiments of the present disclosure.

The transmission device according to the embodiments may correspond to the transmission device of FIG. 1, the encoding process of FIG. 4, and the 2D video/image encoder of FIG. 15, or perform some/all of the operations thereof. Each component of the transmission device may correspond to software, hardware, a processor and/or a combination thereof.

An operation process of the transmission terminal for compression and transmission of point cloud data using V-PCC may be performed as illustrated in the figure.

The point cloud data transmission device according to the embodiments may be referred to as a transmission device.

Regarding a patch generator 18000, a patch for 2D image mapping of a point cloud is generated. Auxiliary patch information is generated as a result of the patch generation. The generated information may be used in the processes of geometry image generation, texture image generation, and geometry reconstruction for smoothing.

Regarding a patch packer 18001, a patch packing process of mapping the generated patches into the 2D image is performed. As a result of patch packing, an occupancy map may be generated. The occupancy map may be used in the processes of geometry image generation, texture image generation, and geometry reconstruction for smoothing.

A geometry image generator 18002 generates a geometry image based on the auxiliary patch information and the occupancy map. The generated geometry image is encoded into one bitstream through video encoding.

An encoding preprocessor 18003 may include an image padding procedure. The geometry image regenerated by decoding the generated geometry image or the encoded geometry bitstream may be used for 3D geometry reconstruction and then be subjected to a smoothing process.

A texture image generator 18004 may generate a texture image based on the (smoothed) 3D geometry, the point cloud, the auxiliary patch information, and the occupancy map. The generated texture image may be encoded into one video bitstream.

A metadata encoder 18005 may encode the auxiliary patch information into one metadata bitstream.

A video encoder 18006 may encode the occupancy map into one video bitstream.

A multiplexer 18007 may multiplex the video bitstreams of the generated geometry image, texture image, and occupancy map and the metadata bitstream of the auxiliary patch information into one bitstream.

A transmitter 18008 may transmit the bitstream to the reception terminal. Alternatively, the video bitstreams of the generated geometry image, texture image, and the occupancy map and the metadata bitstream of the auxiliary patch information may be processed into a file of one or more track data or encapsulated into segments and may be transmitted to the reception terminal through the transmitter.

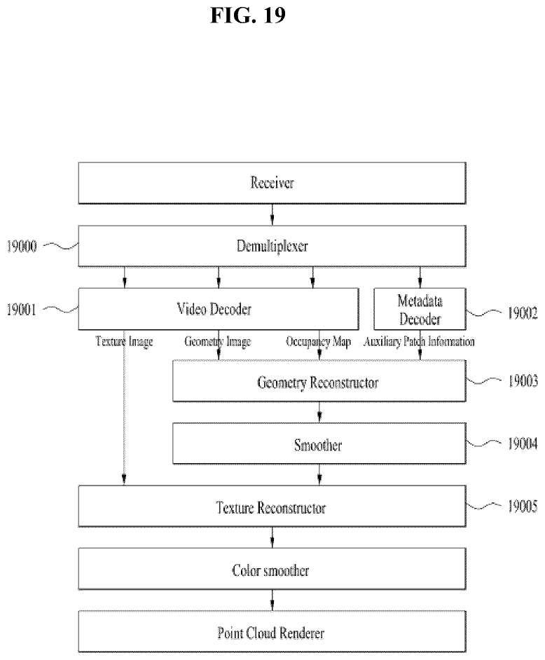

FIG. 19 is a flowchart illustrating operation of a reception device according to embodiments.

The reception device according to the embodiments may correspond to the reception device of FIG. 1, the decoding process of FIG. 16, and the 2D video/image encoder of FIG. 17, or perform some/all of the operations thereof. Each component of the reception device may correspond to software, hardware, a processor and/or a combination thereof.

The operation of the reception terminal for receiving and reconstructing point cloud data using V-PCC may be performed as illustrated in the figure. The operation of the V-PCC reception terminal may follow the reverse process of the operation of the V-PCC transmission terminal of FIG. 18.

The point cloud data reception device according to the embodiments may be referred to as a reception device.

The bitstream of the received point cloud is demultiplexed into the video bitstreams of the compressed geometry image, texture image, occupancy map and the metadata bitstream of the auxiliary patch information by a demultiplexer 19000 after file/segment decapsulation. A video decoder 19001 and a metadata decoder 19002 decode the demultiplexed video bitstreams and metadata bitstream. 3D geometry is reconstructed by a geometry reconstructor 19003 based on the decoded geometry image, occupancy map, and auxiliary patch information, and is then subjected to a smoothing process performed by a smoother 19004. A color point cloud image/picture may be reconstructed by a texture reconstructor 19005 by assigning color values to the smoothed 3D geometry based on the texture image. Thereafter, a color smoothing process may be additionally performed to improve the objective/subjective visual quality, and a modified point cloud image/picture derived through the color smoothing process is shown to the user through the rendering process (through, for example, the point cloud renderer). In some cases, the color smoothing process may be skipped.

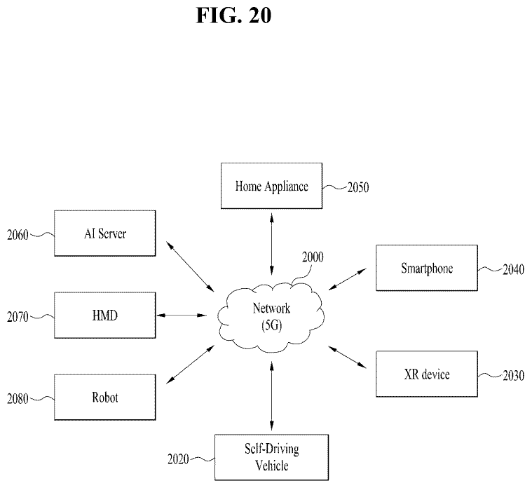

FIG. 20 illustrates an exemplary structure operable in connection with point cloud data transmission/reception methods/devices according to embodiments.

In the structure according to the embodiments, at least one of a server 2060, a robot 2010, a self-driving vehicle 2020, an XR device 2030, a smartphone 2040, a home appliance 2050 and/or a head-mount display (HMD) 2070 is connected to a cloud network 2010. Here, the robot 2010, the self-driving vehicle 2020, the XR device 2030, the smartphone 2040, or the home appliance 2050 may be referred to as a device. In addition, the XR device 2030 may correspond to a point cloud data (PCC) device according to embodiments or may be operatively connected to the PCC device.

The cloud network 2000 may represent a network that constitutes part of the cloud computing infrastructure or is present in the cloud computing infrastructure. Here, the cloud network 2000 may be configured using a 3G network, 4G or Long Term Evolution (LTE) network, or a 5G network.

The server 2060 may be connected to at least one of the robot 2010, the self-driving vehicle 2020, the XR device 2030, the smartphone 2040, the home appliance 2050, and/or the HMD 2070 over the cloud network 2000 and may assist at least a part of the processing of the connected devices 2010 to 2070.

The HMD 2070 represents one of the implementation types of the XR device and/or the PCC device according to the embodiments. An HMD type device according to embodiments includes a communication unit, a control unit, a memory, an I/O unit, a sensor unit, and a power supply unit.

Hereinafter, various embodiments of the devices 2010 to 2050 to which the above-described technology is applied will be described. The devices 2010 to 2050 illustrated in FIG. 20 may be operatively connected/coupled to a point cloud data transmission and reception device according to the above-described embodiments.

<PCC+XR>The XR/PCC device 2030 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 2030 may analyze 3D point cloud data or image data acquired through various sensors or from an external device and generate position data and attribute data about 3D points. Thereby, the XR/PCC device 2030 may acquire information about the surrounding space or a real object, and render and output an XR object. For example, the XR/PCC device 2030 may match an XR object including auxiliary information about a recognized object with the recognized object and output the matched XR object.

<PCC+Self-driving+XR>The self-driving vehicle 2020 may be implemented as a mobile robot, a vehicle, an unmanned aerial vehicle, or the like by applying the PCC technology and the XR technology.

The self-driving vehicle 2020 to which the XR/PCC technology is applied may represent an autonomous vehicle provided with means for providing an XR image, or an autonomous vehicle that is a target of control/interaction in the XR image. In particular, the self-driving vehicle 2020, which is a target of control/interaction in the XR image, may be distinguished from the XR device 2030 and may be operatively connected thereto.

The self-driving vehicle 2020 having means for providing an XR/PCC image may acquire sensor information from the sensors including a camera, and output the generated XR/PCC image based on the acquired sensor information. For example, the self-driving vehicle may have an HUD and output an XR/PCC image thereto to provide an occupant with an XR/PCC object corresponding to a real object or an object present on the screen.

In this case, when the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap the object on the screen. For example, the self-driving vehicle may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only real-world objects, backgrounds, and the like as CG images. On the other hand, the AR technology refers to a technology for showing a CG image virtually created on a real object image. The MR technology is similar to the AR technology described above in that virtual objects to be shown are mixed and combined with the real world. However, the MR technology differs from the AR technology makes a clear distinction between a real object and a virtual object created as a CG image and uses virtual objects as complementary objects for real objects, whereas the MR technology treats virtual objects as objects having the same characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to all VR, AR, MR, and XR technologies. For such technologies, encoding/decoding based on PCC, V-PCC, and G-PCC techniques may be applied.

The PCC method/device according to the embodiments may be applied to a vehicle that provides a self-driving service.

A vehicle that provides the self-driving service is connected to a PCC device for wired/wireless communication.

When the point cloud data transmission and reception device (PCC device) according to the embodiments is connected to a vehicle for wired/wireless communication, the device may receive and process content data related to an AR/VR/PCC service that may be provided together with the self-driving service and transmit the processed content data to the vehicle. In the case where the point cloud data transmission and reception device is mounted on a vehicle, the point cloud transmitting and reception device may receive and process content data related to the AR/VR/PCC service according to a user input signal input through a user interface device and provide the processed content data to the user. The vehicle or the user interface device according to the embodiments may receive a user input signal. The user input signal according to the embodiments may include a signal indicating the self-driving service.

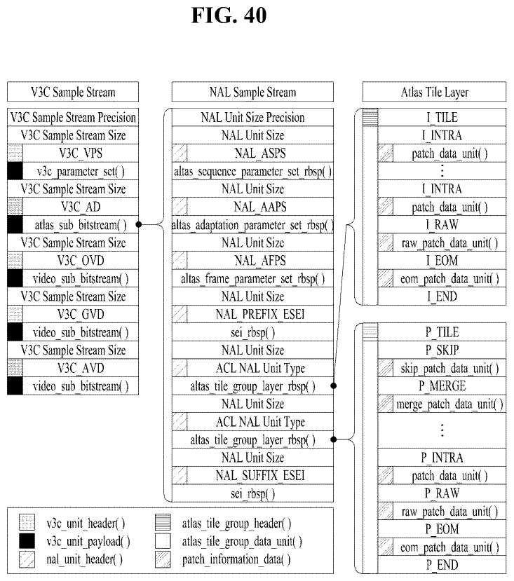

The point cloud data transmission method/device according to the embodiments may refer to the transmission device 10000 in FIG. 1, the point cloud video encoder 10002 in FIG. 1, the encoding process in FIG. 4, the video/image encoder in FIG. 15, the transmission device in FIG. 18, the XR device 1730 in FIG. 20, the transmission device in FIG. 40, and the like. Each component of the transmission method/device may correspond to hardware, software, a processor connected to a memory, and/or a combination thereof.

The point cloud data reception method/device according to the embodiments may refer to the reception device 10005, the point cloud video decoder 10008 of FIG. 2, the decoding process of FIG. 16, the video/image decoder of FIG. 17, the reception device of FIG. 19, the XR device 1730 of FIG. 20, and the like. Each component of the reception method/device may correspond to hardware, software, a processor connected to a memory, and/or a combination thereof.

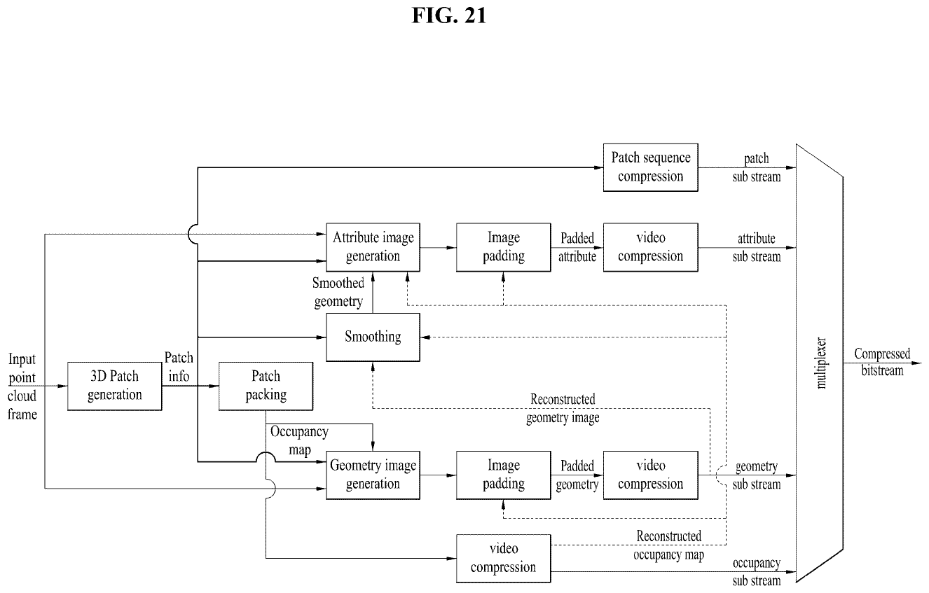

The point cloud data transmission/reception method/device according to the embodiments may be referred to as a method/device according to embodiments. FIG. 21 illustrates a VPCC encoder according to embodiments.

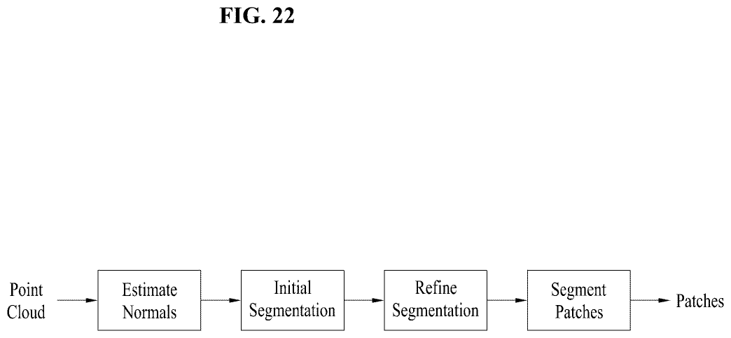

FIG. 21 illustrates the encoder and encoding process illustrated in FIG. 4. FIG. 22 illustrates 3D patch generation according to embodiments.

FIG. 22 illustrates a detailed process of the patch generator (or 3D patch generator) illustrated in FIGS. 4 and 21. According to embodiments, the patches may be referred to as 3D patches.

A 3D patch is a unit for mapping point cloud data to a 2D image. The 3D patch generator may receive point cloud data, estimate normal values, perform segmentation, refine the segmentation, and perform segmentation into patches to generate patches.

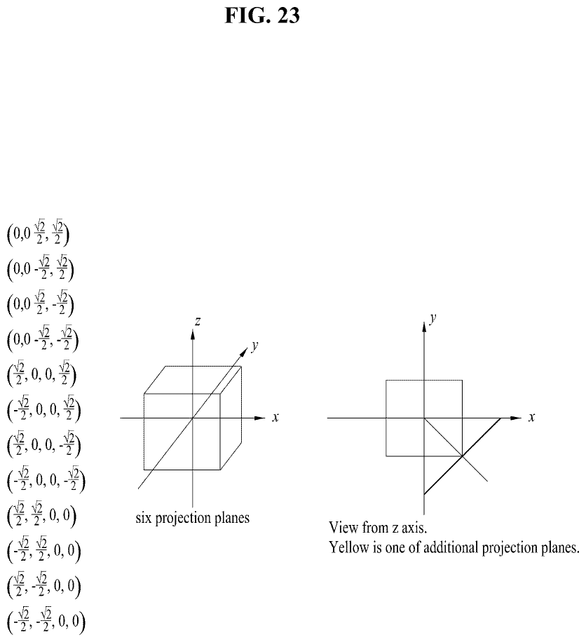

FIG. 23 illustrates additional projection planes for improving visual quality according to embodiments.

As described with reference to FIG. 6, the method/device according to embodiments may calculate a normal corresponding to each plane of the bounding box. To enable encoding/decoding with better quality, the normal values corresponding to each of the 12 corners in addition to the planes may be further selected. The normals nipuy are then defined as shown in FIG. 23. For the calculation of the normals for the planes, refer to the description of FIG. 6.

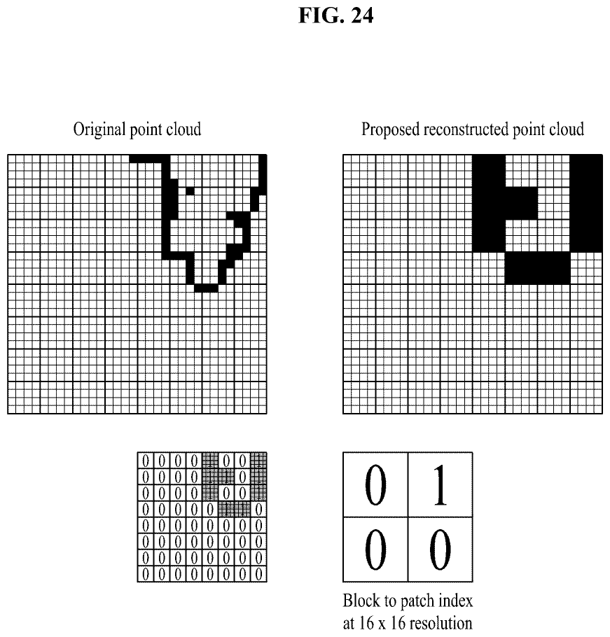

FIG. 24 illustrates an example of a difference in occupancy map based on the size of an occupancy packing block according to embodiments.

In Patch packing & Occupancy map generation above, the occupancy map may vary according to the size of the occupancy packing block.

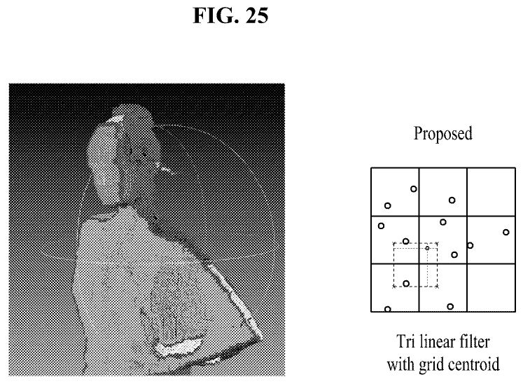

FIG. 25 illustrates the boundaries of a patch of smoothed point cloud data and a trilinear filter according to embodiments.

The aforementioned smoothing is a process for removing discontinuities that may occur at patch boundaries during compression. The purpose of filtering the patch boundaries is to improve the visual quality of the reconstructed point cloud.

The smoothing of the point cloud is applied to the edges of each patch as shown in FIG. 25, and the centroid of the decoded points is precomputed for each grid. After deriving the centroid and the number of points in the 2×2×2 grid, a trilinear filter is applied. When the output of the filter is greater than a predetermined threshold, the point coordinates are moved to the output value. When the output is less than the threshold, the original position is maintained.

A texture according to embodiments may refer to an attribute. The process of texture image generation according to embodiments may be referred to as attribute image generation. The texture may be referred to as an attribute image.

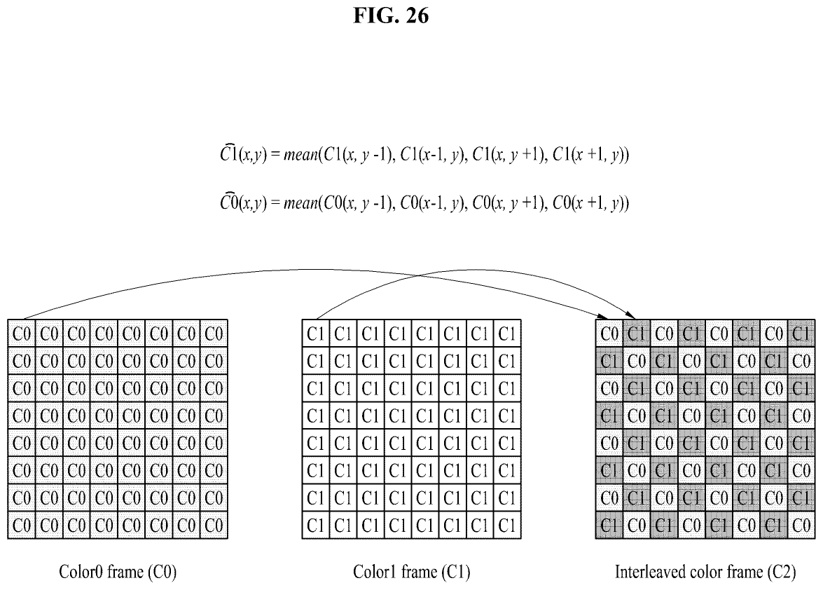

FIG. 26 illustrates attribute interleaving according to embodiments.

FIG. 26 illustrates the process of generating and interleaving an attribute image (attribute data) by an attribute encoder/decoder of a point cloud data transmission/reception method/device.

The attribute image may also be generated in two layers of c0/c1, similar to a geometry image that is generated in two layers of d0/d1. Based on these attributes, the interleaved attribute image generation is performed, where the missing attribute value may be estimated by averaging the neighboring values in the same attribute layer using the equations in FIG. 26.

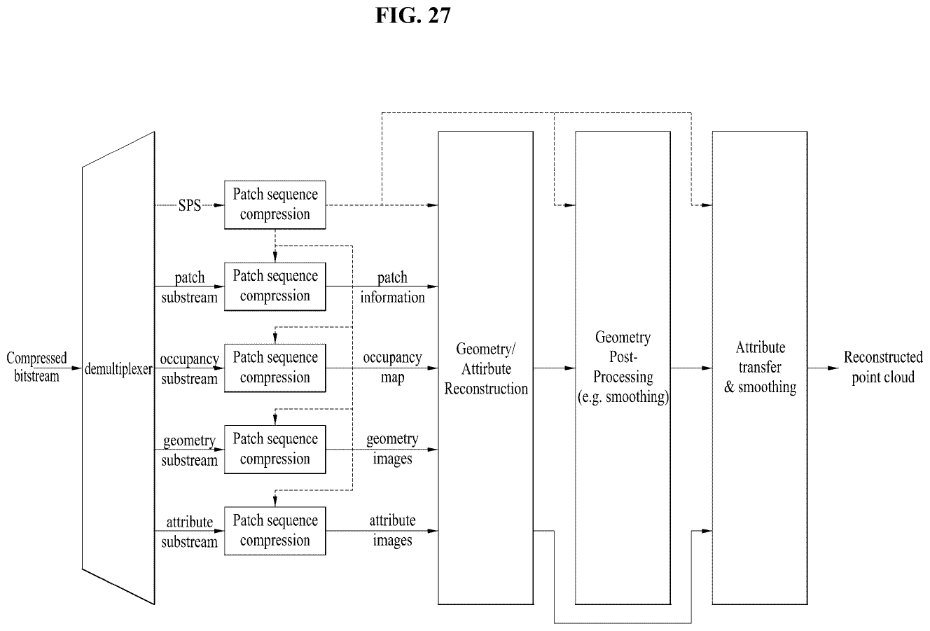

FIG. 27 illustrates a VPCC decoder according to embodiments.

FIG. 27 illustrates the decoder shown in FIG. 16.

Methods/devices according to embodiments may include a method and device for encoding/decoding 3D mesh data.

Embodiments relate to video-based point cloud compression (V-PCC), a method for compressing 3D point cloud data using a 2D video codec. Related techniques are proposed to enable point cloud data compressed by V-PCC to be reconstructed and displayed at the receiving side. Generally, when point cloud data is displayed, it is transformed into 3D mesh data for display. The existing V-PCC standard method does not include a mesh information processor, and accordingly it requires a separate process or system to be added according to the application used to transmit the mesh information. Embodiments may include a structure for projecting the vertex geometry and vertex/face attributes of 3D mesh data onto an image plane and efficiently encoding/decoding the geometry/attribute image of the corresponding image with a 2D video encoder/decoder.

Embodiments relate to encoding/decoding methods for processing mesh data in V-PCC encoding/decoding. Based on V-PCC, a method may be provided for efficiently compressing vertex coordinates and colors, as well as connectivity and face colors, normals, and the like.

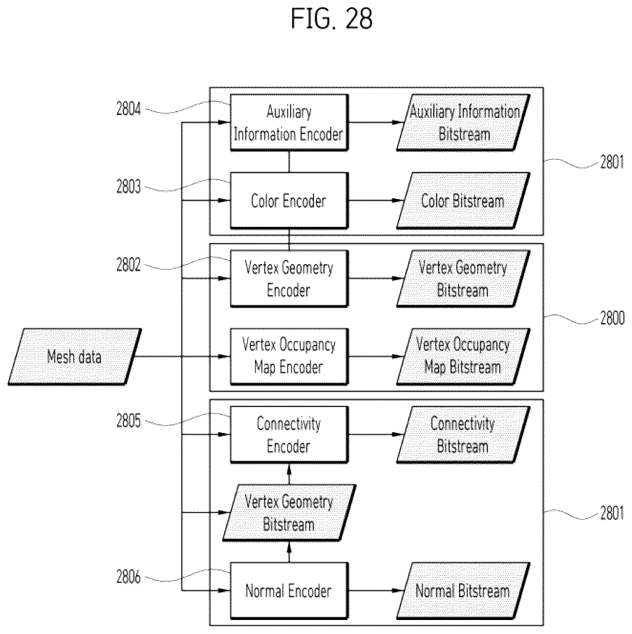

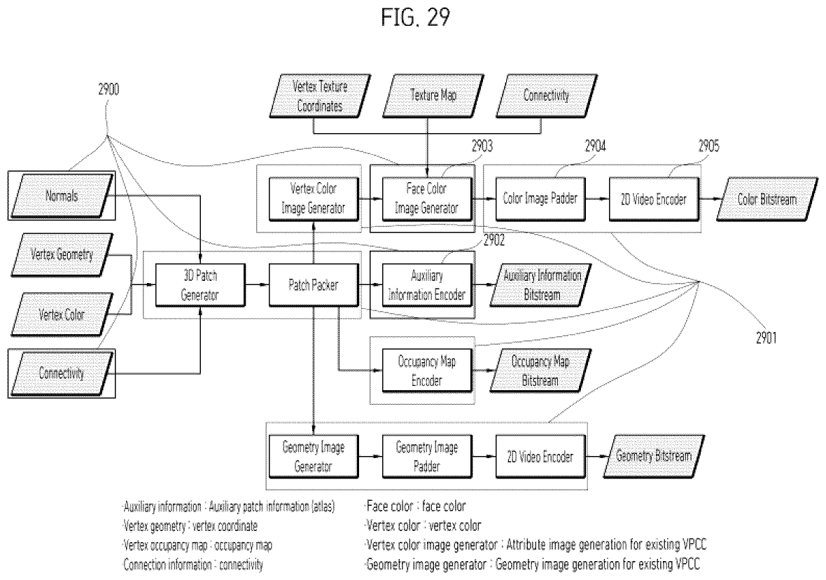

The V-PCC encoding/decoding standard efficiently encodes/decodes only point cloud data. It may not process key information in 3D mesh data, and may require separate devices or post-processing to process the data into mesh data or separately decode/encode information that is not supported. In addition, the existing codec (VPCC) that compresses vertex coordinates and vertex colors based on 2D video codecs by projecting 3D data does not support compression of connectivity and face color, which are the main features of mesh data. However, when used by users, such point cloud data is rarely used and displayed without processing, and is often transformed into a mesh or other form depending on the characteristics of the application being displayed. Accordingly, the currently developed V-PCC standard may not be able to process data containing mesh information, and an additional encoder and decoder may need to be separately applied to the V-PCC standard as shown in FIGS. 28 and 29. In FIG. 28, 2801 represents the V-PCC encoder part, and a separate vertex connectivity encoder may be coupled to transmit mesh information. Similarly, in FIG. 29, which illustrates the decoder part, it can be seen that a separate vertex connectivity decoder is added.

Also, for the recent V-PCC-based mesh data compression, the mesh data is categorized into the following mesh data types.

Category 1: Mesh data with a texture map

Category2: Mesh data with vertex colors

There is a need for a framework capable of supporting both types of mesh data.

Embodiments include a method of efficiently compressing vertex coordinates and colors, as well as connectivity, face colors, and normals based on VPCC.

One system structure based on VPCC includes an encoder/decoder of category 1 and category2 mesh data.

It includes a process of connectivity, face colors, and normals for compressing a VPCC structure and mesh data.

Embodiments include order mapping of vertices reconstructed by VPCC and vertices reconstructed by the connectivity decoder.

Embodiments include a color image mode and a texture map mode for decoding face colors of mesh data.

The optimal mode between the color image mode or the texture map mode may be selectedon on a per sequence, per frame, per tile, or per patch basis to perform encoding and decoding.

The decoder may parse the mode to restore face colors in the color image mode or the texture map mode.

FIG. 28 illustrates a 3D mesh data encoder according to embodiments.

FIG. 28 may correspond to a point cloud data transmission device, an encoder, or the like according to embodiments. Each component of the encoder of FIG. 28 may correspond to hardware, software, a processor, and/or a combination thereof.

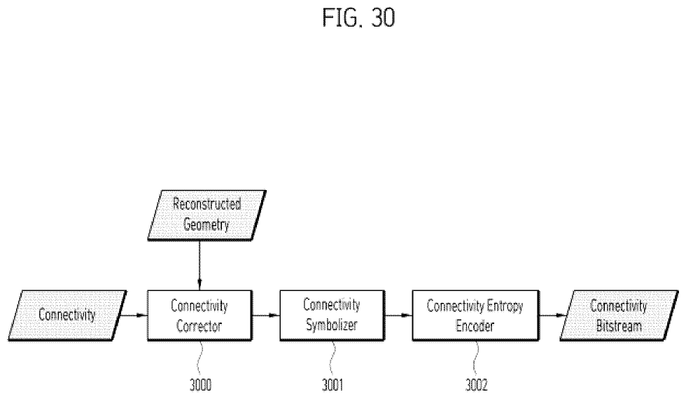

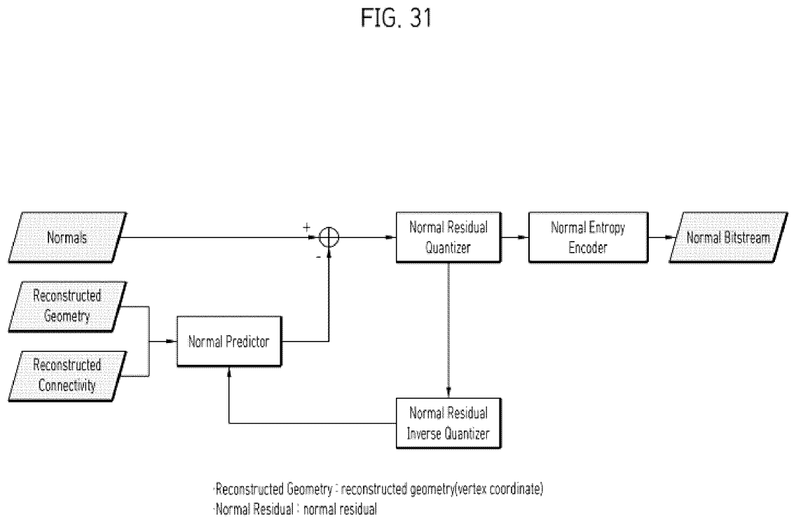

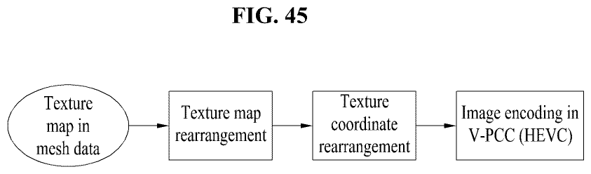

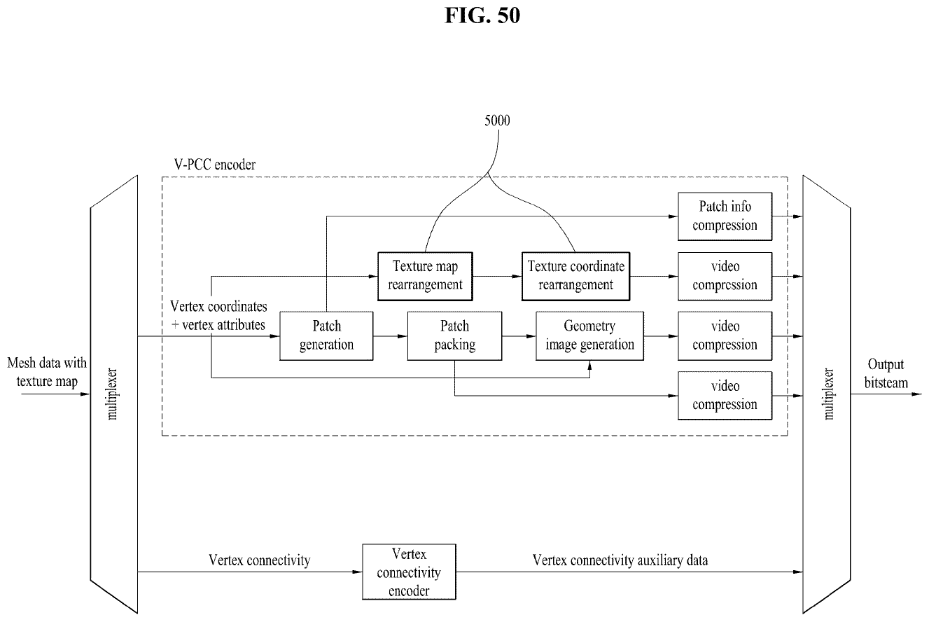

The VPCC encoder 2800 and the mesh data encoder 2801 may be combined to configure an encoder for processing mesh data, as shown in FIG. 28. The encoder for processing of mesh data in FIG. 28 may correspond to the transmission device 10000 of FIG. 1, the point cloud video encoder 10002 of FIG. 1, the file/segment encapsulator 10003 of FIG. 1, the encoder of FIG. 3, the encoder of FIG. 15, the transmission device of FIG. 18, the XR device 2030 of FIG. 20, the encoder of FIG. 21, the encoder of FIG. 22, the encoder of FIG. 28, the encoder of FIG. 29, the encoder of FIG. 30, the encoder of FIG. 31, the bitstream generation of FIGS. 40, 41, and 56 to 58, the encoder of FIG. 45, the encoder of FIG. 50, the encoder of FIG. 52, and the like.

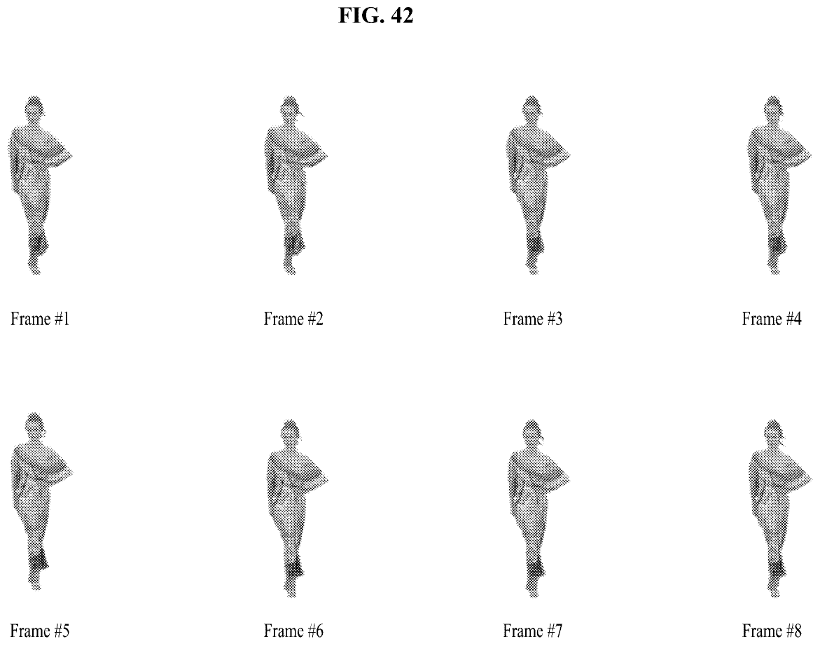

The mesh data as shown in FIGS. 42-44 may be encoded as shown in FIG. 28. By encoding the mesh data contained in the frames, a bitstream containing auxiliary information, color information, geometry information, vertex occupancy maps, connectivity, line information, and the like may be generated.

The mesh data may include vertex geometry, vertex attributes, face attributes, connectivity, texture maps, and vertex texture coordinates. Attributes may include colors and normals. Each term may be referred to by various terms such as data and information in the same sense.

The vertex geometry encoder 2802 receives as input the vertex geometry (x, y, z) of the original mesh data and performs geometry encoding.

As for geometry, the coordinates of the 3D mesh data may be projected into a 2D image, and the image, where the pixel value is the distance from the projection plane, may be encoded using a 2D video encoder.

The color encoder 2803 receives vertex colors (R, G, B, etc.), a texture map, and vertex texture map coordinates of the source mesh data to generate a bitstream for vertices, face colors, and the like.

For the colors, the colors that the 3D mesh data has may be projected into a 2D image, and the image having color values may be encoded by a 2D video encoder.

In some embodiments, restored connectivity may be used to encode the face colors.

The auxiliary information encoder 2804 encodes auxiliary information, such as projection information related to the geometry and the colors.

The connectivity encoder 2805 receives as input the connectivity between the vertices of the mesh data and generates a connectivity bitstream.

At this time, the connectivity may be corrected based on the reconstructed geometry received as input.

The normal encoder 2806 receives as input vertex normals and face normals and generates a bitstream for the vertex normals and face normals.

According to embodiments, Prediction may be performed based on the reconstructed normals, which are obtained by reconstructing previously encoded normals, and the reconstructed geometry to transmit a residual signal.

In some embodiments, the encoding may be performed on a per group of frame (GOF) basis.

FIG. 29 illustrates a 3D mesh data encoder according to embodiments.

The encoder of FIG. 28 may be illustrated more specifically as shown in FIG. 29.

The VPCC encoder 2901 and the mesh data encoder 2900 may be combined to configure an encoder for processing mesh data, as shown in FIG. 29.

The auxiliary information encoder 2902 may encode a determined projection plane index per patch, a 2D bounding box position (u0,v0,u1,v1) of the patch, a 3D reconstructed position (x0,y0,z0) relative to the bounding box of the patch, and a patch index map of an M×N unit in an image space of W×H.

The face color image generator 2903 may perform encoding by selecting a color image mode (proposed mode 1), in which the face colors in the 3D space are projected or warped onto a projection plane to transmit a color image, and a texture map mode (proposed mode 2), in which the texture map and texture coordinates are transmitted per patch.

In the color image mode, the face colors may be projected or warped onto a color image according to the texture map, vertex texture coordinates, and connectivity based on vertices that are packed after being projected or warped, and the image may be encoded using a 2D video encoder.

In some embodiments, for face colors between patches that are lost due to patch packing, the encoder may further pack the corresponding face color values into a color image (attribute image of the VPCC) for transmission.

For the vertices constituting the face colors between the patches, the texture coordinates for mapping the face color values in the color image may be additionally transmitted.

In the texture map mode, a texture map belonging to the vertices of a corresponding patch may be packed into the color image, or a separate texture map image may be constructed to perform encoding and transmit the corresponding texture coordinates (u,v) per vertex.

The color image (attribute image of the VPCC) may include a vertex color and a face color, and the color image padder 2904 may perform padding on regions where no color is present based on neighboring color values ( ).

The padded color image may be encoded by the 2D video encoder 2905.

Referring to FIG. 29, the mesh data may include geometry (geometry data) about vertices constituting the mesh, color information (attribute data) about the vertices, and further include connectivity and a normal of the mesh.

The connectivity may be information indicating connectivity between vertices, and the normal may be a normal vector of the plane composed of the vertices.

The mesh encoder according to the embodiments may further include a function or processor for encoding a color image of a face composed of vertices, and encoding auxiliary information (patch configuration information including mesh data). FIG. 30 illustrates a connectivity encoder according to embodiments.

FIG. 30 specifically illustrates the connectivity encoder of the encoder of FIGS. 28 and 29.

When lossy geometry encoding is performed, the connectivity corrector 3000 corrects the original connectivity based on the reconstructed geometry.

The connectivity symbolizer 3001 (corresponding to the symbolization process of the TFAN, edge breaker, etc.) maps some or all of the vertices or edges to one symbol based on the connection relationship.

In some embodiments, a table of probability values for a specific connection relationship may be signaled as auxiliary information. The specific connection relationship may be, for example, the number of edges or degree of edges connected to the vertex currently being encoded, or the number of triangles or connected to the current vertex.

The connectivity entropy encoder 3002 may entropy-encode the mapped symbols using Exponential Golomb, Variable Length Coding (VLC), Context-Adaptive Variable Length Coding (CAVLC) or Context-Adaptive Binary Arithmetic Coding (CABAC) or the like according to embodiments.

Referring to FIG. 30, since encoding the geometry deforms the original geometry, the connectivity may be corrected based on the reconstructed geometry, which is obtained by reconstructing the geometry for encoding/decoding. Based on the corrected connectivity, the encoder may generate a symbol and entropy code the connectivity based on the symbol.

FIG. 31 illustrates a normal encoder according to embodiments.

FIG. 31 specifically illustrates the normal encoder of the encoder of FIGS. 28 and 29.

Regarding the normal information, the current vertex and face normal may be predicted based on the reconstructed geometry (vertex coordinates) and the reconstructed neighbor vertices and face normals (reconstructed vertex normal or/and reconstructed face normal).

The encoding order of the normals may be determined by the same order as the restored connectivity encoding order, or by a scanning order predetermined based on the reconstructed geometry.

When normal prediction is performed, a normal difference, which is a residual from the original normal, is quantized by the normal residual quantizer.

The quantized normal residual is entropy encoded by a normal entropy encoder to generate a bitstream.

According to embodiments, the quantized normal residual or quantized normal may be entropy encoded by the entropy encoder using Exponential Golomb, Variable Length Coding (VLC), Context-Adaptive Variable Length Coding (CAVLC) or Context-Adaptive Binary Arithmetic Coding (CABAC) or the like.

In some embodiments, encoding the normals may include performing projection-based encoding in the same manner as the geometry and color encoders by mapping the normal to a single three-channel color value.

For example, a normal image may be generated by patch-packing the normals, and a normal image may be padded. The normal image may be encoded using a 2D encoder.

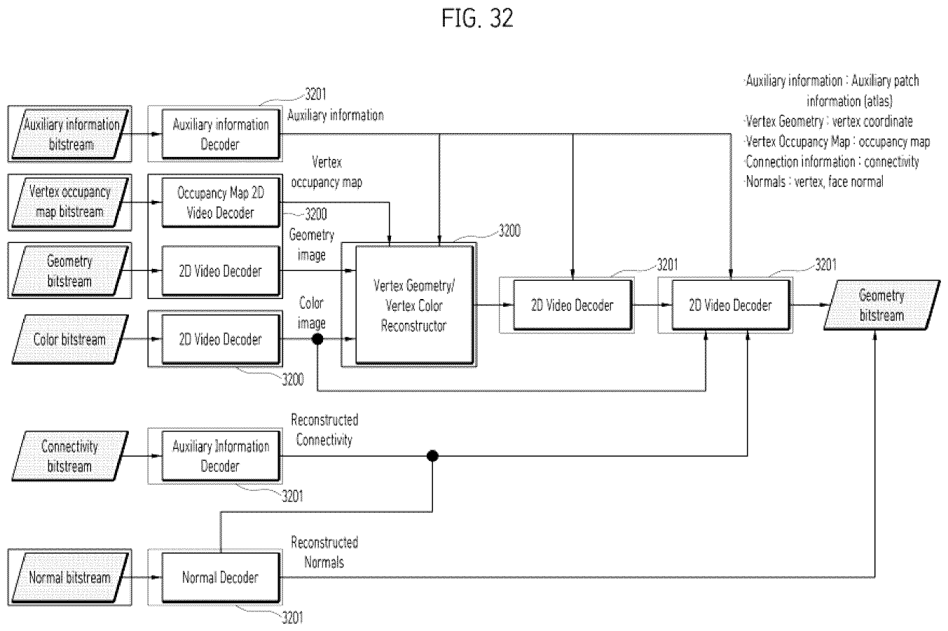

Referring to FIG. 31, the normals may be compressed based on predictive coding. The predictive data about the normal may be generated based on the reconstructed geometry and restored connectivity. Based on the reconstructed geometry and restored connectivity, the restored connectivity for the reconstructed vertex may be acquired the, and the normals represented by the correction and the connectivity may be predicted. A residual of the predicted normal and the current normal may be generated, and the size of the bitstream may be reduced. FIG. 32 illustrates a 3D mesh data decoder according to embodiments.

FIG. 32 may correspond to a point cloud data reception device, decoder, or the like according to embodiments. Each component of FIG. 32 may correspond to hardware, software, a processor, and/or a combination thereof. FIG. 32 is a receiving-side decoder corresponding to the transmitting-side encoder of FIGS. 28 to 31. The decoder may perform a corresponding process and/or inverse process of the encoder.

A vertex color reconstructor receives a color image reconstructed by the 2D video decoder, a reconstructed occupancy map, and auxiliary information as input and reconstructs a vertex color based thereon.

A vertex geometry reconstructor receives the geometry image reconstructed by the 2D video decoder, the reconstructed occupancy map, and the auxiliary information as input and reconstructs vertex geometry.

An auxiliary information decoder decodes the input auxiliary information bitstream to restore auxiliary information for reconstructing a three-dimensional mesh from the projected geometry and color image.

According to embodiment, the auxiliary information may include a projection plane index determined per patch, a 2D bounding box position (u0, v0, u1, v1) of the patch, a 3D reconstruction position (x0, y0, z0) with respect to the bounding box of the patch, a patch index map in M×N units in an image space of W×H, a vertex order table, and auxiliary information for reconstructing face information between patches.

The vertex order table is information needed to map the vertex order of the restored connectivity to the vertex order restored through geometry/color decoding. The decoder may map the vertex order generated according to a predetermined scanning order to the restored vertex order of the connectivity based on the vertices reconstructed through geometry/color decoding.

According to embodiments, the texture coordinates per vertex (color image coordinates of the vertex) constituting the face between the patches may be further parsed to reconstruct the face color between the patches.

In this operation, the color of the face may be packed into a color image for parsing.

A vertex order mapper receives the vertex order table parsed as auxiliary information as input and maps the indices of the vertices restored by the 2D video decoder to the restored restored by the connectivity decoder.

A face color reconstructor receives as input the color image, auxiliary information, and restored connectivity reconstructed by the 2D video decoder and reconstructs the face color.

A normal decoder receives a normal bitstream as input and reconstructs face and vertex normals.

The normal decoding may be performed in the same order as the connectivity decoding order, or the reconstructed geometry may be scanned in a scanning order agreed between the encoder/decoder to perform the reconstruction in the corresponding order. According to embodiments, a normal may be predicted based on the reconstructed geometry and the pre-reconstructed normal.

In an embodiment, 2D video decoding may be performed on a per group of frame (GOF) basis for the occupancy map, color, and geometry.

Accordingly, connectivity, auxiliary information, and normals may be decoded on a per GOF basis.

The connectivity decoder decodes the connectivity bitstream to restore the connectivity between vertices.

Referring to FIG. 32, the mesh decoder may use auxiliary information, vertex occupancy map, geometry image, color image, restored connectivity, and reconstructed normal. The auxiliary information, connectivity, and normal may be characteristic components of the mesh data, and the vertex order mapping. They may be additional characteristic components that the representation color reconstructor and the mesh data decoder include.

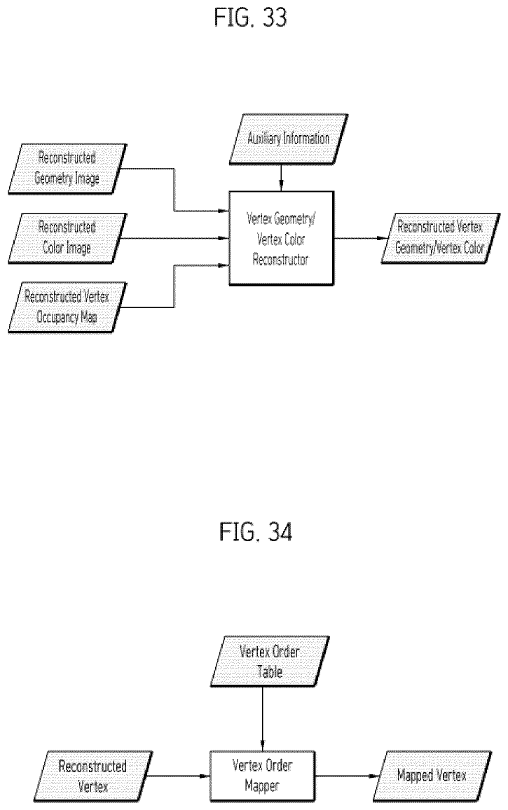

FIG. 33 illustrates a vertex geometry/vertex color decoder according to an embodiment.

FIG. 33 more specifically illustrates the vertex geometry/vertex color decoder included in FIG. 32.

The vertex geometry reconstructor reconstructs the 3D coordinates of the vertices per patch from the reconstructed geometry image based on the reconstructed geometry image, the vertex occupancy map, and the auxiliary information as input.

The auxiliary information used as input may include patch index information, projection plane information for each patch, bounding box coordinates for each patch, and x, y, z axis offsets (tangential, bi-tangential, depth shift) for 3D reconstruction in the geometry.

The vertex color reconstructor receives a reconstructed vertex occupancy map and a reconstructed color image as input and restores the color values of the reconstructed color image of a point with a vertex occupancy map equal to 1 to the color values of the reconstructed vertex from the geometry image at the same position.

The vertex geometry reconstructor reconstructs the 3D vertex geometry based on the pixel positions and pixel values (distances from the projection plane) of the reconstructed geometry image at a point where the reconstructed vertex occupancy map is equal to 1, and auxiliary information per patch.

FIG. 34 illustrates a vertex order mapper according to embodiments.

FIG. 34 more specifically illustrates the vertex order mapper included in FIG. 32.

The vertex order mapper maps the vertex indices restored by the 2D video decoder in a vertex order table decoded by the auxiliary information decoder to the vertex indices of a connectivity decoded by the connectivity decoder.

In some embodiments, the vertex order mapper may be omitted if the vertex indices restored by the 2D video decoder and the vertex indices of the connectivity restored through the connectivity decoder are the same.

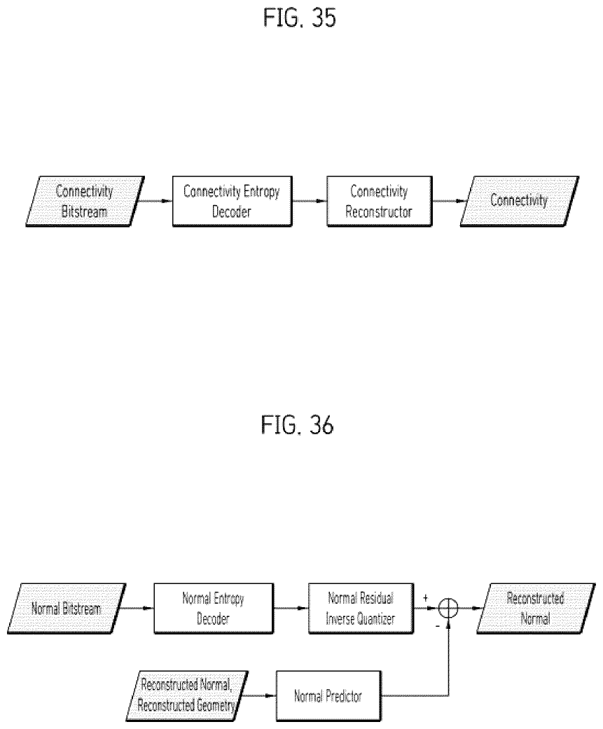

FIG. 35 illustrates a connectivity decoder according to embodiments.

FIG. 35 more specifically illustrates the connectivity decoder included in FIG. 32.

The connectivity entropy decoder may entropy encode the mapped symbols using Exponential Golomb, Variable Length Coding (VLC), Context-Adaptive Variable Length Coding (CAVLC) or Context-Adaptive Binary Arithmetic Coding (CABAC) or the like according to embodiments.

According to embodiments, the entropy probability of the connectivity entropy decoder may be initialized on a per-frame basis, or on a per-subframe basis, or on a per-frame group basis.

In addition, according to embodiments, a table of probability values in a specific connection relationship may be used as input to the connectivity entropy decoder for entropy decoding. In this case, the specific connection relationship may include the number of edges connected to the vertex currently being decoded, or the number of triangles connected to the current vertex.

The connectivity reconstructor reconstructs the connectivity from the symbols representing the connection relationship of the vertices or edges decoded by the entropy decoder. FIG. 36 illustrates a normal decoder according to embodiments.

FIG. 36 illustrates a normal decoder included in FIG. 32.

The normal decoder parses the normal bitstream and performs entropy decoding and inverse quantization to generate a reconstructed normal residual or reconstructed normal. According to an embodiment, the normal predictor may be omitted.

In this case, the entropy decoding may be performed using Exponential Golomb, Variable Length Coding (VLC), Context-Adaptive Variable Length Coding (CAVLC) or Context-Adaptive Binary Arithmetic Coding (CABAC) or the like.

The normal predictor predicts the current vertex and face normal based on the reconstructed normal, reconstructed geometry, and the like.

The reconstructed normal may be generated by adding the predicted normal and the reconstructed normal residual.

Regarding the order of normal decoding, reconstructed vertices may be decoded according to a scanning order defined according to the agreement between the encoder/decoder, or in the same order as the connectivity decoding order, according to embodiments.

According to embodiments, a normal may be mapped to a single three-channel color value in encoding the normal to reconstruct a projection-based normal image in the same manner as in the geometry and color encoders.

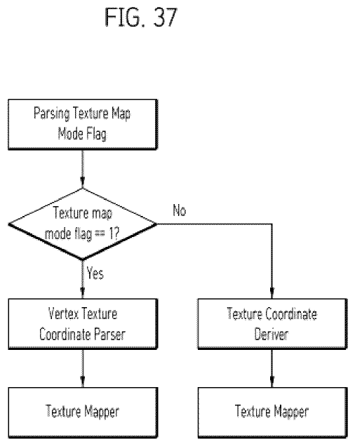

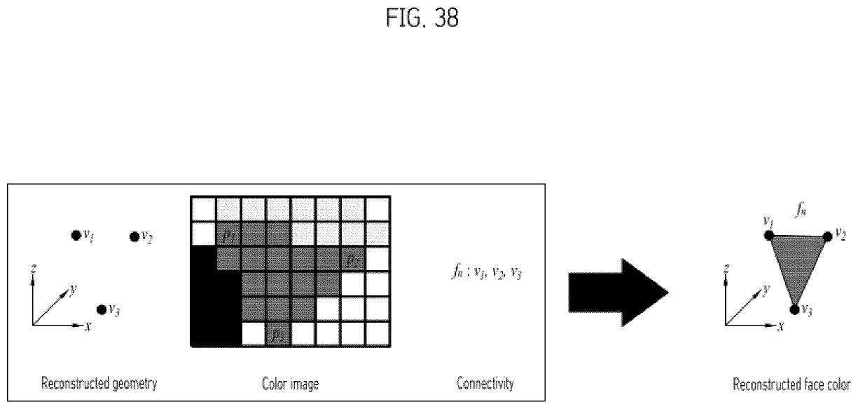

FIG. 37 illustrates a face color decoder according to embodiments.

FIG. 37 more specifically illustrates the face color decoder in FIG. 32.

A face color reconstructor reconstructs the face color of the mesh data based on a reconstructed color image or a reconstructed texture map.

The encoder constructs a color image by projecting or warping the vertex color and the face color composed of vertices in encoding the color image (attribute image in the existing VPCC), and the decoder may restore the face color based on the reconstructed color image. This mode is referred to as a color image mode (proposed mode 1), and the mode that restores the face color based on the texture map and vertex texture coordinates is referred to as a texture map mode (proposed mode 2).

According to embodiments, when the texture map mode is used, a texture map image may be parsed and reconstructed, or a color image with an additionally packed texture map may be parsed.

According to embodiments, the face color may always be reconstructed in the color image mode. Alternatively, the color image mode and the texture map mode may be reconstructed on a basis of a specific unit. Alternatively, the face color may always be reconstructed in the texture map mode.

The specific unit may be a sequence, a frame, or a tile or patch of a color image. FIG. 38 illustrates an example of a face color display according to embodiments.

FIG. 38 illustrates a face color represented based on reconstructed geometry, color image, and connectivity.

When reconstruction is performed in the color image mode:

The color image mode may reconstruct the face color from a color image.

When the reconstruction is performed in the color image mode, parsing of vertex texture coordinates may be omitted.

Here, the texture coordinates (u, v) of each vertex may be derived by the decoder as the coordinates pₙ=(Xₙ>yₙ) of vertex Vn in the color image through a texture coordinate deriver.

The color image mode reconstructs the face color by performing texture mapping on (Xₙ>yₙ) derived for each reconstructed vertex.

When reconstruction is performed in the texture map mode:

When the face color is reconstructed using a texture map, the vertices included in a particular unit may be further parsed for texture coordinates. According to the embodiment, the vertex texture coordinates may be decoded by the auxiliary information decoder according to a predetermined scanning order based on the reconstructed vertices or based on the geometry image.

The scanning order may be, for example, a 3D Morton order or a z-scan order on a color image.

The vertex texture coordinates may be predicted from the coordinates reconstructed first in the scanning order.

The texture map may be packed into a separate texture map image from the color image by the encoder for parsing, or it may be packed into one color image by the decoder for parsing.

When the reconstruction is performed using as a separate texturemap, the width and height of the texture map may be parsed as auxiliary information on a frame-by-frame, sequence-by-sequence, or tile-by-tile basis.

In some embodiments, the texture mapping may linearly interpolate the texture

coordinates of the face pixels based on the texture coordinates of the vertices to be reconstructed, and restoring the image colors or pixel values of the texture map image to the color values of the face pixels based on the texture coordinates.

When the interpolated texture coordinates are not integer positions of the image color or texture map image, the nearest pixel values or linearly or bilinearly integrated pixel values may be restored.

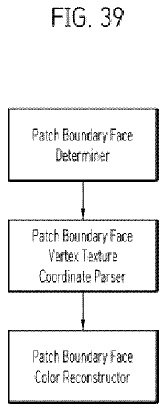

FIG. 39 illustrates a patch boundary representation color decoder according to embodiments.

FIG. 39 more specifically illustrates the patch boundary representation color reconstructor in FIG. 32.

Patch boundary face color reconstruction: When a face color is reconstructed in the color image mode, for face color present between patches may be packed into a color image and encoded by the encoder, and the decoder may reconstruct the color according to parsing of the color image.

When a face is composed of vertices from multiple patches, the decoder may perform texture mapping by further parsing the texture coordinates of the vertices.

Patch boundary face determiner: When a face is composed of multiple patches based on the reconstructed connectivity and geometry received as input, the face is determined to be a patch boundary face.

Patch boundary face vertex texture coordinate parser: Parses the texture coordinates of the vertices that constitute the face determined as a patch boundary face by the patch boundary face determiner.

Patch boundary face color reconstructor: Reconstructs the face color by performing texture mapping on the parsed texture coordinates for the patch boundary face.

According to an embodiment, the patch boundary face color may be packed into a color image by the encoder and parsed by the decoder to perform texture mapping.

FIG. 40 illustrates a V3C bitstream structure according to embodiments.

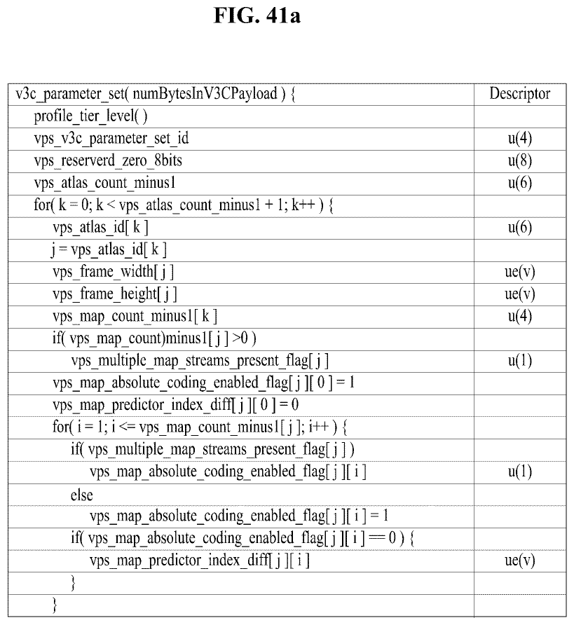

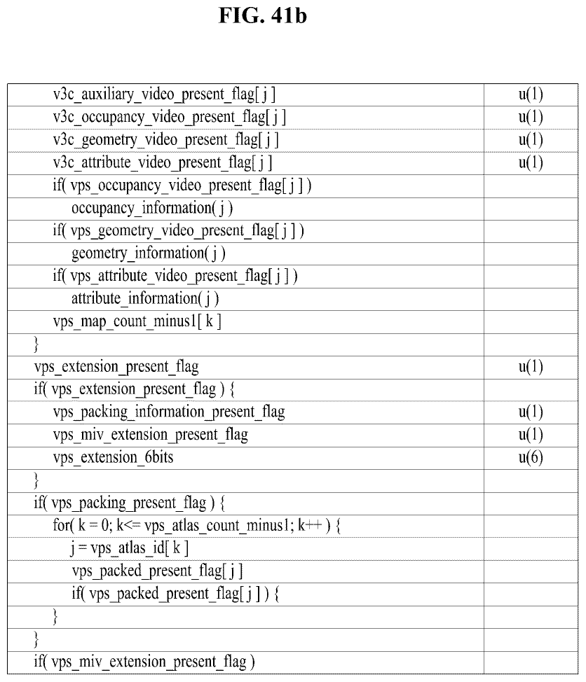

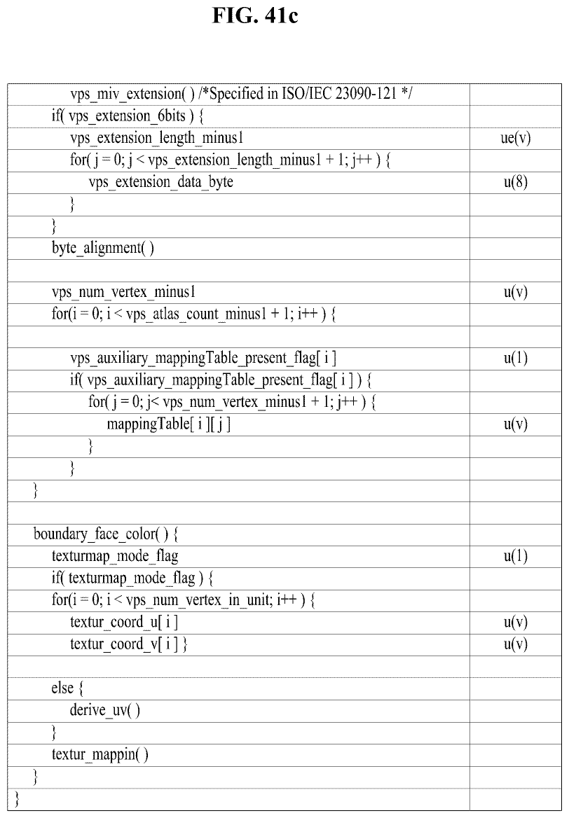

A point cloud data transmission method/device according to embodiments may compress (encode) point cloud data, generate related parameter information (e.g., FIG. 41), and generate and transmit a bitstream as shown in FIG. 40.

A point cloud data reception method/device according to embodiments may receive a bitstream as shown in FIG. 26 and decode the point cloud data contained in the bitstream based on the parameter information contained in the bitstream.

In the point cloud data transmission device according to the embodiments, signaling information (which may be referred to as parameter/metadata or the like) may be encoded by a metadata encoding part (which may be referred to as a metadata encoder or the like) and contained in a bitstream to be transmitted. Further, in the point cloud data reception device according to the embodiments, the metadata may be decoded by a metadata decoding part (which may be referred to as a metadata decoder or the like) and provided to a process of decoding the point cloud data.

A transmitter according to embodiments may encode the point cloud data to generate a bitstream.

The bitstream may include a V3C unit.

A receiver according to embodiments may receive the bitstream transmitted by the transmitter, and decode and reconstruct the point cloud data. Hereinafter, a specific syntax of the V3C unit and the elements included in the V3C unit according to embodiments are described.

FIG. 41 illustrates a V3C parameter set according to embodiments.

FIG. 41 illustrates the parameters included in the V3C bitstream of FIG. 40.

vps_v3c_parameter_set_id: Provides an identifier for the V3C VPS for reference by other syntax elements. The value of vps_v3c_parameter_set_id may be in the range of 0 to 15.

vps_reserved_zero_8bits: If present, vps_reserved_zero_8bits may be equal to 0 in the bitstream. Other values for vps_reserved_zero_8bits may be reserved for future use by ISO/IEC. The decoder may ignore the value of vps_reserved_zero_8bits.

vps_atlas_count_minus1: vps_atlas_count_minus plus 1 indicates the total number of supported atlases in the current bitstream. The value of vps_atlas_count_minus1 may be in the range of 0 to 63.

vps_atlas_id [k]: vps_atlas_id [k] indicates the ID of the atlas with index k. The value of vps_atlas_id [k] may be in the range of 0 to 63. The value of vps_atlas_id [k] may not be the same as vps_atlas_id [j] for all j!=k.

vps_frame_width [j]: vps_frame_width [j] indicates the V3C frame width in terms of integer luma samples for atlas with atlas ID j. This frame width is the nominal width associated with all V3C components for the atlas with atlas ID j.

vps_frame_height [j]: vps_frame_height [j] indicates the V3C frame height in terms of integer luma samples for the atlas with atlas ID j. This frame height is a nominal height associated with all V3C components in the atlas with atlas ID j.

vps_map_count_minus1 [j]: vps_map_count_minus1 [j] plus 1 indicates the number of maps used to encode geometry and attribute data for the atlas with atlas ID j. vps_map_count_minus 1 [j] may be in the range of 0 to 15.

vps_multiple_map_streams_present_flag[j]: vps_multiple_map_streams_present_flag[j] equal to 0 indicates that all geometry or attribute maps for the atlas with atlas ID j are placed in a single geometry or attribute video stream, respectively. vps_multiple_map_streams_present_flag[j] equal to 1 indicates that all geometry or attribute maps for the atlas with atlas ID j are placed in separate video streams. When vps_multiple_map_streams_present_flag[j] is not present, its value may be inferred to be equal to 0.

vps_map_absolute_coding_enabled_flag[j][i]: vps_map_absolute_coding_enabled_flag[j][i] equal to 1 indicates that the geometry map with index i for the atlas with atlas ID j is coded without any map prediction. vps_map_absolute_coding_enabled_flag[j][i] equal 0 indicates that the geometry map with index i for the atlas with atlas ID j is first predicted from another, earlier coded map, prior to map coding. When vps_map_absolute_coding_enabled_flag[j][i] is not present, its value may be inferred to be equal to 1.

vps_map_predictor_index_diff [j][i]: vps_map_predictor_index_diff [j][i] is used to compute the predictor of the geometry map with index i for the atlas with atlas ID j when vps_map_absolute_coding_enabled_flag[j][i] is equal to 0. More specifically, the map predictor index for map i, MapPredictorIndex [i], is calculated as:

MapPredictorIndex [i] =(i-1)-vps_map_predictor_index_diff [j][i] (15)

The value of vps_map_predictor_index_diff [j][i] may be in the range of 0 to i-1. When vps_map_predictor_index_diff [j][i] is not present, its value may be inferred to be equal to 0.

vps_auxiliary_video_present_flag[j]: vps_auxiliary_video_present_flag[j] equal to 1 indicates that auxiliary information for a patch in the atlas with atlas ID j, i.e., information related to RAW or EOM patch types for patches in the atlas with atlas ID j, may be stored in a separate video stream called an auxiliary video stream. vps_auxiliary_video present_flag[j] equal to 0 indicates that auxiliary information, i.e., information related to RAW or EOM patch types for patches in the atlas with atlas ID j, is stored in an auxiliary video stream. When vps_auxiliary_video_present_flag[j] is not present, it is inferred to be equal to 0.

vps_occupancy_video_present_flag[j]: vps_occupancy_video_present_flag[j] equal to 0 indicates that the atlas with the atlas ID j does not have related occupancy video data. vps_occupancy_video_present_flag[j] equal to 1 indicates that t that the atlas with the atlas ID j shall have related occupancy video data. When vps_occupancy_video_present_flag[j] is not present, it is inferred to be equal to 1.

It may be a requirement of bitstream conformance that if vps_occupancy_video_present_flag[j] is equal to 1 for an atlas with atlas ID j, pin_occupancy_present_flag[j] is equal to 0 for an atlas with the same atlas ID.

vps_geometry_video_present_flag[j]: vps_geometry_video_present_flag[j] equal to 0 indicates that the atlas with atlas ID j does not have related geometry video data. vps_geometry_video_present_flag[j] equal to 1 indicates that the atlas with atlas ID j should have related geometry video data. When vps geometry_video present_flag[j] is not present, it is inferred to be equal to 1.

It may be a requirement of bitstream conformance that if vps_geometry_video_present_flag[j] is equal to 1 for an atlas with atlas ID j, pin_geometry present_flag[j] is equal to 0 for an atlas with the same atlas ID.

vps_attribute_video_present_flag[j]: vps_attribute_video_present_flag[j] equal to 0 indicates that the atlas with the atlas ID j does not have related attribute video data. vps_attribute_video_present_flag[j] equal to 1 indicates that the atlas with atlas ID j should have at least one related attribute video data. When vps_attribute_video_present_flag[j] is not present, it is inferred to be equal to 1.

It may be a requirement of bitstream conformance that if vps_attribute_video_present_flag[j] is equal to 1 for an atlas with atlas ID j, pin_attribute_present_flag[j] shall be equal to 0 for an atlas with the same atlas ID j.

vps_extension_present_flag: vps_extension_present_flag equal to 1 indicates that the syntax elements vps_packing_information_present_flag, vps_miv_extension_present_flag, and vps_extension_6bits are present in the syntax structure of v3c_parameter_set ( ) vps_extension_present_flag equal to 0 indicates that the syntax elements are not present.

vps_packing_information_present_flag: vps_packing_information_present_flag equal to 1 indicates that one or more instances of the syntax structure of packing_information (j) are present in the syntax structure of v3c_parameter_set ( ) vps_packing_information_present_flag equal to 0 indicates that this syntax structure is not present. When not present, the value of vps_packing_information_present_flag is inferred to be equal to 0.

vps_miv_extension_present_flag: vps_miv_extension_present_flag equal to 1 indicates that the syntax structure of vps_miv_extension ( ) is present in the syntax structure of v3c_parameter_set ( ) vps_miv_extension_present_flag equal to 0 indicates that this syntax structure is not present. When not present, the value of vps_miv_extension_present_flag is inferred to be equal to 0.

vps_extension_6bits: vps_extension_6bits that is not equal to 0 indicates that the syntax element vps_extension_length is present in the syntax structure of v3c_parameter_set ( ) vps_extension_6bits equal to 0 indicates that the syntax element vps_extension_length_minus1 is not present. vps_extension_6bits may be equal to 0 in bitstreams that conform to this version of this document. Other values of vps_extension_6bits may be reserved for future use by ISO/IEC.

vps packed_video_present_flag[j]: vps_packed_video_present_flag[j] equal to 0 indicates that the atlas with atlas ID j does not have related packed video data. vps_packed_video_present_flag[j] equal to 1 indicates that the atlas with atlas ID j should have related packed video data. When vps packed_video present_flag[j] is not present, it is inferred to be equal to 0.

It is a requirement of bitstream conformance if vps_packed_video_present_flag[j] is equal to 1 for an atlas with atlas ID j, at least one of the pin_occupancy_present_flag[j], pin_geometry present_flag[j], or pin_attribute_present_flag[j] is equal to 1.

It may be a requirement for bitstream conformance that if vps_packed_video_present_flag[j] is equal to 1 for atlas ID j, at least one of pin_occupancy present_flag[j], pin_geometry present_flag[j], or pin_attribute_present_flag[j] is equal to 1.

vps_extension_length_minus1: vps_extension_length_minus1 plus 1 indicates the number of elements vps_extension_data_byte following this syntax element.

vps_extension_data_byte may have any value.

vps_num_vertex_minus1: Indicates the number of vertices in the frame-1.

vps_auxiliary_mappingTable_present_flag: A flag indicating the presence or absence of a vertex order table. The flag equal to 1 indicates that the vertex order table is present. The flag is equal to 0 indicates that the vertex order table is not present.

mappingTable: Indicates a vertex order table. The vertex order table may be decoded by the auxiliary information decoder. The indices of the vertices may be restored by the 2D video decoder. The connectivity may be decoded by the connectivity decoder. The mapping table represents information indicating the mapping of the indices of the vertices reconstructed by the 2D video decoder to the indices of the vertices of the connectivity decoded by the connectivity decoder.

texturemap_mode_flag: A flag indicating the texture map mode. The flag equal to 1 indicates that a texture map is present. The flag is equal to 0 indicates that the texture map is not present.

num_vertex_in_unit: Indicates the number of vertices in a specific unit. This may be implicitly inferred by the decoder as the number of reconstructed vertices in the specific unit. The number may be parsed according to embodiments.

texture_coord_u and texture_coord_v: Indicate the coordinate values of the vertex texture. They indicate the values of u and v for uv coordinates, respectively.

derive_uv ( ) Represents the vertex texture coordinate deriver.

texture_mapping ( ) Represents the patch boundary face color reconstructor.

The V-PCC encoding/decoding standard supports efficient encoding/decoding of point cloud data based on video codecs. Therefore, it may not be possible to process mesh (triangle, polygon) information in the current V-PCC standard. However, in general, when the point cloud data is displayed by a user's application, other forms of information such as mesh (triangle, polygon) information obtained by transforming and processing the point cloud data, rather than the point cloud data itself, may be utilized in most cases. The V-PCC standard method does not include a mesh information processor, and accordingly a separate process or system may be added to transfer mesh information or generate mesh information through post-processing, depending on the application being used. Furthermore, embodiments may include methods for efficiently encoding/decoding both types of 3D mesh data (mesh data with vertex color information and mesh data with a texture map and vertex texture coordinates) in the V-PCC standard method.

In embodiments, the proposed structure allows mesh data having vertex color information and mesh data having a texture map and vertex texture coordinates to be compressed using an encoder/decoder with the same structure. An optimal face color encoding mode may be selected between the texture map mode and color image mode proposed by the encoder to perform efficient encoding according to the characteristics of the data. According to the face color decoding method of the proposed color image mode, efficient decoding may be performed by implicitly deriving the texture coordinates of the corresponding vertices by the decoder without transmitting the texture coordinates by the encoder.

FIG. 42 illustrates category 1 mesh data according to embodiments.

FIG. 42 illustrates eight consecutive frames in a longdress for category 1 mesh data.

A method/device according to embodiments may perform a texture map rearrangement for efficient mesh coding in V-PCC.

Embodiments relate to video-based point cloud compression (V-PCC), a method for compressing 3D point cloud data using an existing 2D video codec. Currently, in the standard V-PCC method does not allow for processing of mesh data. Only processing of mesh data through a preprocessor and a postprocessor is allowed. Embodiments propose a method for utilizing a texture map in the mesh data as an attribute image for V-PCC when the mesh data is processed in a conventional V-PCC method.

Embodiments include the following operations.

The mesh data texture map reconstruction may be performed by block-based calculation of a context matching rate in the texture map.

The mesh data texture map reconstruction may be performed by object-based calculation of a context matching rate in the texture map.

According to embodiments, decoding/encoding may be performed efficiently not only for videos where the texture map is properly organized for V-PCC, but also for videos where the texture map is unorganized.

Embodiments are directed to methods for efficiently performing mesh data processing in VPCC encoding/decoding. Proposed herein is a method for utilizing the characteristics of V-PCC that processes data based on video codecs when processing mesh data based on V-PCC.

The V-PCC standard is for point cloud data only, and a new standardization process for mesh data processing is currently underway. The standard MPEG defines the following types of mesh data

Category 1: Mesh data including texture maps.

Category 2: Mesh data with texture information on the vertices.

The embodiments propose a method for efficiently utilizing the characteristics of the V-PCC video decoder/encoder when decoding/encoding mesh data of category 1 and natured mesh data through V-PCC.

In the V-PCC standard for compressing point cloud information with video codecs, there is a standard related activity for handling mesh information. This is because the point cloud information itself is rarely used in applications. The data volume of the point cloud information itself is very large, and thus the point cloud information is usually transformed into mesh data according to the characteristics of each application and viewing device. Currently, only point cloud information is supported by the V-PCC standard, and thus a separate mesh encoder/decoder is being used, and there is an attempt to establish a V-PCC standard that covers mesh information.

There are two types of mesh information defined by standards organizations as follows.

Category 1: Mesh data including a texture map

Category2: Mesh data with texture information on the vertices

In general, Category 1 is the type that is currently utilized in many applications. In the case of Category 2, connectivity, which is a characteristic of mesh data, is added to the current point cloud data using specific software. In the current V-PCC standard area, for mesh coding, category 1 and category 2 frameworks may be configured and processed separately.

Embodiments are proposed for frameworks that utilize characteristics of category 1 data. A method for utilizing a texture map, which is a characteristic of category 1 data, as an attribute image in V-PCC is proposed.

FIG. 42 shows part of the category 1 mesh information defined by a standards organization. It shows images of frames #1 to #8 in a longdress sequence.

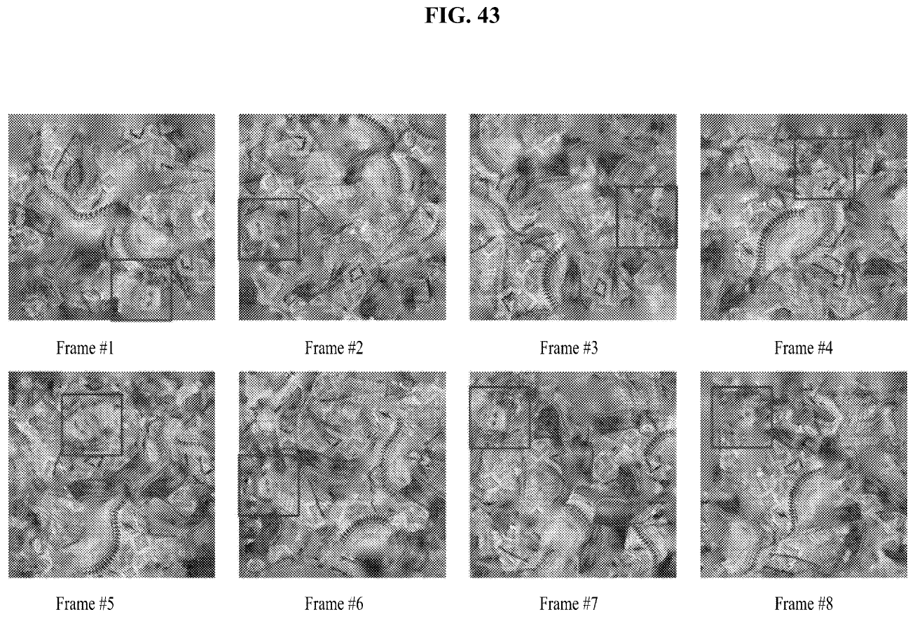

FIG. 43 illustrates a texture map for each of consecutive frames according to embodiments.

FIG. 43 illustrates a texture map corresponding to each of the eight longdress frames of FIG. 42. Referring to the consecutive frames of FIG. 42, it may be seen that the image itself has changed very little. However, the texture maps in FIG. 43 show no temporal consistency, even though they are adjacent frames. This may cause significant degradation in compression performance in terms of V-PCC that employs a video encoder/decoder.

Referring to the texture maps for consecutive frames in FIG. 43, it may be seen that the objects in the texture maps have similar attributes. It may be inefficient to compress and reconstruct data with little change in these consecutive frames without continuity.

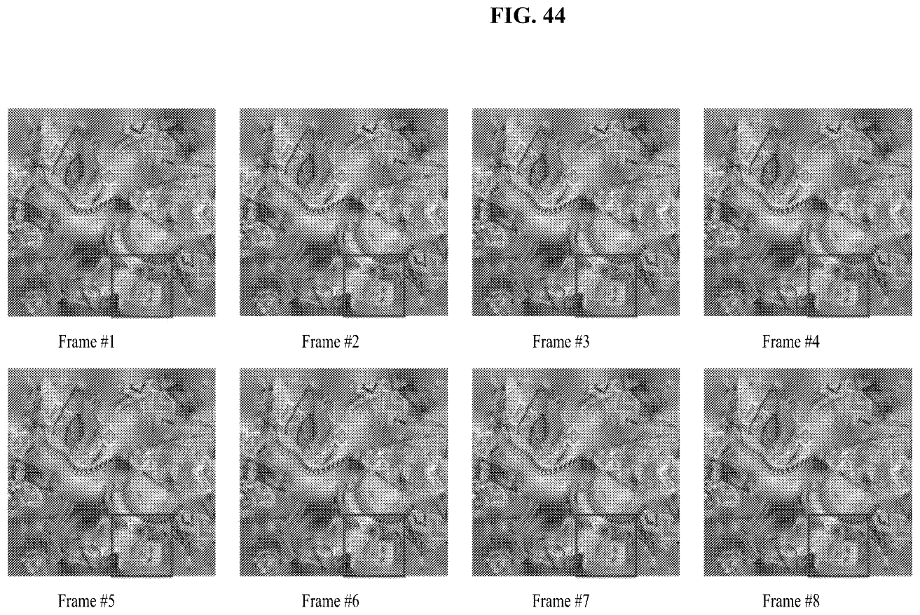

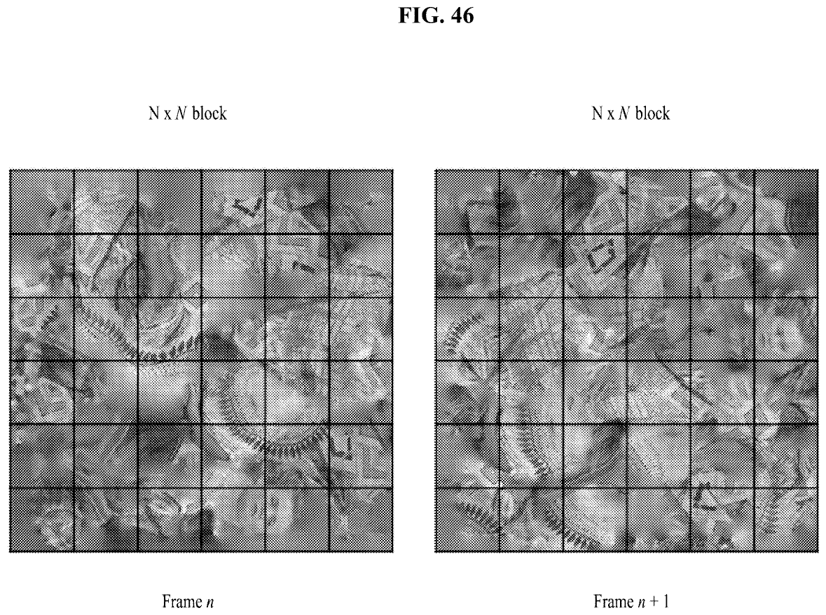

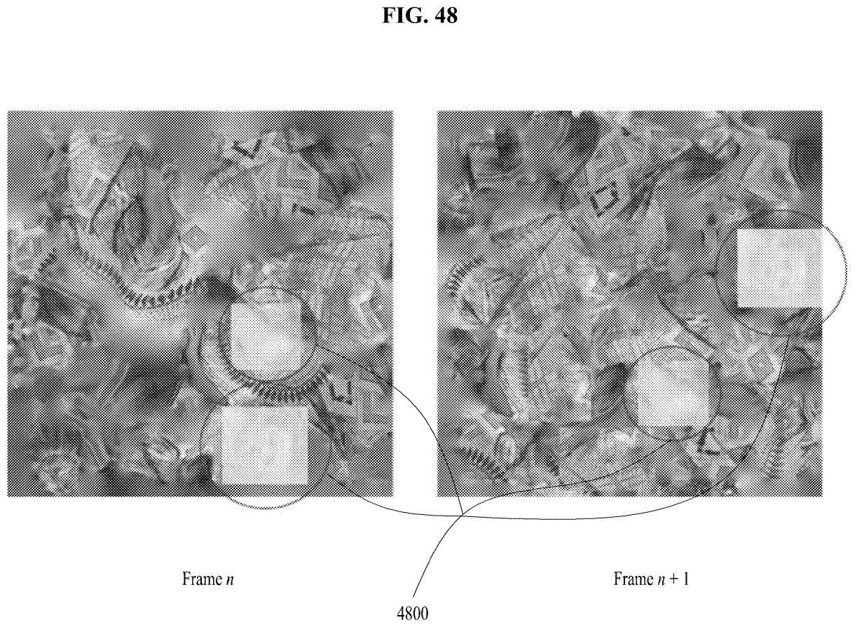

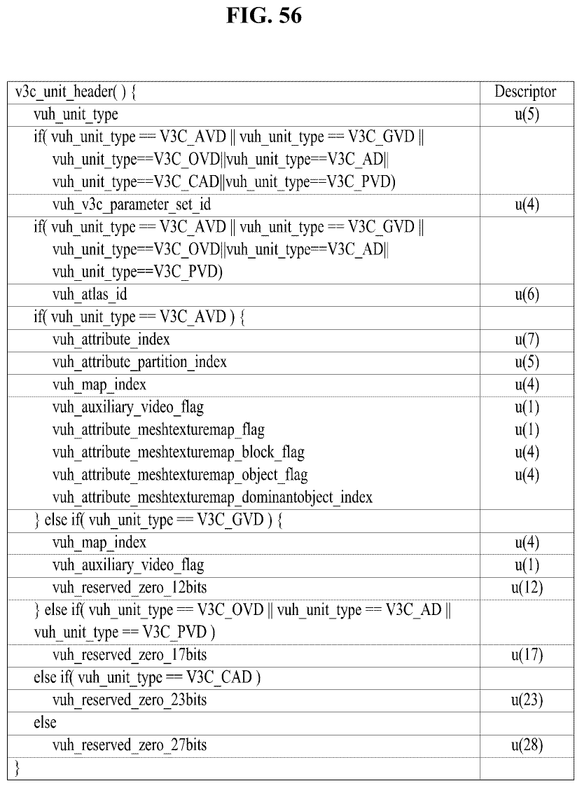

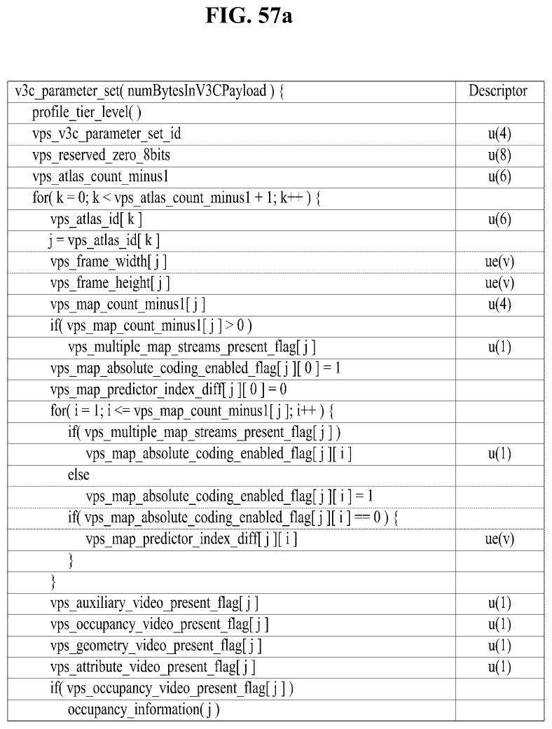

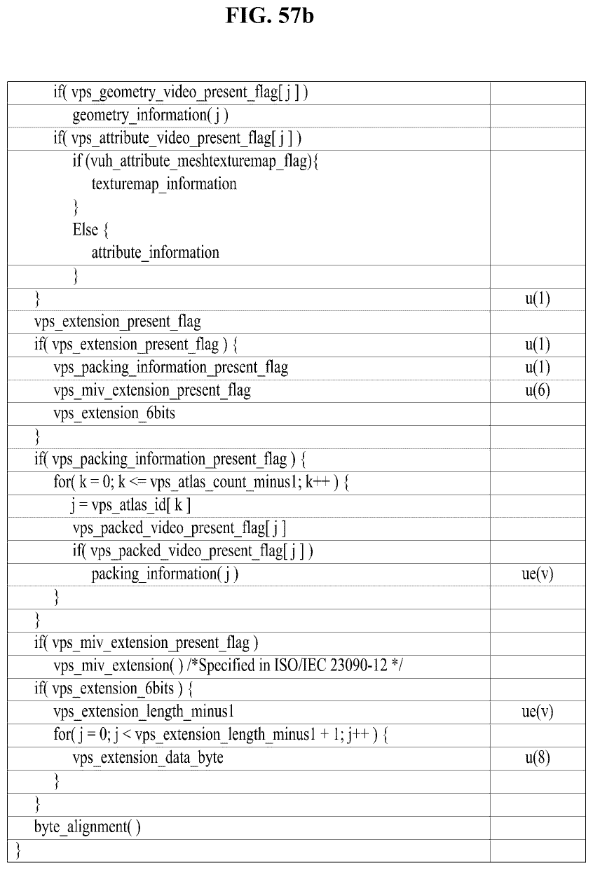

A texture map is a projection of the point cloud data contained in a frame, which is a map-like data of the point cloud data. In compressing and reconstructing the point cloud data, the point cloud data may be reconstructed based on the texture map. The texture map may include points and their colors projected onto a plane. Compression/reconstruction performance may be increased by efficiently compressing data present within a similar range across frames. As shown in FIG. 44, the texture map within a frame may be reconstructed. Further, the reconstruction unit may be a block of constant size as shown in FIG. 46, or an object unit of an object as shown in FIG. 48. Information about blocks and objects may be included in a unit header as shown in FIG. 56. In addition, signaling information about the reconstruction may be included in a parameter set as shown in FIG. 57. The reception device may parse the unit header and/or parameter set contained in the received bitstream and efficiently reconstruct the mesh data based on the texture map.

FIG. 44 illustrates a reconstruction of texture maps of consecutive frames according to embodiments.

FIG. 44 illustrates an example of reconstructing the texture maps of each of eight consecutive longdress frames to maintain temporal consistency.

As shown in FIG. 44, if the texture maps are reconstructable to maintain temporal consistency, the attribute images in V-PCC are replaceable with the texture maps of the mesh data, and thus compression efficiency may be expected to be improved. In particular, in the case of V-PCC mesh coding, which, unlike G-PCC, requires the use of a video encoder/decoder, the reconstruction of the mesh data texture map capable of maintaining temporal consistency may have a significant impact on performance.

Accordingly, methods/devices according to embodiments may provide the following effects.

By utilizing the texture map of the mesh data as an attribute map of V-PCC, the efficiency of coding the mesh data using the V-PCC may be increased.

Texture maps may be given temporal consistency to take advantage of the characteristics of the video encoder/decoder.

When complete texture map reconstruction is not feasible, coding efficiency may be maximized by a calculation for minimization.

The following method is proposed to efficiently compress video data by reconstructing a texture map suitable for the V-PCC standard.

The mesh data texture map may be reconstructed by calculating the context matching rate per block within the texture map.

The mesh data texture map may be reconstructed by calculating the context matching rate per object within the texture map.

One of the above two methods may be selected, or both methods may be used complementarily.

Hereinafter, the method of reconstructing a mesh data texture map by calculating a context matching rate will be described.

Referring to FIG. 44, it may be seen that, for example, the position of the texture of an object included in eight consecutive frames is reconstructed such that the position of the object in the texture map in the consecutive frames is placed with consistency. In other words, when compressing point cloud data about an object included in frames into a texture map representing the position, color, configuration, etc. of the object, the compression performance may be increased by reconstructing the map with consistency. The region marked with a square in FIG. 44 is an example of a human face. It may be seen that the human face included in frames #1 to #8 are reconstructed in similar positions and with similar colors.

FIG. 45 illustrates a texture map rearranger according to embodiments.

The point cloud data transmission device, encoder, and the like described above may further include a texture map rearranger as shown in FIG. 45.

As shown in FIG. 45, a V-PCC framework for conventional mesh coding may further include a texture map rearranger (which may be referred to as a processor or the like) configured to minimize temporal consistency. The temporal consistency minimization calculator may include a calculator configured to minimize a similarity measure (such as a mean square error, Euclidean distance, correlation, etc.) of texture information (such as color, edge, feature point, etc.) that may represent image features.

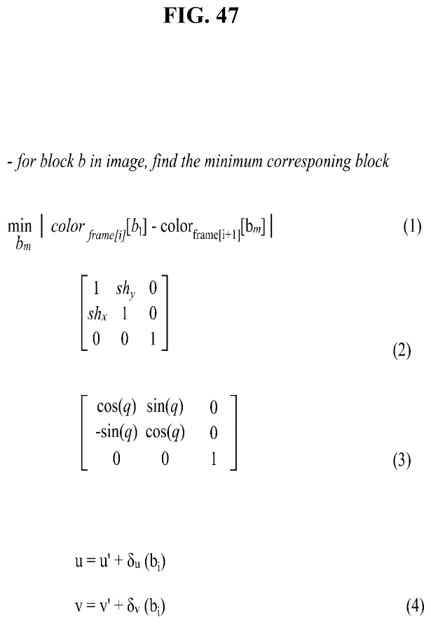

FIGS. 46 and 47 illustrate texture reconstruction according to embodiments.

FIGS. 46 and 47 illustrate an example of using the mean square error of color values in the texture information. Texture map reconstruction may be performed by dividing each consecutive texture map into N x N blocks and voting for a block that best matches each block among neighboring blocks. In this case, if a perfect match is not possible, the error is minimized to maintain as much consistency as possible.

Referring to FIG. 47-(1), the block bm that is most similar to (least different from) the color value of each block may be determined. In this way, a method for maintaining consistency between the current frame and the next frame may be utilized. While FIG. 46 illustrates an example of 6×6 blocks, the number of blocks may be increased or decreased. In addition to simply comparing blocks, the matching method may be varied by using the affine transform of FIG. 47-(2) and rotation transform of FIG. 47-(3), as shown in FIG. 47.

Referring to FIG. 47-(2), shₓ and sh_{y} denote the factors of the affine transformation for the x and y axes, respectively. In Figure FIG. 47-(3), q denotes the rotation angle.

Depending on the result of the calculation, the texture map may be used as an attribute image as it is, or may be reconstructed and used with UV mapping (FIG. 47-(4)). When the texture map is reconstructed according to the result of the matched block, the texture coordinates (UV mapping) may be affected. Therefore, a correction may be applied to the existing coordinates by the u,v coordinates of the changed image coordinates of each block and reflected in the texture map configuration.

In this way, through the calculation of FIG. 47, each block in the texture map may correspond to the most similar point to the block of the next frame to maintain temporal continuity as much as possible. In this case, a metric that may effectively minimize the difference may be used in addition to the exemplary method in FIG. 47. In addition, when the similarities are similar, the entire dominant vectors may be applied collectively to improve temporal consistency.

FIG. 48 illustrates texture reconstruction using object-by-object matching according to embodiments.

FIG. 48 shows an example of texture reconstruction using main object-based matching. Similar to the block-by-block processing in FIG. 46, a texture map may be reconstructed to maximize temporal consistency by matching on a main object basis. An object part may be any unit that makes up an object. For example, when the object is a human, the object parts may be divided into a face, a body, legs, and the like of the human.

Category 1 may be data with texture maps an, and category 2 may be additional data with points and mesh connectivity.

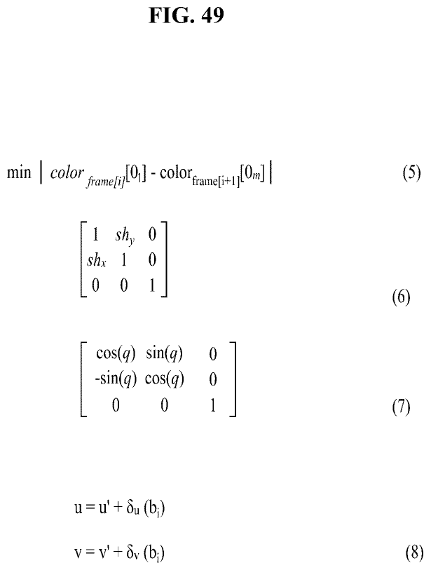

FIG. 49 illustrates texture reconstruction according to embodiments.

Equations (1), (2), (3) and (4) of FIG. 47 may be changed to (5) in FIG. 49 as possessing is performed on a per object basis, and the calculated metric is based on the same principle as the above equations.

In addition to simply comparing objects, the matching method may be varied by using the affine transform (6) and rotation transform (7) in FIG. 49.

In (6) of FIG. 49, shₓ and sh_{y} denote the factors of the affine transformation for the x and y axes, respectively, and q in Equation (7) denotes the rotation angle.

By matching the main object parts (e.g., face, neck) in the circle 4800 in FIG. 48 in the next frame, the object may be moved in the directions of dₓ and d_{y} so as to be repositioned (FIG. 49-(8)). By way of example, each object in the texture map may be corresponded to the most similar point to the corresponding object in the next frame to maximize temporal consistency. In this case, a metric that may effectively minimize the difference may be used in addition to the exemplary method in FIG. 49. In addition, if the similarities are similar, the entire dominant vectors may be applied collectively to improve temporal consistency.

FIG. 50 illustrates a point cloud data transmission device (encoder) according to embodiments.

Each component of FIG. 50 may correspond to hardware, software, a processor, and/or a combination thereof.

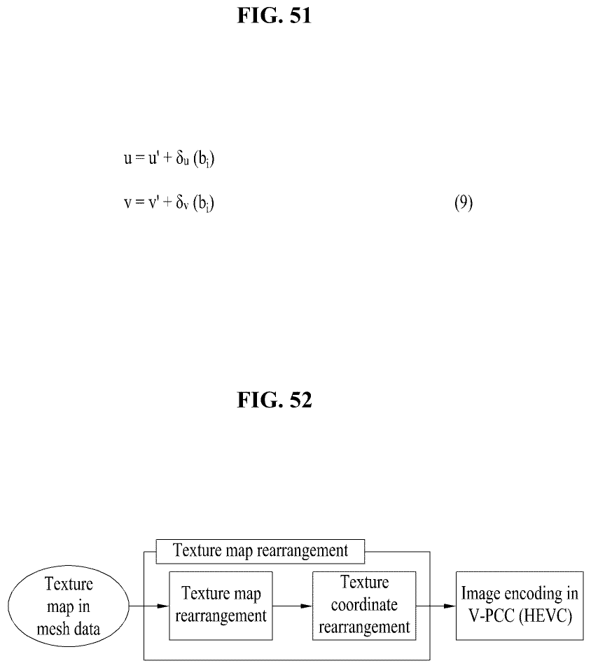

The V-PCC encoder may further include a texture map rearrangement performer 5000. The texture map of the mesh data may be directly utilized as an attribute image. The temporal consistency minimization calculator of the encoder may include or be replaced with a calculator configured to minimize a similarity measure (mean square error, Euclidean distance, correlation, etc.) of texture information (color, edge, feature point, etc.) that may represent image features. Depending on the result of the calculation, the texture map may be used as an attribute image as it is, or may be reconstructed and used with UV mapping (FIG. 47 (4)). When the texture map is reconstructed according to the result of the matched block, the texture coordinates (UV mapping) may be affected. Therefore, a correction may be applied to the existing coordinates by the u, v coordinates of the changed image coordinates of each block and reflected in the texture map configuration (see FIG. 51).

FIG. 51 illustrates coordinate correction according to embodiments.

In FIG. 51, u and v are the original texture map coordinates and u′ and v′ are the changed coordinates, respectively. du (bi) and dv (bi) denote the amount of translation offset when the coordinates are reconstructed and placed in the directions of u and v in block bi, respectively.

FIG. 52 illustrates a texture map rearrangement method according to embodiments. A flowchart of the texture map rearrangement is shown in FIG. 52.

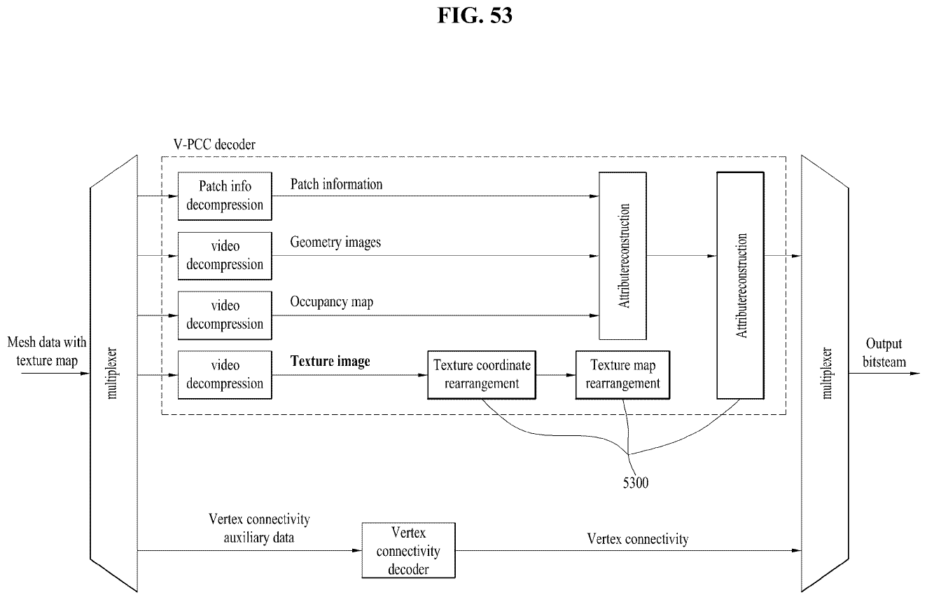

FIG. 53 illustrates a point cloud data reception device according to embodiments.

Each component of FIG. 53 may correspond to hardware, software, a processor, and/or a combination thereof.

The V-PCC decoding may further include texture coordinate restoration and texture map restoration for the texture map (5300).

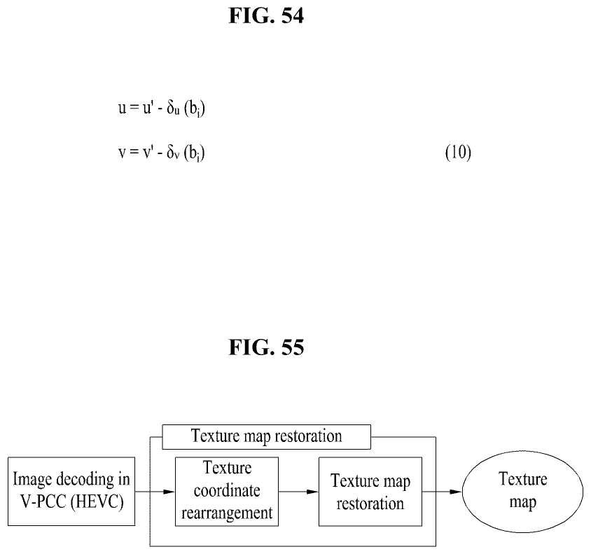

To restore the texture map reconstructed by the encoder to its original state, the texture coordinates may first be modified by the inverse operation of (9) in FIG. 51, as shown in (10) in FIG. 54.

FIG. 54 illustrates texture coordinates according to embodiments.

In (10) in FIG. 54, u and v are the original texture map coordinates and u′ and v′ are the changed coordinates, respectively. du (bi) and dv (bi) denote denote the amount of offset in reconstruction and placement in the directions of u and v in block bi, respectively. After restoring the coordinates to the original coordinates in this way, the original texture map is restored through an inverse reconstruction step based on the amount of offset for each block (or per object) in the reconstructed texture map. The attribute image reconstruction step may be omitted and replaced if a texture map is used separately.

FIG. 55 illustrates a texture map restoration method for a decoder according to embodiments.

Relevant information may be signaled to add/carry out embodiments. The signaling information according to the embodiments may be used at the transmitting end or the receiving end. The signaling information according to the embodiments may be generated and transmitted by the transmission or reception device according to the embodiments, for example, the metadata processor (which may be referred to as a metadata generator or the like) of the transmission device, and received and acquired by the metadata parser of the reception device. Each operation of the reception device according to the embodiments may be performed based on the signaling information.

FIG. 56 illustrates a V3C unit header according to embodiments.

FIG. 56 illustrates the unit header included in FIG. 40.

FIG. 57 illustrates a V3C parameter set according to embodiments.

FIG. 57 illustrates the parameter set included in FIG. 40. It may correspond to the parameter set of FIG. 41.

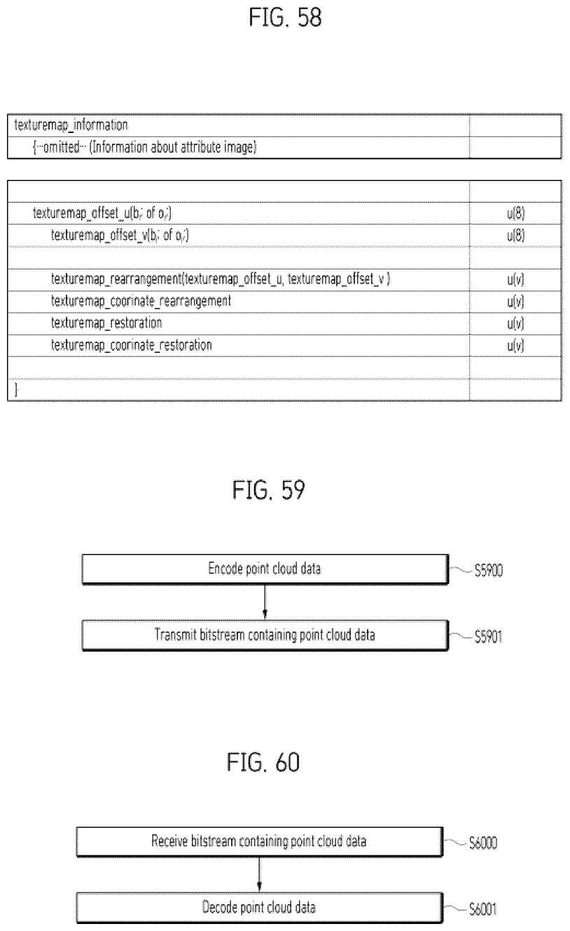

FIG. 58 illustrates texture map information according to embodiments.

FIG. 58 illustrates texture map information included in FIG. 40.

Hereinafter, the semantics of the signaling information contained in the syntax of FIGS. 56 and 58 are described.

V3C unit header semantics:

vuh_unit_type indicates a V3C unit type. It may be a V3C parameter set, atlas data, occupancy video data, geometry video data, attribute video data, packed video data, common atlas data, or the like.

vuh_v3c_parameter_set_id: vuh_v3c_parameter_set_id indicates the value of vps_v3c_parameter_set_id for the active V3C VPS. The value of vuh_v3c_parameter_set_id may be in the range of 0 to 15.

vuh_atlas_id: vuh_atlas_id indicates the ID of the atlas corresponding to the current V3C unit. The value of vuh_atlas_id may be in the range of 0 to 63.

vuh_attribute_index: vuh_attribute_index indicates the index of the attribute data carried in the attribute video data unit. The value of vuh_attribute_index may be in the range of 0 to ai_attribute_count [vuh_atlas_id]-1.

vuh_attribute_partition_index: vuh_attribute_partition_index indicates the index of the attribute dimension group contained in the attribute video data unit. The value of vuh_attribute_partition_index may be in the range of 0 to ai_attribute_dimension_partitions_minus1 [vuh_atlas_id] [vuh_attribute_index].

vuh_map_index: When present, vuh_map_index indicates the map index of the current geometry or attribute stream. When not present, the map index of the current geometry or attribute subbitstream is derived for the type of subbitstream and for geometry and attribute video subbitstreams, respectively. When present, the value of vuh_map_index may be in the range of 0 to vps_map_count_minus 1 [vuh_atlas_id].

vuh_auxiliary_video_flag: vuh_auxiliary_video_flag equal to 1 indicates that the related geometry or attribute video data unit is a RAW and/or EOM-coded point video dedicated sub-bitstream. vuh_auxiliary_video_flag equal to 0 indicates that the related geometry or attribute video data unit may contain RAW and/or EOM-coded points. When vuh_auxiliary_video_flag is not present, its value may be inferred to be equal to 0.

V3C parameter set semantics: See the description in FIG. 41.

Attribute information semantics: may be included in the texture map information in FIG. 58.

ai_attribute_count [j]: ai_attribute_count [j] indicates the number of attributes associated with the atlas with atlas ID j.

ai_attribute_type_id [j][i]: Indicates the attribute type of the attribute video data unit with index i for the atlas with atlas ID j. The type may include Texture, Material ID, Transparency, Reflectance, and Normals.

ATTR_TEXTURE indicates an attribute that contains texture information about a volumetric frame. For example, it may indicate an attribute that contains RGB (Red, Green, Blue) color information.

ATTR_MATERIAL_ID indicates a an attribute that contains additional information that identifies the material type of the point in the volumetric frame. For example, the material type may be used as an indicator to identify a characteristic of the point in the volumetric frame or an object.

ATTR_TRANSPARENCY indicates an attribute that contains transparency information associated with each point in the volumetric frame.

ATTR_REFLECTANCE indicates an attribute that contains reflectance information associated with each point in the volumetric frame.

ATTR_NORMAL indicates an attribute that contains a unit vector information associated with each point in a volumetric frame. The unit vector specifies the perpendicular direction to a surface at a point (i.e. direction a point is facing). An attribute frame with this attribute type shall have ai_attribute_dimension_minus1 equal to 2. Each channel of an attribute frame with this attribute type shall contain one component of the unit vector (x, y, z), where the first component contains the x coordinate, the second component contains the y coordinate, and the third component contains the z coordinate. ATTR UNSPECIFIED indicates an attribute that contains values that have no specified meaning in this document and will not have a specified meaning in the future as an integral part of this document.

ATTR_NORMAL indicates an attribute that contains unit vector information associated with each point in the volumetric frame. The unit vector specifies the direction perpendicular to a surface at a point (i.e., the direction a point is facing). An attribute frame with this attribute type shall have ai_attribute_dimension_minus1 equal to 2. Each channel of an attribute frame with this attribute type shall contain one component of the unit vector (x, y, z), where the first component contains the x coordinate, the second component contains the y coordinate, and the third component contains the z coordinate.

ai_attribute_codec_id [j][i]: ai_attribute_codec_id [j][i] indicates the mapping index of the codec identifier of the video decoder used to decode the attribute video sub-bitstream, with index i for the atlas having atlas ID j.

ai_auxiliary_attribute_codec_id [j][i]: When present, specifies the identifier of the codec used to compress the attribute video data for the raw and/or EOM-coded points of attribute i when the raw and/or EOM-coded points are encoded into an auxiliary video stream for the atlas with atlas ID j.

ai_attribute_map_absolute_coding_persistence_flag[j][i]:

ai_attribute_map_absolute_coding_persistence_flag[j][i] equal to 1 indicates that for attribute with index i, all attribute maps corresponding to atlas with atlas ID j are coded without any map prediction. ai_attribute_map_absolute_coding_persistence_flag[j][i] equal to 0 indicates that the attribute map for the attribute with index i corresponding to the atlas with atlas ID j should use the same map prediction method used for the geometry component of the atlas that has an atlas.

ai_attribute_dimension_minus1 [j][i]: ai_attribute_dimension_minus1 [j][i] plus 1 indicates the total number of dimensions (i.e., number of channels) of the attribute with index i for the atlas with atlas ID j.

ai_attribute_dimension_partitions_minus1 [j][i]:

ai_attribute_dimension_partitions_minus1 [j][i] plus 1 indicates the number of partition groups into which the attribute channel of the attribute with index i should be grouped for the atlas with atlas ID j.

ai_attribute_partition_channels_minus1 [j][i][k]:

ai_attribute partition_channels_minus1 [j][i][k] plus 1 indicates the number of channels assigned to a dimension partition group with index k of attribute with index i for atlas with atlas ID j.

ai_attribute_2d_bit_depth_minus1 [j][i]: ai_attribute_2d_bit_depth_minus1 [j] [i] plus 1 indicates the nominal 2D bit depth to which all attribute videos with attribute index i should be converted for an atlas with atlas ID j.

ai_attribute_MSB_align_flag[j][i]: ai_attribute_MSB_align_flag[j][i] indicates a method of transforming decoded attribute video samples with attribute index i for an atlas with atlas ID j to samples with a nominal attribute bit depth.

vuh_attribute_meshtexturemap_flag: Indicates the presence or absence of a texture map in the input mesh data.

vuh_attribute_meshtexturemap_block_flag: A flag (0 or 1) indicating whether the reconstruction of the texturemap for the input mesh data should be performed on a block-by-block basis.

vuh_attribute_meshtexturemap_object_flag: A flag (0 or 1) indicating whether the reconstruction of the texturemap for the input mesh data should be performed on an object-by-object basis.

vuh_attribute_meshtexturemap_block_index: The block index for texturemap reconstruction of the mesh data (m×m=total number of blocks).

vuh_attribute_meshtexturemap_dominantobject_index: The object index for texturemap reconstruction of the mesh data (which may specify i objects specified by the user).

texturemap_information: If a texture map is present (vuh_attribute_meshtexturemap_flag==1) as in the case of obtaining attribute map information (attributemap_information) in V-PCC, texturemap_information may perform the function of attributemap_inforamtion.

texturemap_rearrangement (texturemap_offset_u, texturemap_offset_v): The calculator for texturemap rearrangement, which is added to the main function of the texturemap_information part (attribute_information part of V-PCC) may operate so as to minimize the temporal consistency of the texturemap using several metrics. A result corresponding to texturemap_offset_u and texturemap_offset_v is returned on a per block or object basis.

texturemap_coorinate_rearrangement: After performing the texture map rearrangement (texturemap_rearrangement), the coordinates of the changed texture map reflect the change in the changed coordinates.

texturemap_restoration: Restores the original texture map by reversing the operation performed by the calculator for texture map reconstruction, which is added to the main function of texturemap_information (attribute_information of V-PCC).

texturemap_coorinate_restoration: Restores the texture coordinates to their original state after the video decompression in the decoding following encoding.

texturemap_offset_u (bi of oi): Stores the amount of offset in the direction of u for each block or object.

texturemap_offset_v (bi of oi)): Stores the amount of offset in the direction of v for each block or object.

The PCC encoding method, PCC decoding method, and signaling method of the embodiments may provide the following effects

When the texture map is reconstructable to maintain temporal consistency, the attribute image may be replaced by the texture map of the mesh data in V-PCC, resulting in compression efficiency performance. For V-PCC mesh coding, which requires the use of a video encoder/decoder unlike G-PCC, reconstruction of the mesh data texture map to maintain temporal consistency may have a significant impact on performance. By enabling the texture map of mesh data to be directly utilized as the attribute map of V-PCC, the efficiency of mesh data coding using V-PCC may be increased. In addition, temporal consistency may be given to the texture map to utilize the characteristics of the video encoder/decoder. In addition, when a complete texture map reconstruction is not feasible, the coding efficiency may be maximized through minimization calculation.

By reconfiguring the texture map according to the characteristics of the video encoder/decoder of the V-PCC using the methods described above, the coding efficiency of mesh data may be maximized. The V-PCC may efficiently decode/encode images not only when the texture map is properly organized, but also when the texture map is unorganized. Although the texture map rearrangement does not support perfect inter coding, the coding efficiency may be maximized by arranging similar parts between neighboring frames as close as possible.

Thus, the transmission method/device according to the embodiments may efficiently compress the point cloud data to transmit the data. In addition, as related signaling data is transmitted, the reception method/device according to the embodiments may efficiently decode/reconstruct the point cloud data.

FIG. 59 illustrates a method of transmitting point cloud data according to embodiments.

The method of transmitting point cloud data according to the embodiments may include encoding the point cloud data (S5900).

The encoding according to the embodiments may include operations of the transmission device 10000, point cloud video encoder 10002, and file/segment encapsulator 10003 of FIG. 1, the encoder of FIG. 3, the encoder of FIG. 15, the transmission device of FIG. 18, the XR device of FIG. 20, the encoder of FIG. 21, the encoder of FIG. 28, the encoder of FIG. 29, the encoder of FIG. 30, the encoder of FIG. 31, the bitstream generation of FIGS. 40, 41, and 56 to 58, the encoder of FIG. 45, the encoder of FIG. 50, and the encoder of FIG. 52.

The method of transmitting point cloud data according to the embodiments may further include transmitting a bitstream containing the point cloud data (S5901).

The transmission according to the embodiments may include operations of the transmission device 10000 and transmitter 10004 of FIG. 1, the transmission device and transmitter 18008 of FIG. 18, the bitstream transmission of FIG. 21, and the bitstream transmission of FIGS. 40, 41, and 56 to 58.

FIG. 60 illustrates a method of receiving point cloud data according to embodiments.

The method of receiving point cloud data according to the embodiments may include receiving a bitstream containing point cloud data (S6000).

The reception according to the embodiments may include operations of the reception device 10005 and receiver 10006 of FIG. 1, the reception device and receiver of FIG. 19, the bitstream reception of FIG. 27, and the bitstream reception of FIGS. 40, 41, and 56 to 58.

The method of receiving point cloud data according to the embodiments may further include decoding the point cloud data (S6001).

The decoding according to the embodiments may include operations of the point cloud video decoder 10008, the file/segment decapsulator 10007, the decoder of FIG. 16, the decoder of FIG. 17, the reception device of FIG. 19, the XR device 2030 of FIG. 20, the decoder of FIG. 27, the decoder of FIGS. 32 to 39, the decoder of FIGS. 40 and 41, the bitstream parsing of FIGS. 56 to 58, the decoder of FIG. 53, and the decoder of FIG. 55.

Referring to FIG. 1, the method of transmitting point cloud data according to embodiments may include encoding point cloud data and transmitting point cloud data.

Referring to FIG. 28, regarding the 3D mesh data encoder, the encoding of the point cloud data may include encoding mesh data of the point cloud data. The encoding of the mesh data may include encoding vertex geometry data of the mesh data, encoding a vertex occupancy map of the mesh data, encoding auxiliary information of the mesh data, encoding color information related to the mesh data, encoding connectivity of the mesh data, and encoding normals of the mesh data. The vertex geometry data may be positions of the vertices of the mesh data. The vertex geometry data may be referred to as geometry information or the like.

Referring to FIGS. 29, 30 and 31, regarding the 3D mesh data encoder, encoding of connectivity, and encoding of normals, the encoding of the auxiliary information may include encoding at least one of a plane index related to a patch of the point cloud data, an index of a bounding box, a reconstruction position related to the bounding box, or a patch index map. The method of transmitting point cloud data according to the embodiments may further include generating a face color image, wherein the generating of the face color image may include encoding the color image by projecting a face color in a 3D space onto the color image, or encoding the color image by packing a texture map for the vertices of the patch into the color image, and transmitting texture coordinates for the vertices. The encoding of the connectivity may include correcting the connectivity based on the reconstructed geometry data, and mapping the vertices to a symbol based on the connectivity. The encoding of the normals may include encoding the normals based on normals predicted based on the reconstructed geometry data and the reconstructed connectivity.

The connectivity may include information related to connectivity between vertices of the mesh data. In the process of encoding the original geometry, the encoded geometry may be reconstructed to generate the reconstructed geometry. Based on the reconstructed geometry, the mesh data may be reconstructed. The original geometry refers to the original value of the position information, and the reconstructed geometry refers to the value reconstructed by restoring the compressed geometry.

Referring to FIG. 41, regarding the parameter set (v3c_parameter_set), the bitstream may contain information about the number of vertices of the mesh data of the point cloud data, information about the order of the vertices, and texture coordinate information.

Referring to FIGS. 42 to 44 and 45, regarding reconstruction of the mesh data, frame, and texture map, the encoding of the point cloud data may further include reconstructing the texture map of the mesh data of the point cloud data. The reconstructing of the texture map may include rearranging the texture map, and modifying coordinates of a texture for the texture map.

Referring to FIGS. 46, 47, 48, and 49, regarding block-by-block texture reconstruction and object-by-object texture reconstruction, the reconstructing of the texture map may include reconstructing a frame containing the texture map into blocks and modifying the coordinates of the texture based on the blocks, or may include reconstructing the frame containing the texture map into objects and modifying the coordinates of the texture based on the objects.

The method of transmitting point cloud data according to the embodiments may be carried out by a transmission device.

The point cloud data transmission device according to embodiments may include an encoder configured to encode the point cloud data, and a transmitter configured to transmit the point cloud data.

The encoder configured to encode the point cloud data may include an encoder configured to encode mesh data of the point cloud data. The encoder configured to encode the mesh data may encode vertex geometry data of the mesh data, a vertex occupancy map of the mesh data, auxiliary information of the mesh data, color information related to the mesh data, a connectivity of the mesh data, and normals of the mesh data.

The point cloud data reception method according to embodiments may perform a corresponding process and/or a reverse process to the transmission method.

A method of receiving point cloud data according to embodiments may include receiving a bitstream containing point cloud data; and decoding the point cloud data.

Referring to FIG. 32, regarding the 3D mesh data decoder, the decoding of the point cloud data may include decoding mesh data of the point cloud data. The decoding of the mesh data may include decoding auxiliary information related to the mesh data, decoding an occupancy map of the mesh data, decoding vertex geometry data of the mesh data, decoding attribute data of the mesh data, decoding connectivity of the mesh data, and decoding normals of the mesh data.

Referring to FIGS. 32 and 33, regarding the auxiliary information decoder and vertex geometry and vertex color reconstructors, the decoding of the auxiliary information related to the mesh data may include decoding auxiliary information for reconstruction of vertex geometry data and attribute data, wherein the auxiliary information may include information for restoration of a plane index, a position of a bounding box, a reconstructed position, a patch index map, and a vertex order table for a patch of the point cloud data. The vertex order table contains information for mapping of restored connectivity and restored vertex order. The decoding of the vertex geometry data of the mesh data may include restore reconstructed vertex geometry data and reconstructed attribute data based on the reconstructed geometry data, the reconstructed attribute data, and the reconstructed vertex occupancy map.

The mesh data may include auxiliary information, color information, vertex geometry, vertex occupancy map information, connectivity, and normals.

The reception method may restore the encoded mesh data. The restored connectivity is data obtained by restoring the encoded connectivity, and the restored vertex order is data obtained by restoring the encoded vertex order. The reconstructed geometry data is data obtained by restoring the positions of the encoded vertices. The restored attribute data is data obtained by restoring the encoded color information.

As shown in FIG. 32, the reception method may generate auxiliary information, vertex point map information, a geometry image, a color image, restored connectivity, and reconstructed normals.

The auxiliary information is information needed to restore the mesh data, and may be transmitted to the vertex geometry/color reconstructor, vertex order mapper, and face color reconstructor.

The vertex geometry/vertex color reconstructor may reconstruct vertex positions and vertex colors based on the geometry image (vertex coordinates), color image (vertex colors), vertex occupancy map (occupancy map), and auxiliary information.

The vertex order mapper may map the vertex order to restore the vertices constituting the mesh data and the connection relationship between the vertices. An order of the vertices may be created.

The face color reconstructor may restore the color of a face composed of vertices.

A normal may be a normal vector for a vertex or an object (e.g., a human face).

Referring to FIG. 34, regarding the vertex order mapper, the decoding of the mesh data may further include mapping the index of the reconstructed vertex to the vertex index of connectivity based on the vertex order table. Based on the vertex order table containing information indicating the order of vertices, the vertex index may be mapped like the connection relationship to the original mesh data.

The decoding of the point cloud data may further include restoring a texture map of the mesh data of the point cloud data. The restoring of the texture map may include restoring coordinates of the texture for the texture map. Thereby, the texture map may be restored.

The bitstream may contain information indicating whether a texture map for the mesh data of the point cloud data is present, information indicating whether a unit of reconstruction of the texture map is a block, information indicating whether the unit of reconstruction of the texture map is an object, a block index for reconstruction of the texture map, an object index for reconstruction of the texture map, and offset information for the texture map.

The point cloud data reception method may be carried out by a reception device.

A point cloud data reception device according to embodiments may include a receiver configured to receive containing a bitstream point cloud data, and a decoder configured to decode the point cloud data.

Accordingly, the embodiments provide the following effects.

Vertex color information, and/or mesh data with a texture map and vertex texture coordinates may be compressed using an encoder/decoder of the same structure.

By selecting the optimal face color encoding mode between the texture map mode and color image mode proposed by the encoder, efficient encoding may be performed according to the characteristics of the data.

According to the method for encoding/decoding the face color in the color image mode, the encoder may not transmit texture coordinates, but the decoder may implicitly derive the texture coordinates of the vertices. Thereby, the encoding/decoding may be performed efficiently.

By directly using the texture map of the mesh data as an attribute map of V-PCC, the efficiency of mesh data coding using V-PCC may be increased.

By reconstructing the texture map according to the characteristics of the V-PCC video encoder/decoder, the coding efficiency of the mesh data may be maximized.

Further, mesh-related point cloud data may be efficiently encoding and decoding by using the characteristics of mesh data including a texture map.

The embodiments have been described in terms of a method and/or a device. The description of the method and the description of the device may complement each other.

Although embodiments have been described with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may also fall within the scope of the appended claims and their equivalents. The devices and methods may not be limited by the configurations and methods of the embodiments described above. The embodiments described above may be configured by being selectively combined with one another entirely or in part to enable various modifications. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.” Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise.

The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or a combination thereof. The firmware, software, and/or a combination thereof may be stored in the processor or the memory.

### Mode for Disclosure

As described above, related details have been described in the best mode for carrying out the embodiments.

### Industrial Applicability

As described above, the embodiments are fully or partially applicable to a point cloud data transmission/reception device and system.

Those skilled in the art may change or modify the embodiments in various ways within the scope of the embodiments.

Embodiments may include variations/modifications within the scope of the claims and their equivalents.

1. A method of transmitting point cloud data, the method comprising:
encoding point cloud data; and
transmitting the point cloud data.

2. The method of claim 1, wherein the encoding of the point cloud data comprises:
encoding mesh data of the point cloud data,
wherein the encoding of the mesh data comprises:
encoding vertex geometry data of the mesh data;
encoding a vertex occupancy map of the mesh data;
encoding auxiliary information related to the mesh data;
encoding color information related to the mesh data;
encoding connectivity related to the mesh data; and
encoding normal information related to the mesh data.

3. The method of claim 2, wherein the encoding of the auxiliary information comprises:
encoding, in relation to a patch of the point cloud data, at least one of a plane index, an index of a bounding box, a restored position related to the bounding box, or a patch index map,
the method further comprising:
generating a face color image,
wherein the generating of the face color image comprises:
encoding the color image by projecting a face color in three-dimensional space onto a color image; or
encoding the color image by packing a texture map for vertices of the patch with the color image, and transmitting texture coordinates for the vertices,
wherein the encoding of the connectivity,
correcting the connectivity based on reconstructed geometry data; and
mapping the vertices to a symbol based on the connectivity,
wherein the encoding of the normal information comprises:
encoding the normal information based on predicted normal information based on the reconstructed geometry data and reconstructed connectivity.

4. The method of claim 1, wherein the bitstream contains information about a number of vertices of mesh data of the point cloud data, information about an order of the vertices, and texture coordinate information.

5. The method of claim 1, wherein the encoding of the point cloud data comprises:
reconstructing a texture map of mesh data of the point cloud data,
wherein the reconstructing of the texture map comprises:
rearranging the texture map; and
modifying coordinates of a texture for the texture map.

6. The method of claim 5, wherein the reconstructing of the texture map comprises:
reconstructing a frame containing the texture map into blocks; and
modifying the coordinates of the texture based on the blocks; or
reconstructing the frame containing the texture map into objects,
modifying the coordinates of the texture based on the object.

7. A device for transmitting point cloud data, the device comprising:
an encoder configured to encode point cloud data; and
a transmitter configured to transmit the point cloud data.

8. The device of claim 8, wherein the encoder configured to encode the point cloud data comprises:
an encoder configured to encode mesh data of the point cloud data,
wherein the encoder configured to encode the mesh data is configured to:
encode vertex geometry data of the mesh data;
encode a vertex occupancy map of the mesh data;
encode auxiliary information related to the mesh data;
encode color information related to the mesh data;
encode connectivity related to the mesh data; and
encode normal information related to the mesh data.

9. A method of receiving point cloud data, the method comprising:
receiving a bitstream containing point cloud data; and
decoding the point cloud data.

10. The method of claim 9, wherein the decoding of the point cloud data comprises:
decoding mesh data of the point cloud data,
wherein the decoding of the mesh data comprises:
decoding auxiliary information related to the mesh data;
decoding an occupancy map of the mesh data;
decoding vertex geometry data of the mesh data;
decoding attribute data of the mesh data;
decoding connectivity related to the mesh data; and
decoding normal information related to the mesh data.

11. The method of claim 10, wherein the decoding of the auxiliary information comprises:
decoding auxiliary information related to reconstruction of the vertex geometry data and the attribute data,
wherein the auxiliary information comprises information for restoring a plane index, a position of a bounding box, a reconstructed position, a patch index map, and a vertex order table for a patch of the point cloud data,
wherein the vertex order table contains reconstructed connectivity and information for mapping of a restored vertex order,
wherein the decoding of the vertex geometry data of the mesh data comprises:
reconstructing the reconstructed vertex geometry data and reconstructed attribute data based on the reconstructed geometry data, the reconstructed attribute data, and a reconstructed vertex occupancy map.

12. The method of claim 10, wherein the decoding of the mesh data comprises:
mapping, based on the vertex order table, an index of a reconstructed vertex to an index of a vertex of the connectivity.

13. The method of claim 9, wherein the decoding of the point cloud data comprises:
reconstructing a texture map of mesh data of the point cloud data,
wherein the reconstructing of the texture map comprises:
reconstructing coordinates of a texture for the texture map.

14. The method of claim 9, wherein the bitstream contains:
information indicating whether a texture map related to mesh data of the point cloud data;
information indicating whether a unit of reconstruction of the texture map is a block;
information indicating whether the unit of reconstruction of the texture map is an object;
a block index for reconstruction of the texture map;
an object index for reconstruction of the texture map; and
offset information related to the texture map.

15. A device for receiving point cloud data, the device comprising:
a receiver configured to receive a bitstream containing point cloud data; and
a decoder configured to decode the point cloud data.
